(19) United States
(12) Patent Application Publication
(10) Pub. No.: US 2023/0223593 A1
(43) Pub. Date: Jul. 13, 2023

(54) INORGANIC SOLID ELECTROLYTE-CONTAINING COMPOSITION, SHEET FOR ALL-SOLID STATE SECONDARY BATTERY, AND ALL-SOLID STATE SECONDARY BATTERY, AND MANUFACTURING METHODS FOR SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Hiroshi ISOJIMA, Kanagawa (JP); Hideyuki SUZUKI, Kanagawa (JP); Koji YASUDA, Kanagawa (JP)

(73) Assignee: FUJIFILM Corporation, Tokyo (JP)

(21) Appl. No.: 18/180,862

(22) Filed: Mar. 9, 2023

Related U.S. Application Data
(63) Continuation of application No. PCT/JP2021/033460, filed on Sep. 13, 2021.

(30) Foreign Application Priority Data
Sep. 30, 2020 (JP) 2020-166556
Dec. 17, 2020 (JP) 2020-209628
Jul. 30, 2021 (JP) 2021-126029

(51) Int. Cl. H01M 10/0562; H01M 10/0585; H01M 4/62

(52) U.S. Cl. CPC H01M 10/0562; H01M 10/0585; H01M 4/622; H01M 2300/0068; H01M 2004/021

(57) ABSTRACT

There are provided an inorganic solid electrolyte-containing composition that has excellent dispersion characteristics and excellent application suitability and enables excellent cycle characteristics, a sheet for an all-solid state secondary battery, and an all-solid state secondary battery, and manufacturing methods for a sheet for an all-solid state secondary battery and an all-solid state secondary battery, in which the above inorganic solid electrolyte-containing composition is used. The inorganic solid electrolyte-containing composition for an all-solid state secondary battery contains an inorganic solid electrolyte, a polymer binder, and a dispersion medium, in which an adsorption rate of the polymer binder with respect to the inorganic solid electrolyte is 50% or less, and the inorganic solid electrolyte and the polymer binder satisfies a specific relationship in terms of surface energy.

### CROSS-REFERENCE TO RELATED APPLICATIONS

This application is a Continuation of PCT International Application No. PCT/JP2021/033460 filed on Sep. 13, 2021, which claims priority under 35 U.S.C. § 119 (a) to Japanese Patent Application No. 2020-166556 filed in Japan on Sep. 30, 2020, Japanese Patent Application No. 2020-209628 filed in Japan on Dec. 17, 2020, and Japanese Patent Application No. 2021-126029 filed in Japan on Jul. 30, 2021. Each of the above applications is hereby expressly incorporated by reference, in its entirety, into the present application.

### BACKGROUND OF THE INVENTION

### 1. Field of the Invention

The present invention relates to an inorganic solid electrolyte-containing composition, a sheet for an all-solid state secondary battery, and an all-solid state secondary battery, and manufacturing methods for a sheet for an all-solid state secondary battery and an all-solid state secondary battery.

### 2. Description of the Related Art

In an all-solid state secondary battery, all of a negative electrode, an electrolyte, and a positive electrode consist of solid, and the all-solid state secondary battery can greatly improve safety and reliability, which are said to be problems to be solved in a battery in which an organic electrolytic solution is used. It is also said to be capable of extending the battery life. Furthermore, all-solid state secondary batteries can be provided with a structure in which the electrodes and the electrolyte are directly disposed in series. As a result, it becomes possible to increase the energy density to be high as compared with a secondary battery in which an organic electrolytic solution is used, and thus the application to electric vehicles, large-sized storage batteries, and the like is anticipated.

In such an all-solid state secondary battery, examples of substances that form constitutional layers (a solid electrolyte layer, a negative electrode active material layer, a positive electrode active material layer, and the like) include an inorganic solid electrolyte and an active material. In recent years, this inorganic solid electrolyte, particularly an oxide-based inorganic solid electrolyte or a sulfide-based inorganic solid electrolyte has attracted attention as an electrolyte material having a high ion conductivity comparable to that of the organic electrolytic solution.

As the material that forms a constitutional layer (a constitutional layer forming material) of an all-solid state secondary battery, a material containing the above-described inorganic solid electrolyte and the like has been proposed. For example, JP2015-088486A discloses a solid electrolyte composition including an inorganic solid electrolyte (A) having an ion conductivity of a metal belonging to Group 1 or Group 2 of the periodic table; a binder particle (B) having an average particle diameter of 10 nm or more and 1,000 nm or less, which are composed of a polymer into which a macromonomer (X) having a number average molecular weight of 1,000 or more is incorporated as a side chain component; and a dispersion medium (C).

### SUMMARY OF THE INVENTION

In a case of forming a constitutional layer with solid particle materials (an inorganic solid electrolyte, an active material, conductive auxiliary agent, and the like), it is desirable that the constitutional layer forming material is excellent in characteristics such as dispersibility and application suitability from the viewpoint of improving the battery performance (for example, cycle characteristics) of an all-solid state secondary battery.

From the viewpoints of reducing the burden on the environment in recent years and reducing the manufacturing cost, the use of a high-concentration composition (a concentrated slurry) having an increased solid content concentration has been studied as a constitutional layer forming material. However, as the solid content concentration of the composition is increased, the characteristics of the composition generally deteriorate significantly. As a result, even with a high-concentration composition, it has not been easy to realize a constitutional layer forming material that is excellent in dispersion characteristics of suppressing the aggregation and the like of a solid particle material (also referred to as solid particles) and excellent in application suitability such as characteristics (surface properties) of easily forming a coating film having a flat surface or characteristics (adhesiveness) of causing solid particles to adhere to each other or causing solid particles to bind to a base material. Even in a case of using the binder particles described in JP2015-088486A, it has not been easy to sufficiently realize a composition having both dispersibility and application suitability, and thus further studies have been required.

Further, research and development for improving the performance and the practical application of electric vehicles have progressed rapidly, and the demand for battery performance required for an all-solid state secondary battery has become higher. In order to respond to such demands, it is important to make the constitutional layer forming material exhibit higher characteristics to form a constitutional layer.

An object of the present invention is to provide an inorganic solid electrolyte-containing composition excellent in dispersion characteristics and application suitability, where the inorganic solid electrolyte-containing composition is capable of realizing the excellent cycle characteristics in a case of being used as a constitutional layer forming material of an all-solid state secondary battery. In addition, another object of the present invention is to provide a sheet for an all-solid state secondary battery and an all-solid state secondary battery, and manufacturing methods for a sheet for an all-solid state secondary battery and an all-solid state secondary battery, in which the above inorganic solid electrolyte-containing composition is used.

As a result of diligent studies focusing on solid particles such as an inorganic solid electrolyte and a polymer binder that is used in combination with a dispersion medium, the inventors of the present invention found that in a case where an inorganic solid electrolyte and a polymer binder, which satisfies a relationship defined by Expression (1) described later between the polymer binder and the inorganic solid electrolyte in terms of surface energy and exhibits an adsorption rate of 50% or less with respect to the inorganic solid electrolyte, are used in combination, the aggregation, the sedimentation, or the like of the inorganic solid electrolyte can be suppressed. Accordingly, it has been found that in a case where this inorganic solid electrolyte-containing composition is used as a constitutional layer forming material, it is possible to realize a sheet for an all-solid state secondary battery, having a constitutional layer, the coated surface of which is flat and thus the surface property is good and in which excellent adhesiveness is provided, and furthermore, to realize an all-solid state secondary battery which is excellent cycle characteristics. The present invention has been completed through further studies based on these findings.

That is, the above problems have been solved by the following means.

<1> An inorganic solid electrolyte-containing composition for an all-solid state secondary battery, comprising:

an inorganic solid electrolyte having an ion conductivity of a metal belonging to Group 1 or Group 2 in the periodic table;

a polymer binder; and

a dispersion medium, in which an adsorption rate of the polymer binder with respect to the inorganic solid electrolyte in the dispersion medium is 50% or less, and the inorganic solid electrolyte and the polymer binder satisfy a relationship defined by Expression (1) in terms of surface energy,

(Xse−Xba)²+(Yse−Yba)²≤R² Expression (1)

in the expression, Xse represents a dispersion element of surface energy of the inorganic solid electrolyte, and Yse represents a polarity element of the surface energy of the inorganic solid electrolyte,

Xba represents a dispersion element of surface energy of the polymer binder, and Yba represents a polarity element of the surface energy of the polymer binder, and

R is 20.

<2> The inorganic solid electrolyte-containing composition according to <1>, in which the adsorption rate is 5% or more and less than 30%.

<3> The inorganic solid electrolyte-containing composition according to <1> or <2>, further comprising:

an active material,

in which this active material and the polymer binder satisfy a relationship defined by Expression (2) in terms of surface energy,

(Xam−Xba)²+(Yam−Yba)²≤r² Expression (2)

in the expression, Xam represents a dispersion element of surface energy of the active material, and Yam represents a polarity element of the surface energy of the active material,

Xba represents a dispersion element of surface energy of the polymer binder, and Yba represents a polarity element of the surface energy of the polymer binder, and

r is 30.

<4> The inorganic solid electrolyte-containing composition according to <3>, in which the inorganic solid electrolyte, the polymer binder, and the active material satisfy a relationship defined by Expression (3) in terms of surface energy,

R_{SE}+R_{AM}≤30 Expression (3)

in the expression, R_{SE}² represents a left side of Expression (1), and R_{AM}² represents a left side of Expression (2).

<5> The inorganic solid electrolyte-containing composition according to any one of <1> to <4>, in which the dispersion medium contains at least one selected from an ester compound, a ketone compound, an ether compound, an alcohol compound, an amide compound, an amine compound, or a nitrile compound, and the polymer binder has a molecular weight of 10,000 to 700,000,

or the dispersion medium contains at least one selected from an aromatic compound or an aliphatic compound, and the polymer binder has a molecular weight of 70,000 to 1,000,000.

<6> The inorganic solid electrolyte-containing composition according to any one of <1> to <5>, in which a difference between an SP value of the dispersion medium and an SP value of the polymer binder is 3 or less.

<7> The inorganic solid electrolyte-containing composition according to any one of <1> or <6>, in which a polymer that forms the polymer binder contains a constitutional component having a functional group selected from the following group (a) of functional groups,

<Group (a) of functional groups>

a hydroxy group, an amino group, a carboxy group, a sulfo group, a phosphate group, a phosphonate group, a sulfanyl group, an ether bond, an imino group, an ester bond, an amide bond, a urethane bond, a urea bond, a heterocyclic group, an aryl group, a carboxylic acid anhydride group, and a fluoroalkyl group.

<8> A sheet for an all-solid state secondary battery, comprising a layer formed of the inorganic solid electrolyte-containing composition according to any one of <1> to <7>.

<9> An all-solid state secondary battery comprising, in the following order:

a positive electrode active material layer;

a solid electrolyte layer; and

a negative electrode active material layer, in which at least one of the positive electrode active material layer, the negative electrode active material layer, or the solid electrolyte layer has a layer formed of the inorganic solid electrolyte-containing composition according to any one of <1> to <7>.

<10> A manufacturing method for a sheet for an all-solid state secondary battery, the manufacturing method comprising forming a film of the inorganic solid electrolyte-containing composition according to any one of <1> to <7>.

<11> A manufacturing method for an all-solid state secondary battery, the manufacturing method comprising incorporating a sheet for an all-solid state secondary battery, which is obtained by the manufacturing method according to <10>, into an all-solid state secondary battery.

According to the present invention, it is possible to provide an inorganic solid electrolyte-containing composition excellent in dispersion characteristics (dispersibility and stability) and application suitability (surface properties and adhesiveness), where the inorganic solid electrolyte-containing composition is capable of realizing the excellent cycle characteristics in a case of being used as a constitutional layer forming material of an all-solid state secondary battery. In addition, according to the present invention, it is possible to provide a sheet for an all-solid state secondary battery and an all-solid state secondary battery, which have a layer formed of the above inorganic solid electrolyte-containing composition. Further, according to the present invention, it is possible to provide manufacturing methods for a sheet for an all-solid state secondary battery and an all-solid state secondary battery, in which the above inorganic solid electrolyte-containing composition is used.

### BRIEF DESCRIPTION OF THE DRAWINGS

FIG. 1 is a vertical cross-sectional view schematically illustrating an all-solid state secondary battery according to a preferred embodiment of the present invention.

### DESCRIPTION OF THE PREFERRED EMBODIMENTS

In the present invention, numerical ranges indicated using “to” include numerical values before and after the “to” as the lower limit value and the upper limit value.

In the present invention, the expression of a compound (for example, in a case where a compound is represented by an expression in which “compound” is attached to the end) refers to not only the compound itself but also a salt or an ion thereof. In addition, this expression also refers to a derivative obtained by modifying a part of the compound, for example, by introducing a substituent into the compound within a range where the effect of the present invention is not impaired.

In the present invention, (meth)acryl means one of or both of acryl and methacryl. The same applies to (meth)acrylate.

In the present invention, a substituent, a linking group, or the like (hereinafter, referred to as a substituent or the like), which is not specified regarding whether to be substituted or unsubstituted, may have an appropriate substituent. Accordingly, even in a case where a YYY group is simply described in the present invention, this YYY group includes not only an aspect having a substituent but also an aspect not having a substituent. The same shall be applied to a compound that is not specified in the present specification regarding whether to be substituted or unsubstituted. Examples of the preferred examples of the substituent include a substituent Z described later.

In the present invention, in a case where a plurality of substituents or the like represented by a specific reference numeral are present or a plurality of substituents or the like are simultaneously or alternatively defined, the respective substituents or the like may be the same or different from each other. In addition, unless specified otherwise, in a case where a plurality of substituents or the like are adjacent to each other, the substituents may be linked or fused to each other to form a ring.

In the present invention, the polymer means a polymer; however, it has the same meaning as a so-called polymeric compound. Further, a polymer binder means a binder constituted of a polymer and includes a polymer itself and a binder formed by containing a polymer.

[Inorganic Solid Electrolyte-Containing Composition]

The inorganic solid electrolyte-containing composition according to the embodiment of the present invention is an inorganic solid electrolyte-containing composition for an all-solid state secondary battery, containing an inorganic solid electrolyte having an ion conductivity of a metal belonging to Group 1 or Group 2 in the periodic table, a polymer binder, and a dispersion medium. The polymer binder contained in this inorganic solid electrolyte-containing composition satisfies a relationship defined by Expression (1) described later between the polymer binder and the inorganic solid electrolyte in terms of surface energy and exhibits an adsorption rate of 50% or less with respect to the inorganic solid electrolyte.

That is, it suffices that the inorganic solid electrolyte-containing composition according to the embodiment of the present invention contains the polymer binder, and the content state of the polymer binder and the like are not particularly limited. For example, in the inorganic solid electrolyte-containing composition, the polymer binder may be adsorbed or may not be adsorbed to the inorganic solid electrolyte; however, in a case where it adsorbs thereto, the degree of the adsorption may be within the range of the adsorption rate described later.

This polymer binder functions, in a layer formed of at least an inorganic solid electrolyte-containing composition, as a binder that causes solid particles such as an inorganic solid electrolyte (as well as a co-existable active material, conductive auxiliary agent, and the like) to bind to each other (for example, between inorganic solid electrolytes, between an inorganic solid electrolyte and an active material, or between active materials). Further, it may function as a binder that binds a collector to solid particles. In the inorganic solid electrolyte-containing composition, the polymer binder may have or may not have a function of causing solid particles to bind to each other.

The inorganic solid electrolyte-containing composition according to the embodiment of the present invention is preferably a slurry in which the inorganic solid electrolyte is dispersed in a dispersion medium. In this case, the polymer binder has a function of dispersing solid particles in a dispersion medium by being adsorbed to solid particles such as an inorganic solid electrolyte or being interposed therebetween. This makes it possible to enhance the dispersion characteristics and the application suitability of the inorganic solid electrolyte-containing composition. Here, the adsorption of the polymer binder to the solid particles includes not only physical adsorption but also chemical adsorption (adsorption by chemical bond formation, adsorption by transfer of electrons, or the like). In addition, in a case where the polymer binder is dispersed in the dispersion medium (in the solid state), a part of the low adsorption binder may be dissolved in the dispersion medium within a range where the effect of the present invention is not impaired.

The inorganic solid electrolyte-containing composition according to the embodiment of the present invention is excellent in dispersion characteristics (dispersibility and dispersion stability) and application suitability (surface properties and adhesiveness). In a case where this inorganic solid electrolyte-containing composition is used as a constitutional layer forming material, it is possible to realize a sheet for an all-solid state secondary battery, which has a constitutional layer having a flat surface and excellent surface properties and excellent in adhesiveness between solid particles, and furthermore, to realize an all-solid state secondary battery which is excellent cycle characteristics.

In the aspect in which the active material layer formed on the collector is formed of the inorganic solid electrolyte-containing composition according to the embodiment of the present invention, it is also possible to realize strong adhesiveness between the collector and the active material layer and thus it is possible to achieve a further improvement of the cycle characteristics.

Although the details of the reason for the above are not yet clear, it is conceived to be as follows.

That is, in an inorganic solid electrolyte-containing composition, a polymer binder in which the dispersion element and the polarity element of the surface energy satisfy a relationship defined by Expression (1) described later between the polymer binder and the inorganic solid electrolyte and exhibits an adsorption rate of 50% or less with respect to the inorganic solid electrolyte permeates between particles of the inorganic solid electrolyte having similar surface energy and can create a state of being interposed without excessively being adsorbed to the inorganic solid electrolyte, whereby dispersibility can be increased. Furthermore, it is conceived to be possible to suppress the reaggregation, sedimentation, or the like of the inorganic solid electrolyte not only immediately after the preparation of the inorganic solid electrolyte-containing composition but also even after a lapse of time, and it is possible to stably maintain a higher dispersion state (the dispersion stability is excellent).

In a case where a constitutional layer is formed using the inorganic solid electrolyte-containing composition according to the embodiment of the present invention, which exhibits such excellent dispersion characteristics, it is possible to suppress the generation of reaggregates, sediments, or the like of the inorganic solid electrolyte, even at the formation a film of a constitutional layer (for example, during the coating and as well as during drying of the inorganic solid electrolyte-containing composition). This makes it possible to suppress variations in the contact state between inorganic solid electrolytes in the constitutional layer. In particular, in a case where the inorganic solid electrolyte-containing composition contains an active material or the like, it is conceived that specific particles of the active material or the like are less likely to be unevenly distributed in the constitutional layer (solid particles are uniformly arranged in the constitutional layer). As a result, it is possible to suppress the generation or expansion of voids due to charging and discharging, which contributes to the improvement of cycle characteristics of an all-solid state secondary battery.

In addition to this, it is conceived that the inorganic solid electrolyte-containing composition according to the embodiment of the present invention can effectively weaken the interaction between the particles of the inorganic solid electrolyte and at the time of the formation of a film of the inorganic solid electrolyte-containing composition, can exhibit a viscosity (fluidity) suitable for film formation in addition to the improvement of the dispersion characteristics. As a result, the applied inorganic solid electrolyte-containing composition properly flows (becomes leveled), and the generation of protrusions and recesses having severe undulations due to insufficient flow or excessive flow can be suppressed (the surface properties of the coated surface are excellent). Furthermore, the interfacial contact state of the solid particles is improved (the adhesiveness is increased), and thus the solid particles firmly adhere to each other. Therefore, in the present invention, the solid content concentration of the inorganic solid electrolyte-containing composition can be set to be high as compared with a case in the related art, and thus the above-described excellent dispersion characteristics and excellent application suitability can be realized.

In a case where a constitutional layer is formed by using such an inorganic solid electrolyte-containing composition having excellent dispersion characteristics and excellent application suitability, the adhesiveness between solid particles as well as the adhesiveness between solid particles and a base material (a collector) is reinforced while suppressing the generation of voids due to the improvement of the dispersion characteristics, and furthermore, the concentration of current (the deterioration of solid particles) on steep protruding parts on the surface of the constitutional layer can be suppressed. For this reason, it is conceived to be possible to realize an all-solid state secondary battery that has excellent cycle characteristics without significantly deteriorating battery characteristics even after repeated charging and discharging.

The solid content concentration of the inorganic solid electrolyte-containing composition is not particularly limited and can be appropriately set to, for example, 20% to 80% by mass. The solid content concentration is preferably 30% to 70% by mass and more preferably 40 to 60% by mass.

In the present invention, since dispersion characteristics and application suitability can be effectively improved by adopting a composition containing a polymer binder in which the dispersion element and the polarity element of the surface energy satisfy a relationship defined by Expression (1) described later between the polymer binder and the inorganic solid electrolyte and exhibits an adsorption rate of 50% or less with respect to the inorganic solid electrolyte, an inorganic solid electrolyte, and a dispersion medium, it is possible to use a high-concentration composition in which the solid content concentration is set to be higher than that in the related art, as the inorganic solid electrolyte-containing composition. For example, the lower limit value of the solid content concentration of the high-concentration composition can be set to 50% by mass or more. The upper limit value thereof is less than 100% by mass and can be set to, for example, 90% by mass or less. It is preferably 85% by mass or less and more preferably 80% by mass or less.

In a case where an active material layer is formed of the inorganic solid electrolyte-containing composition according to the embodiment of the present invention, a constitutional layer is formed while a highly (homogeneously) dispersion state immediately after preparation is maintained as described above. For this reason, it is conceived that the contact (the adhesion) of the polymer binder to the surface of the collector is not inhibited by the solid particles that have been preferentially sedimented, and the polymer binder can come into contact with (adhesion to) the surface of the collector in a state of being dispersed together with solid particles. As a result, in the electrode sheet for an all-solid state secondary battery in which an active material layer is formed of the inorganic solid electrolyte-containing composition according to the embodiment of the present invention on a collector, it is possible to realize strong adhesiveness between the collector and the active material. Further, the all-solid state secondary battery in which the active material layer is formed on the collector with the inorganic solid electrolyte-containing composition according to the embodiment of the present invention exhibits strong adhesiveness between the collector and the active material, and it is possible to realize the further improvement of the cycle characteristics and the conductivity.

The inorganic solid electrolyte-containing composition according to the embodiment of the present invention is preferably used as a material (a constitutional layer forming material) for forming a solid electrolyte layer or an active material layer, where the material is for a sheet for an all-solid state secondary battery (including an electrode sheet for an all-solid state secondary battery) or an all-solid state secondary battery. In particular, the inorganic solid electrolyte-containing composition has a high content of the inorganic solid electrolyte in the solid content and can be preferably used as a material for forming a solid electrolyte sheet for an all-solid state secondary battery or a solid electrolyte layer, and high cycle characteristics can be achieved in this aspect as well.

The viscosity of the inorganic solid electrolyte-containing composition according to the embodiment of the present invention at 25° C. (room temperature) is not particularly limited. The viscosity at 25° C. is preferably 200 to 15,000 cP, more preferably 200 to 8,000 cP, and still more preferably 400 to 6,000 cP, in terms of improving the dispersion characteristics and application suitability.

The viscosity of the inorganic solid electrolyte-containing composition can be appropriately set, for example, by changing or adjusting the solid content concentration of the inorganic solid electrolyte-containing composition, the kind or content of the solid particle or the polymer binder, the kind of the dispersion medium, and the like, and moreover, the dispersion conditions.

(Measuring Method for Slurry Viscosity)

A value measured according to the following method is employed as the viscosity of the inorganic solid electrolyte-containing composition.

Specifically, using an E-type viscometer (TV-35, manufactured by TOKI SANGYO Co., Ltd.) and a standard cone rotor (1″34′×R24), 1.1 mL of a sample (an inorganic solid electrolyte-containing composition) is applied to a sample cup adjusted to a 25° C., set the sample cup in the main body, and maintained for 5 minutes until the temperature becomes constant. Then, the measurement range is set to “U”, and a value obtained by measuring at a shear rate of 10/s (rotation speed: 2.5 rpm) one minute after the start of rotation is defined as the viscosity.

The inorganic solid electrolyte-containing composition according to the embodiment of the present invention is preferably a non-aqueous composition. In the present invention, the non-aqueous composition includes not only an aspect including no watery moisture but also an aspect where the moisture content is preferably 500 ppm or less. In the non-aqueous composition, the moisture content is more preferably 200 ppm or less, still more preferably 100 ppm or less, and particularly preferably 50 ppm or less. In a case where the inorganic solid electrolyte-containing composition is a non-aqueous composition, it is possible to suppress the deterioration of the inorganic solid electrolyte. The water content refers to the water amount (the mass proportion to the inorganic solid electrolyte-containing composition) in the inorganic solid electrolyte-containing composition, and specifically, it is a value measured by carrying out filtration through a 0.02 μm membrane filter and then Karl Fischer titration.

The inorganic solid electrolyte-containing composition according to the aspect of the present invention includes an aspect containing not only an inorganic solid electrolyte, a polymer binder, and a dispersion medium but also an active material, as well as a conductive auxiliary agent or the like (the composition in this aspect may be referred to as the “electrode composition”).

Hereinafter, components that are contained and components that can be contained in the inorganic solid electrolyte-containing composition according to the embodiment of the present invention will be described.

<Inorganic Solid Electrolyte>

The inorganic solid electrolyte-containing composition according to the embodiment of the present invention contains an inorganic solid electrolyte (it is also referred to as inorganic solid electrolyte particles in a case of having a particle shape).

In the present invention, the inorganic solid electrolyte is an inorganic solid electrolyte, where the solid electrolyte refers to a solid-form electrolyte capable of migrating ions therein. The inorganic solid electrolyte is clearly distinguished from the organic solid electrolyte (the polymeric electrolyte such as polyethylene oxide (PEO) or the organic electrolyte salt such as lithium bis(trifluoromethanesulfonyl)imide (LiTFSI)) since it does not include any organic substance as a principal ion-conductive material. In addition, the inorganic solid electrolyte is solid in a steady state and thus, typically, is not dissociated or liberated into cations and anions. Due to this fact, the inorganic solid electrolyte is also clearly distinguished from inorganic electrolyte salts of which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has an ion conductivity of a metal belonging to Group 1 or Group 2 in the periodic table and generally does not have electron conductivity. In a case where the all-solid state secondary battery according to the embodiment of the present invention is a lithium ion battery, the inorganic solid electrolyte preferably has a lithium ion conductivity.

As the inorganic solid electrolyte, a solid electrolyte material that is typically used for an all-solid state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based inorganic solid electrolyte. The sulfide-based inorganic solid electrolytes are preferably used from the viewpoint that it is possible to form a more favorable interface between the active material and the inorganic solid electrolyte.

(i) Sulfide-Based Inorganic Solid Electrolyte

The sulfide-based inorganic solid electrolyte is preferably an electrolyte that contains a sulfur atom, has an ion conductivity of a metal belonging to Group 1 or Group 2 in the periodic table, and has electron-insulating properties. The sulfide-based inorganic solid electrolytes are preferably inorganic solid electrolytes which, as elements, contain at least Li, S, and P and have a lithium ion conductivity, but the sulfide-based inorganic solid electrolytes may also include elements other than Li, S, and P depending on the purposes or cases.

Examples of the sulfide-based inorganic solid electrolyte include a lithium ion-conductive inorganic solid electrolyte satisfying the composition represented by Formula (S1).

Lₐ₁M_{b1}P_{c1}S_{d1}Aₑ₁ (S1)

In the formula, L represents an element selected from Li, Na, or K and is preferably Li. M represents an element selected from B, Zn, Sn, Si, Cu, Ga, Sb, Al, or Ge. A represents an element selected from I, Br, Cl, or F. a1 to e1 represent the compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two or more raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio of Li₂S to P₂S₅ in Li—P—S-based glass and Li—P—S-based glass ceramic is preferably 60:40 to 90:10 and more preferably 68:32 to 78:22 in terms of the molar ratio, Li₂S:P₂S₅. In a case where the ratio between Li₂S and P₂S₅ is set in the above-described range, it is possible to increase a lithium ion conductivity. Specifically, the lithium ion conductivity can be preferably set to 1×10⁻⁴ S/cm or more and more preferably set to 1×10⁻³ S/cm or more. The upper limit is not particularly limited but realistically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S-Ges₂-Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—Li₄SiO₄, Li₂S—SiS₂—Li₃PO₄, and Li₁₀GeP₂Si₂. The mixing ratio between the individual raw materials does not matter. Examples of the method of synthesizing a sulfide-based inorganic solid electrolyte material using the above-described raw material compositions include an amorphization method. Examples of the amorphization method include a mechanical milling method, a solution method, and a melting quenching method. This is because treatments at a normal temperature become possible, and it is possible to simplify manufacturing processes.

(ii) Oxide-Based Inorganic Solid Electrolyte

The oxide-based inorganic solid electrolyte is preferably an electrolyte that contains an oxygen atom, has an ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit is not particularly limited; however, it is practically 1×10⁻¹ S/cm or less.

Specific examples of the compound include LiₓₐLa_{ya}TiO₃ (LLT) [xa satisfies 0.3≤xa≤0.7, and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{cc}_{zc}O_{nc} (M^{cc} is one or more elements selected from C, S, Al, Si, Ga, Ge, In, and Sn, xc satisfies 0≤xc≤5, yc satisfies 0≤yc≤1, zc satisfies 0≤zc≤1, and nc satisfies 0≤nc≤6); Li_{xd}(Al, Ga)_{yd}(Ti, Ge)_{zd}Si_{ad}P_{md}O_{nd} (xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13); Li₍₃₋₂ₓₑ₎M^{ee}ₓₑD^{ee}O (xe represents a number 0 or more and 0.1 or less, and M^{ee} represents a divalent metal atom, D^{ee} represents a halogen atom or a combination of two or more halogen atoms); Li_{xf}Si_{yf}O_{zf} (xf satisfies 1≤xf≤5, yf satisfies 0<yf≤3, zf satisfies 1≤zf≤10); Li_{xg}S_{yg}O_{zg} (xg satisfies 1≤xg≤3, yg satisfies 0<yg≤2, zg satisfies 1≤zg≤10); Li₃BO₃; Li₃BO₃—Li₂SO₄; Li₂O—B₂O₃—P₂O₅; Li₂O—SiO₂; Li₆BaLa₂Ta₂O₁₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh-+yh}(Al, Ga)ₓₕh(Ti, Ge)₂₋ₓₕSi_{yh}P_{3-yh}O₁₂ (xh satisfies 0≤xh≤1, and yh satisfies 0≤yh≤1); and Li₇La₃Zr₂O₁₂ (LLZ) having a garnet-type crystal structure.

In addition, a phosphorus compound containing Li, P, or O is also desirable. Examples thereof include lithium phosphate (Li₃PO₄); LiPON in which a part of oxygen atoms in lithium phosphate are substituted with a nitrogen atom; and LiPOD¹ (D¹ is preferably one or more elements selected from Ti, V, Cr, Mn, Fe, Co, Ni, Cu, Zr, Nb, Mo, Ru, Ag, Ta, W, Pt, and Au). Further, it is also possible to preferably use LiA¹ON (A¹ is one or more elements selected from Si, B, Ge, Al, C, and Ga).

(iii) Halide-Based Inorganic Solid Electrolyte

The halide-based inorganic solid electrolyte is preferably a compound that contains a halogen atom, has an ion conductivity of a metal belonging to Group 1 or Group 2 in the periodic table, and has electron-insulating properties.

The halide-based inorganic solid electrolyte is not particularly limited; however, examples thereof include LiCl, LiBr, LiI, and compounds such as Li₃YBr₆ or Li₃YCl₆ described in ADVANCED MATERIALS, 2018, 30, 1803075. In particular, Li₃YBr₆ or Li₃YCl₆ is preferable.

(iv) Hydride-Based Inorganic Solid Electrolyte

The hydride-based inorganic solid electrolyte is preferably a compound that contains a hydrogen atom, has an ion conductivity of a metal belonging to Group 1 or Group 2 in the periodic table, and has electron-insulating properties.

The hydride-based inorganic solid electrolyte is not particularly limited; however, examples thereof include LiBH₄, Li₄(BH₄)₃I, and 3LiBH₄—LiCl.

The inorganic solid electrolyte is preferably particulate. In this case, the particle diameter (the volume average particle diameter) of the inorganic solid electrolyte is not particularly limited; however, it is preferably 0.01 μm or more and more preferably 0.1 μm or more. The upper limit is preferably 100 μm or less and more preferably 50 μm or less.

The particle diameter of the inorganic solid electrolyte is measured according to the following procedure. Using water (heptane in a case where the inorganic solid electrolyte is unstable in water), the inorganic solid electrolyte particles are diluted in a 20 mL sample bottle to prepare 1% by mass of a dispersion liquid. The diluted dispersion liquid sample is irradiated with 1 kHz ultrasonic waves for 10 minutes and is then immediately used for testing. Data collection is carried out 50 times using this dispersion liquid sample, a laser diffraction/scattering-type particle size distribution analyzer LA-920 (product name, manufactured by Horiba Ltd.), and a quartz cell for measurement at a temperature of 25° C. to obtain the volume average particle diameter. Other detailed conditions and the like can be found in JIS Z8828: 2013 “particle diameter Analysis-Dynamic Light Scattering” as necessary. Five samples per level are produced and measured, and the average values thereof are employed.

The inorganic solid electrolyte-containing composition may contain one kind or two or more kinds of inorganic solid electrolytes.

In a case of forming a solid electrolyte layer, the mass (mg) (mass per unit area) of the inorganic solid electrolyte per unit area (cm²) of the solid electrolyte layer is not particularly limited. It can be appropriately determined according to the designed battery capacity and can be set to, for example, 1 to 100 mg/cm².

However, in a case where the inorganic solid electrolyte-containing composition contains an active material described later, the mass per unit area of the inorganic solid electrolyte is preferably such that the total amount of the active material and the inorganic solid electrolyte is in the above range.

The content of the inorganic solid electrolyte in the inorganic solid electrolyte-containing composition is not particularly limited. However, from the viewpoints of the reduction of dispersion characteristics and the application suitability, it is preferably 50% by mass or more, more preferably 70% by mass or more, and still more preferably 90% by mass or more, with respect to 100% by mass of the solid content. From the same viewpoint, the upper limit thereof is preferably 99.9% by mass or less, more preferably 99.5% by mass or less, and particularly preferably 99% by mass or less.

However, in a case where the inorganic solid electrolyte-containing composition contains an active material described later, regarding the content of the inorganic solid electrolyte in the inorganic solid electrolyte-containing composition described above, the total content of the active material and the inorganic solid electrolyte is preferably in the above-described range.

In the present invention, the solid content (solid component) refers to components that neither volatilize nor evaporate and disappear in a case where the inorganic solid electrolyte-containing composition is subjected to drying treatment at 150° C. for 6 hours in a nitrogen atmosphere at a pressure of 1 mmHg. Typically, the solid content refers to a component other than a dispersion medium described later.

<Polymer Binder>

The inorganic solid electrolyte-containing composition according to the present invention is a polymer binder that exhibits an adsorption rate of 50% or less with respect to an inorganic solid electrolyte in a dispersion medium contained in the composition and contains a polymer binder that satisfies a relationship defined by Expression (1) described later between the polymer binder and the inorganic solid electrolyte in terms of surface energy.

In the inorganic solid electrolyte-containing composition according to the embodiment of the present invention, in a case where the polymer binder is used in combination with solid particles of the inorganic solid electrolyte or the like, it is possible to improve the dispersion characteristics and the application suitability of the inorganic solid electrolyte-containing composition (the slurry).

(Adsorption Rate)

In the present invention, the adsorption rate (%) of a polymer binder is a value measured by using an inorganic solid electrolyte and a specific dispersion medium contained in the inorganic solid electrolyte-containing composition, and it is an indicator that indicates the degree of adsorption of a polymer binder to an inorganic solid electrolyte in this dispersion medium. Here, the adsorption of the polymer binder to the inorganic solid electrolyte includes not only physical adsorption but also chemical adsorption (adsorption by chemical bond formation, adsorption by transfer of electrons, or the like).

In a case where the inorganic solid electrolyte-containing composition contains a plurality of kinds of inorganic solid electrolytes, the adsorption rate is defined as an adsorption rate with respect to the inorganic solid electrolyte having the same composition (kind and content) as the composition of the inorganic solid electrolyte in the inorganic solid electrolyte-containing composition. Similarly, in a case where the inorganic solid electrolyte-containing composition contains a plurality of kinds of specific dispersion media, the adsorption rate is measured by using a dispersion medium having the same composition (the kind and the content) as the specific dispersion media in the inorganic solid electrolyte-containing composition.

It is noted that in a case where the inorganic solid electrolyte-containing composition contains a plurality of kinds of polymer binders, it suffices that any one of the polymer binders satisfies the above-described adsorption rate and a relationship defined by Expression (1) described below when the adsorption rate of each of the specific polymer binders in the inorganic solid electrolyte-containing composition is measured.

In the present invention, the adsorption rate of the polymer binder is a value calculated according to the method described in Examples.

The adsorption rate of the polymer binder is 50% or less. In a case where the polymer binder exhibits the above adsorption rate, it is possible to suppress the excessive adsorption to the inorganic solid electrolyte and improve the dispersion characteristics and the application suitability of the inorganic solid electrolyte-containing composition. The adsorption rate is preferably 40% or less, more preferably 30% or less, still more preferably less than 20%, and particularly preferably 15% or less, in that both dispersion characteristics and application suitability can be achieved at a higher level. In addition, it is also preferable to set it to 10% or less. On the other hand, the lower limit of the adsorption rate is not particularly limited and may be 0%. The lower limit of the adsorption rate is preferably small from the viewpoint of dispersion characteristics and application suitability; however, on the other hand, it is preferably 3% or more, more preferably 5% or more, and still more preferably 7% or more, from the viewpoint of improving the binding property of the inorganic solid electrolyte.

In the present invention, the adsorption rate with respect to the inorganic solid electrolyte is appropriately set depending on the characteristics (for example, the mass average molecular weight) of the polymer that forms a polymer binder, the kind or content of the functional group contained in the polymer, the form of the polymer binder (the amount dissolved in the dispersion medium).

The polymer binder may be soluble (a soluble type binder) or insoluble (an insoluble type binder) in the dispersion medium contained in the inorganic solid electrolyte-containing composition; however, it is preferably a soluble type binder dissolved in the dispersion medium. In a case where two or more kinds of polymer binders are contained, it is preferable that at least one kind of polymer binder is soluble, and it is more preferable that all the polymer binders are soluble.

In the present invention, the description that the polymer binder is dissolved in a dispersion medium means that a polymer binder is dissolved in a dispersion medium of the inorganic solid electrolyte-containing composition, and for example, it means that the solubility is 10% by mass or more in the solubility measurement. On the other hand, the insoluble type binder in which a polymer binder is not dissolved in a dispersion medium means that the solubility in the solubility measurement is less than 10% by mass. The measuring method for solubility is as follows.

That is, a specified amount of a polymer binder as a measurement target is weighed in a glass bottle, 100 g of a dispersion medium that is the same kind as the dispersion medium contained in the inorganic solid electrolyte-containing composition is added thereto, and stirring is carried out at a temperature of 25° C. on a mix rotor at a rotation speed of 80 rpm for 24 hours. After stirring for 24 hours, the obtained mixed solution is subjected to the transmittance measurement under the following conditions. This test (the transmittance measurement) is carried out by changing the amount of the polymer binder dissolved (the above-described specified amount), and the upper limit concentration X (% by mass) at which the transmittance is 99.8% is defined as the solubility of the polymer binder in the above dispersion medium.

<Transmittance Measurement Conditions>

Dynamic Light Scattering (DLS) Measurement

Device: DLS measuring device DLS-8000 manufactured by Otsuka Electronics Co., Ltd.

Laser wavelength, output: 488 nm/100 mW

Sample cell: NMR tube

In a case where the inorganic solid electrolyte-containing composition according to the embodiment of the present invention contains an active material described later (in a case where an active material layer is formed of the inorganic solid electrolyte-containing composition), the adsorption rate of the polymer binder to the active material is not particularly limited; however, it is preferably 90% or less, more preferably 0.1% to 50%, and still more preferably 1% to 10% in terms of the dispersion characteristics and the application suitability of the inorganic solid electrolyte-containing composition and the reinforcement of the binding property of solid particles. In the present invention, the adsorption rate of a polymer binder with respect to an active material is a value measured by using an active material and a dispersion medium, which are contained in the inorganic solid electrolyte-containing composition, and it is an indicator that indicates the degree of adsorption of a polymer binder to an active material in this dispersion medium. Here, the adsorption of the polymer binder to the active material includes not only physical adsorption but also chemical adsorption (adsorption by chemical bond formation, adsorption by transfer of electrons, or the like).

As a result, in a case where the inorganic solid electrolyte-containing composition contains a plurality of kinds of active materials, in a case where it contains a plurality of kinds of specific dispersion media, as well as in a case where a plurality of kinds of polymer binders are used, the adsorption rate is the same as that of the polymer binder with respect to the inorganic solid electrolyte, which is described above. In the present invention, the adsorption rate of the polymer binder with respect to the active material shall be a value calculated in the same manner as the method in [Measurement of adsorption rate of binder with respect to inorganic solid electrolyte] described in Example, except that an active material is used instead of the inorganic solid electrolyte. In the present invention, the adsorption rate with respect to the active material can be appropriately set in the same manner as the adsorption rate with respect to the inorganic solid electrolyte.

(Dispersion Element and Polarity Element of Surface Energy)

In the present invention, the polymer binder and the inorganic solid electrolyte satisfy a relationship defined by Expression (1) in terms of surface energy.

(Xse−Xba)²+(Yse−Yba)²≤R² Expression (1)

In the expression, Xse represents a dispersion element of surface energy of the inorganic solid electrolyte, and Yse represents a polarity element of the surface energy of the inorganic solid electrolyte. Xba represents a dispersion element of surface energy of the polymer binder, and Yba represents a polarity element of the surface energy of the polymer binder. R is 20. It is noted that units of Xse, Xba, Yse, Yba, and R are all mN/m.

The left side in Expression (1) indicates the sum of the square of the difference between the dispersion elements and the square of the difference between the polarity elements in terms of surface energies of the polymer binder and the inorganic solid electrolyte, respectively, which indicates that smaller this sum, the higher the affinity between the polymer binder and the inorganic solid electrolyte. In the present invention, the relationship defined in Expression (1) described above is satisfied, that is, the above sum is R² (=400) or less, whereby the polymer binder and the inorganic solid electrolyte exhibit a high affinity with each other, and thus it is presumed that the dispersion step at the time of preparing the inorganic solid electrolyte-containing composition according to the embodiment of the present invention allows the polymer binder to be easily incorporated between the inorganic solid electrolytes, which suppresses the aggregation of the inorganic solid electrolyte and makes it possible to enhance the dispersion characteristics and the application suitability of the inorganic solid electrolyte in the inorganic solid electrolyte-containing composition.

In a case where the inorganic solid electrolyte-containing composition contains a plurality of kinds of inorganic solid electrolytes, the dispersion element and the polarity element of the surface energy shall be those of the inorganic solid electrolyte having the same composition (kind and content) as the composition of the inorganic solid electrolyte in the inorganic solid electrolyte-containing composition. In a case where the inorganic solid electrolyte-containing composition contains a plurality of kinds of specific polymer binders, it suffices that any one of the polymer binders satisfies the above-described adsorption rate and a relationship defined by Expression (1) in a case where the dispersion element and the polarity element of the surface energy of each of the specific polymer binders in the inorganic solid electrolyte-containing composition are measured.

In the present invention, the dispersion element and the polarity element of the surface energy of each of the polymer binder and the inorganic solid electrolyte shall be values calculated according to the method described in Examples.

R in Expression (1) is preferably 18 or less, more preferably 15 or less, still more preferably 10 or less, and particularly preferably 7 or less, in that both dispersion characteristics and application suitability can be achieved at a higher level. On the other hand, the lower limit of R in Expression (1) is not particularly limited and can be set to 0. From the viewpoint of cycle characteristics, 0.3 or more is preferable, 0.6 or more is more preferable, and 0.9 or more is still more preferable.

It is noted that, in any of the upper limit values of R in Expression (1), the first decimal place is 0. That is, R is 20 means that R is 20.0. In addition, the calculated value on the left side in Expression (1) shall be a value that is rounded off to the second decimal place.

In the present invention, the dispersion element and the polarity element of the surface energy of the polymer binder can be appropriately set depending on the constitutional component of the polymer that forms a polymer binder, the kind or content of the functional group of the polymer, the molecular weight, and the like.

In a case where the inorganic solid electrolyte-containing composition according to the embodiment of the present invention contains an active material described later, it is preferable that the active material and the polymer binder satisfy a relationship defined by Expression (2) in terms of surface energy.

(Xam−Xba)²+(Yam−Yba)²≤r² Expression (2)

In the expression, Xam represents a dispersion element of the surface energy of the active material, and Yam represents a polarity element of the surface energy of the active material. Xba represents a dispersion element of surface energy of the polymer binder, and Yba represents a polarity element of the surface energy of the polymer binder. r is 30. It is noted that units of Xam, Xba, Yam, Yba, and r are all mN/m.

The left side in Expression (2) indicates the sum of the square of the difference between the dispersion elements and the square of the difference between the polarity elements in terms of surface energies of the active material and the polymer binder, respectively, which indicates that smaller this sum, the higher the affinity between the active material and the polymer binder. In the present invention, the relationship defined in Expression (2) described above is satisfied, that is, the above sum is r² (=900) or less, whereby the active material and the polymer binder exhibit a high affinity with each other, and thus it is conceived that the dispersion step at the time of preparing the inorganic solid electrolyte-containing composition according to the embodiment of the present invention allows the polymer binder to be easily incorporated between the active materials, which suppresses the aggregation of the active material and makes it possible to enhance the dispersion characteristics and the application suitability of the inorganic solid electrolyte-containing composition.

In a case where the inorganic solid electrolyte-containing composition contains a plurality of kinds of active materials, the dispersion element and the polarity element of the surface energy shall be those of the inorganic solid electrolyte having the same composition (kind and content) as the active material in the inorganic solid electrolyte-containing composition. In a case where the inorganic solid electrolyte-containing composition contains a plurality of kinds of specific polymer binders, it suffices that any one of the polymer binders satisfies the above-described adsorption rate and relationships defined by Expression (1) and Expression (2) in a case where the dispersion element and the polarity element of the surface energy of each of the specific polymer binders in the inorganic solid electrolyte-containing composition are measured.

In the present invention, the dispersion element and the polarity element of the surface energy of the active material shall be values calculated according to the method described in Examples.

r in Expression (2) is preferably 27 or less, more preferably 26 or less, and still more preferably 25 or less, in that both dispersion characteristics and application suitability can be achieved at a higher level. On the other hand, the lower limit of r in Expression (2) is not particularly limited and can be set to 0. From the viewpoint of cycle characteristics, 0.5 or more is preferable, 1.0 or more is more preferable, and 1.5 or more is still more preferable.

It is noted that, in any of the upper limit values of r in Expression (2), the first decimal place is 0. That is, r is 30 means that R is 30.0. In addition, the calculated value on the left side in Expression (2) shall be a value that is rounded off to the second decimal place. Similarly, in Expressions (3) and (4) described later, the value on the right side is 0 in the first decimal place, and the calculated value on the left side is a value that is rounded off to the second decimal place.

In addition, in a case where the inorganic solid electrolyte-containing composition according to the embodiment of the present invention contains an active material described later, it is preferable that the inorganic solid electrolyte, the polymer binder, and the active material satisfy a relationship defined by Expression (3) in terms of surface energy.

R_{SE}+R_{AM}≤30 Expression (3)

in the expression, R_{SE}² represents a left side of Expression (1), and R_{AM}² represents a left side of Expression (2). That is, R_{SE} means {(Xse−Xba)²+(Yse−Yba)²}^{0.5}, and R_{AM} means {(Xam−Xba)²+(Yam−Yba)²}^{0.5}.

The left side in Expression (3) indicates the sum of the left side to the power of 0.5 in Expression (1) and the left side to the power of 0.5 in Expression (2), and it is indicated that the smaller this sum, the higher both the affinity between the inorganic solid electrolyte and the polymer binder and the affinity between the active material and the polymer binder. In the present invention, the relationship defined in Expression (3) described above is satisfied, that is, the above sum is 30 or less, whereby both the active material and the inorganic solid electrolyte exhibit a high affinity with a polymer binder, and thus it is conceived that the dispersion step at the time of preparing the inorganic solid electrolyte-containing composition according to the embodiment of the present invention allows the polymer binder to be easily incorporated between the inorganic solid electrolytes and between the active materials, which suppresses the aggregation of the inorganic solid electrolyte and the aggregation of the active material and makes it possible to enhance the dispersion characteristics and the application suitability of the inorganic solid electrolyte and the active material in the inorganic solid electrolyte-containing composition.

In a case where the inorganic solid electrolyte-containing composition contains a plurality of kinds of active materials, the dispersion element and the polarity element of the surface energy shall be those of the inorganic solid electrolyte having the same composition (kind and content) as the active material in the inorganic solid electrolyte-containing composition. In a case where the inorganic solid electrolyte-containing composition contains a plurality of kinds of specific polymer binders, it suffices that any one of the polymer binders satisfies the above-described adsorption rate and relationships defined by Expression (1) to Expression (3) in a case where the dispersion element and the polarity element of the surface energy of each of the specific polymer binders in the inorganic solid electrolyte-containing composition are measured.

R_{SE}+R_{AM} in Expression (3) is preferably 27 or less, in that both dispersion characteristics and application suitability can be achieved at a higher level. On the other hand, the lower limit of R_{SE}+R_{AM} in Expression (3) is not particularly limited and can be also set to 0. From the viewpoint of cycle characteristics, 1.0 or more is preferable, 2.0 or more is more preferable, and 3.0 or more is still more preferable.

In an inorganic solid electrolyte and an active material which are generally used in an all-solid state secondary battery, the inorganic solid electrolyte is easily aggregated as compared with the active material, and thus it is important to enhance the dispersibility of the inorganic solid electrolyte from the viewpoint of effectively enhancing the dispersion characteristics and the application suitability of the inorganic solid electrolyte-containing composition. Therefore, in a case where the inorganic solid electrolyte-containing composition according to the embodiment of the present invention contains an active material described later, It is preferable to satisfy a relationship defined by Expression (4) below from the viewpoint of further enhancing the dispersion characteristics and the application suitability of the inorganic solid electrolyte-containing composition.

R_{AM}−R_{SE}≥−13 Expression (4)

In the expression, R_{SE} and R_{AM} respectively have the same meanings as R_{SE} and R_{AM} in Expression (3).

In the present invention, the relationship defined in Expression (4) described above is satisfied, and thus it is conceived that the dispersion step at the time of preparing the inorganic solid electrolyte-containing composition according to the embodiment of the present invention allows the polymer binder to be capable of being incorporated between the inorganic solid electrolytes even in a case where both the inorganic solid electrolyte and the active material are present together, whereby the aggregation of the inorganic solid electrolyte can be effectively suppressed.

R_{AM}−R_{SE} in Expression (4) is preferably −9 or more, more preferably −3 or more, and still more preferably 0 or more, in that both dispersion characteristics and application suitability can be achieved at a higher level. On the other hand, the upper limit of the R_{AM}−R_{SE} in Expression (4) is not particularly limited and can be set to 30, where 25 or less is preferable.

The polymer that forms the polymer binder is not particularly limited as long as it satisfies the above adsorption rate with respect to the inorganic solid electrolyte, and various polymers can be used.

In terms of dispersion stability, it is preferable not to be reacted with the inorganic solid electrolyte due to heating at the time of the preparation of the inorganic solid electrolyte-containing composition and the production of the sheet for an all-solid state secondary battery or the all-solid state secondary battery, and specifically, it is preferable that the polymer does not have an ethylenically unsaturated double bond.

Among the above, a polymer having a polymerized chain of carbon-carbon double bonds is preferably mentioned in the main chain is preferably mentioned.

In a case where two or more kinds of polymer binders are contained, it is preferable that the polymer that forms at least one kind of polymer binder is a polymer having the above-described polymerized chain in the main chain, and an aspect in which the polymer that forms all the polymer binders is a polymer having the above-described polymerized chain in the main chain is also one of the preferred aspects.

In the present invention, a main chain of the polymer refers to a linear molecular chain in which all the molecular chains that constitute the polymer other than the main chain can be conceived as a branched chain or a pendant with respect to the main chain. Although it depends on the mass average molecular weight of the molecular chain regarded as a branched chain or pendant chain, the longest chain among the molecular chains that constitute the polymer is typically the main chain. In this case, a terminal group at the polymer terminal is not included in the main chain. In addition, side chains of the polymer refer to molecular chains other than the main chain and include a short molecular chain and a long molecular chain.

Examples of the polymer having a polymerized chain of carbon-carbon double bonds in the main chain include chain polymerization polymers such as a fluorine-based polymer (a fluorine-containing polymer), a hydrocarbon-based polymer, a vinyl polymer, and a (meth)acrylic polymer. The polymerization mode of these chain polymerization polymers is not particularly limited, and the chain polymerization polymer may be any one of a block copolymer, an alternating copolymer, or a random copolymer.

As the polymer that forms a polymer binder, each of the above-described polymers can be appropriately selected, where a fluorine-based polymer or a (meth)acrylic polymer is preferable, and a (meth)acrylic polymer is more preferable.

The polymer that forms a polymer binder may be one kind or two or more kinds.

(Constitutional Component Having Functional Group Selected from Group (a) of Functional Groups)

The polymer that constitutes the polymer binder preferably contains a constitutional component having a functional group selected from the following group (a) of functional groups. In a case where two or more kinds of polymer binders are contained, the polymer that forms at least one kind of polymer binder preferably has a constitutional component having this functional group, and an aspect in which the polymers that form all the polymer binders include the constitutional component having this functional group is also one of the preferred aspects. The constitutional component having a functional group has a function of improving the adsorption rate of the polymer binder with respect to the inorganic solid electrolyte and may be any constitutional component that forms the polymer.

The functional group may be incorporated into the main chain or the side chain of the polymer. In the case of being incorporated into the side chain, the functional group may be directly bonded to the main chain or may be bonded through a linking group. The linking group is not particularly limited; however, examples thereof include a linking group described later.

In the chain polymerization polymer, the constitutional component having an ester bond (excluding an ester bond that forms a carboxy group) or an amide bond means a constitutional component in which an ester bond or an amide bond is not directly bonded to an atom that constitutes the main chain of a chain polymerization polymer or the main chain of a polymerized chain (for example, a polymerized chain contained in a macromonomer) that is incorporated into the chain polymerization polymer as a branched chain or a pendant chain, and it does not include, for example, a constitutional component derived from a (meth)acrylic acid alkyl ester.

The functional group contained in one constitutional component may be one kind or two or more kinds, and in a case where two or more kinds are contained, they may be or may not be bonded to each other.

<Group (a) of Functional Groups>

A hydroxy group, an amino group, a carboxy group, a sulfo group, a phosphate group, a phosphonate group, a sulfanyl group, an ether bond (—O—), an imino group (═NR, or —NR—), an ester bond (—CO—O—), an amide bond (—CO—NR—), a urethane bond (—NR—CO—O—), a urea bond (—NR—CO—NR—), a heterocyclic group, an aryl group, a carboxylic acid anhydride group, and a fluoroalkyl group

Each of the amino group, the sulfo group, the phosphate group (the phosphoryl group), the heterocyclic group, and the aryl group, which are included in the group (a) of functional groups, is not particularly limited; however, it has the same meaning as the corresponding group of the substituent Z described later. However, the amino group more preferably has 0 to 12 carbon atoms, still more preferably 0 to 6 carbon atoms, and particularly preferably 0 to 2 carbon atoms. The phosphonate group is not particularly limited; however, examples thereof include a phosphonate group having 0 to 20 carbon atoms. In a case where a ring structure contains an amino group, an ether bond, an imino group (—NR—), an ester bond, an amide bond, a urethane bond, a urea bond, or the like, it is classified as a heterocycle. The hydroxy group, the amino group, the carboxy group, the sulfo group, the phosphate group, the phosphonate group, or the sulfanyl group may form a salt.

The fluoroalkyl group is a group obtained by substituting at least one hydrogen atom of an alkyl group or cycloalkyl group with a fluorine atom, and it preferably has 1 to 20 carbon atoms, more preferably 2 to 15 carbon atoms, and still more preferably 3 to 10 carbon atoms. Regarding the number of fluorine atoms on the carbon atom, a part of the hydrogen atoms may be substituted, or all the hydrogen atoms may be substituted (a perfluoroalkyl group).

The siloxane group is not particularly limited, and it is preferably, for example, a group having a structure represented by —(SiR₂—O)ₙ—. The repetition number n is preferably an integer of 1 to 100, more preferably an integer of 5 to 50, and still more preferably an integer of 10 to 30.

R in each bond represents a hydrogen atom or a substituent, and it is preferably a hydrogen atom. The substituent is not particularly limited. It is selected from a substituent Z described later, and an alkyl group is preferable.

The carboxylic acid anhydride group is not particularly limited; however, it includes a group obtained by removing one or more hydrogen atoms from a carboxylic acid anhydride (for example, a group represented by Formula (2a)), as well as a constitutional component itself (for example, a constitutional component represented by Formula (2b)) obtained by copolymerizing a polymerizable carboxylic acid anhydride as a copolymerizable compound. The group obtained by removing one or more hydrogen atoms from a carboxylic acid anhydride is preferably a group obtained by removing one or more hydrogen atoms from a cyclic carboxylic acid anhydride. The carboxylic acid anhydride group derived from a cyclic carboxylic acid anhydride also corresponds to a heterocyclic group; however, it is classified as a carboxylic acid anhydride group in the present invention. Examples thereof include acyclic carboxylic acid anhydrides such as acetic acid anhydride, propionic acid anhydride, and benzoic acid anhydride, and cyclic carboxylic acid anhydrides such as maleic acid anhydride, phthalic acid anhydride, fumaric acid anhydride, and succinic acid anhydride. The polymerizable carboxylic acid anhydride is not particularly limited; however, examples thereof include a carboxylic acid anhydride having an unsaturated bond in the molecule, and a polymerizable cyclic carboxylic acid anhydride is preferable. Specific examples thereof include maleic acid anhydride.

Examples of the carboxylic acid anhydride group include a group represented by Formula (2a) and a constitutional component represented by Formula (2b); however, the present invention is not limited thereto. In each of the formulae, * represents a bonding position.

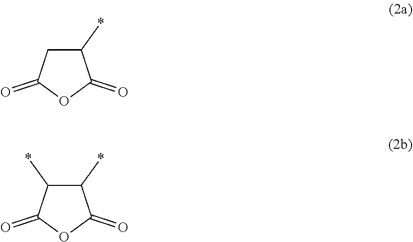 [SMILES: *C1CC(=O)OC1=O ; *C1C(=O)OC(=O)C1*]

The linking group that binds a functional group to the main chain is not particularly limited; however, it has the same meaning as the linking group in the group having a hydrocarbon group having 4 or more carbon atoms, except for the particularly preferred linking group that can be adopted as R² of Formula (1-1) described later. As the linking group that binds a functional group to the main chain, a particularly preferred linking group is a group obtained by combining a —CO—O— group or —CO—N(R^{N})— group (here, R^{N} is as described above) and an alkylene group or polyalkyleneoxy chain.

The method of incorporating a functional group into a polymer chain is not particularly limited, and examples thereof include a method of using a compound having a functional group selected from the group (a) of functional groups as a copolymerizable compound, a method of using a polymerization initiator having (generating) the above-described functional group or a chain transfer agent, and a method of using a polymeric reaction. Alternatively, a functional group can be introduced by using a functional group that is present in the main chain, the side chain, or the terminal of the polymer, as a reaction point. For example, as shown in Examples described later, a functional group selected from the group (a) of functional groups can be introduced by various reactions with a carboxylic acid anhydride group in a polymer chain using a compound having a functional group.

The compound having the above-described functional group is not particularly limited; however, examples thereof include a compound having at least one carbon-carbon unsaturated bond and at least one functional group described above. For example, it includes a compound in which a carbon-carbon unsaturated bond and the above-described functional group are directly bonded, a compound in which a carbon-carbon unsaturated bond and the above-described functional group are bonded through a linking group, as well as a compound (for example, the polymerizable cyclic carboxylic acid anhydride) in which the functional group itself contains a carbon-carbon unsaturated bond. Further, the compound having the above-described functional group include compounds that are capable of introducing a functional group into the polymer constitutional component after polymerization by various reactions (for example, alcohol and each of the amino, mercapto, and epoxy compounds (including polymers thereof), which are capable of undergoing an addition reaction or condensation reaction with a constitutional component derived from carboxylic acid anhydride, a constitutional component having a carbon-carbon unsaturated bond, or the like). Further, examples of the compound having the above-described functional group also include a compound in which a carbon-carbon unsaturated bond is bonded directly or via a linking group to a macromonomer having a functional group incorporated as a substituent in the polymerized chain (for example, AS-6 (product name, a styrene macromonomer, manufactured by TOAGOSEI Co., Ltd.) described later). Examples of the macromonomer from which a macromonomer constitutional component is derived include a macromonomer having a polymerized chain of a chain polymerization polymer described later.

The number average molecular weight of the macromonomer is not particularly limited; however, it is preferably 500 to 100,000, more preferably 1,000 to 50,000, and still more preferably 2,000 to 20,000, in that the binding force of solid particles as well as the adhesiveness to the collector can be further strengthened while maintaining excellent dispersion characteristics and excellent application suitability. The content of the repeating unit having a functional group that is incorporated into the macromonomer is preferably 1% to 100% by mole, more preferably 3% to 80% by mole, and still more preferably 5% to 70% by mole. The content of the repeating unit having no functional group is preferably 0%% to 90% by mole, more preferably 0% to 70% by mole, and still more preferably 0% to 50% by mole. Any component can be selected from the viewpoint of solubility.

The constitutional component having the above-described functional group is not particularly limited as long as it has the above-described functional group; however, examples thereof include a constitutional component obtained by introducing the above functional group into a (meth)acrylic compound (M1) or another polymerizable compound (M2) described later, a constitutional component represented by any one of Formulae (b-1) to (b-3), or a constitutional component represented by Formulae (1-1) described later.

The compound from which a constitutional component having the above functional group is derived is not particularly limited; however, examples thereof include a polymerizable cyclic carboxylic acid anhydride and a compound in which the above functional group is introduced into a fluoroalkyl group-containing (meth)acrylic acid short-chain alkyl ester compound (here, short-chain alkyl means an alkyl group having 3 or less of carbon atoms).

The content of the constitutional component having the above functional group in the polymer is not particularly limited as long as the adsorption rate of the polymer binder with respect to the inorganic solid electrolyte can be suppressed to 50% or less.

The content thereof is preferably 0.01% to 80% by mole, more preferably 0.01% to 70% by mole, still more preferably 0.1% to 50% by mole, and particularly preferably 0.3% to 50% by mole, in terms of the binding property of solid particles. The lower limit value of the content can be set to 5% by mole or more or 20% by mole or more.

In a case where the polymer has a plurality of constitutional components having a functional group, the content of the constitutional components having a functional group is adopted as the total amount. In addition, in a case where one constitutional component has a plurality of functional groups or a plurality of kinds of functional groups, the content of this constitutional component having functional groups is generally employed as the content of the constitutional component. However, for an SEBS binder described later, the total amount of contents in terms of the respective functional groups shall be adopted, for convenience, in relation to the adsorption rate or the like of the SEBS binder. However, in a case where a plurality of functional groups or a plurality of kinds of functional groups are present in one molecular chain (in a case of being derived from a common raw material compound), the contents in terms of the respective functional groups are not included for calculation in the above total amount, but contents of the plurality of functional groups or the plurality of kinds of functional groups are included for calculation in the total amount as one content in terms of one functional group.

In a case where two or more kinds of polymer binders are contained, the content of the constitutional component having the above functional group with respect to the total number of moles of the constitutional components of the polymers that form all the polymer binders is not particularly limited, and it is appropriately set according to the content in each of the above polymers.

—Substituent Z—

The examples are an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, and 1-carboxymethyl), an alkenyl group (preferably an alkenyl group having 2 to 20 carbon atoms, such as vinyl, allyl, and oleyl), an alkynyl group (preferably an alkynyl group having 2 to 20 carbon atoms, for example, ethynyl, butadynyl, and phenylethynyl), a cycloalkyl group (preferably a cycloalkyl group having 3 to 20 carbon atoms, such as cyclopropyl, cyclopentyl, cyclohexyl, and 4-methylcyclohexyl; in the present specification, the alkyl group generally has a meaning including a cycloalkyl group therein when being referred to, however, it will be described separately here), an aryl group (preferably an aryl group having 6 to 26 carbon atoms, such as phenyl, 1-naphthyl, 4-methoxyphenyl, 2-chlorophenyl, and 3-methylphenyl), an aralkyl group (preferably an aralkyl group having 7 to 23 carbon atoms, for example, benzyl or phenethyl), and a heterocyclic group (preferably a heterocyclic group having 2 to 20 carbon atoms and more preferably a 5- or 6-membered heterocyclic group having at least one oxygen atom, one sulfur atom, or one nitrogen atom. The heterocyclic group includes an aromatic heterocyclic group and an aliphatic heterocyclic group. Examples thereof include a tetrahydropyran ring group, a tetrahydrofuran ring group, a 2-pyridyl group, a 4-pyridyl group, a 2-imidazolyl group, a 2-benzimidazolyl group, a 2-thiazolyl group, a 2-oxazolyl group, or a pyrrolidone group); an alkoxy group (preferably an alkoxy group having 1 to 20 carbon atoms, for example, a methoxy group, an ethoxy group, an isopropyloxy group, or a benzyloxy group); an aryloxy group (preferably an aryloxy group having 6 to 26 carbon atoms, for example, a phenoxy group, a 1-naphthyloxy group, a 3-methylphenoxy group, or a 4-methoxyphenoxy group; in the present specification, the aryloxy group has a meaning including an aryloyloxy group therein when being referred to); a heterocyclic oxy group (a group in which an —O— group is bonded to the above-described heterocyclic group), an alkoxycarbonyl group (preferably an alkoxycarbonyl group having 2 to 20 carbon atoms, for example, an ethoxycarbonyl group, a 2-ethylhexyloxycarbonyl group, or a dodecyloxycarbonyl group); an aryloxycarbonyl group (preferably an aryloxycarbonyl group having 6 to 26 carbon atoms, for example, a phenoxycarbonyl group, a 1-naphthyloxycarbonyl group, a 3-methylphenoxycarbonyl group, or a 4-methoxyphenoxycarbonyl group); an amino group (preferably an amino group having 0 to 20 carbon atoms, an alkylamino group, or an arylamino group, for example, an amino (—NH₂) group, an N,N-dimethylamino group, an N,N-diethylamino group, an N-ethylamino group, or an anilino group); a sulfamoyl group (preferably a sulfamoyl group having 0 to 20 carbon atoms, for example, an N,N-dimethylsulfamoyl group or an N-phenylsufamoyl group); an acyl group (an alkylcarbonyl group, an alkenylcarbonyl group, an alkynylcarbonyl group, an arylcarbonyl group, or a heterocyclic carbonyl group, preferably an acyl group having 1 to 20 carbon atoms, for example, an acetyl group, a propionyl group, a butyryl group, an octanoyl group, a hexadecanoyl group, an acryloyl group, a methacryloyl group, a crotonoyl group, a benzoyl group, a naphthoyl group, or a nicotinoyl group); an acyloxy group (an alkylcarbonyloxy group, an alkenylcarbonyloxy group, an alkynylcarbonyloxy group, an arylcarbonyloxy group, or a heterocyclic carbonyloxy group, preferably an acyloxy group having 1 to 20 carbon atoms, for example, an acetyloxy group, a propionyloxy group, a butyryloxy group, an octanoyloxy group, a hexadecanoyloxy group, an acryloyloxy group, a methacryloyloxy group, a crotonoyloxy group, a benzoyloxy group, a naphthoyloxy group, or a nicotinoyloxy group); an aryloyloxy group (preferably an aryloyloxy group having 7 to 23 carbon atoms, for example, a benzoyloxy group); a carbamoyl group (preferably a carbamoyl group having 1 to 20 carbon atoms, for example, an N,N-dimethylcarbamoyl group or an N-phenylcarbamoyl group); an acylamino group (preferably an acylamino group having 1 to 20 carbon atoms, for example, an acetylamino group or a benzoylamino group); an alkylthio group (preferably an alkylthio group having 1 to 20 carbon atoms, for example, a methylthio group, an ethylthio group, an isopropylthio group, or a benzylthio group); an arylthio group (preferably an arylthio group having 6 to 26 carbon atoms, for example, a phenylthio group, a 1-naphthylthio group, a 3-methylphenylthio group, or a 4-methoxyphenylthio group); a heterocyclic thio group (a group in which an —S— group is bonded to the above-described heterocyclic group), an alkylsulfonyl group (preferably an alkylsulfonyl group having 1 to 20 carbon atoms, for example, a methylsulfonyl group or an ethylsulfonyl group), an arylsulfonyl group (preferably an arylsulfonyl group having 6 to 22 carbon atoms, for example, a benzenesulfonyl group), an alkylsilyl group (preferably an alkylsilyl group having 1 to 20 carbon atoms, for example, a monomethylsilyl group, a dimethylsilyl group, a trimethylsilyl group, or a triethylsilyl group); an arylsilyl group (preferably an arylsilyl group having 6 to 42 carbon atoms, for example, a triphenylsilyl group), an alkoxysilyl group (preferably an alkoxysilyl group having 1 to 20 carbon atoms, for example, a monomethoxysilyl group, a dimethoxysilyl group, a trimethoxysilyl group, or a triethoxysilyl group), an aryloxysilyl group (preferably an aryloxysilyl group having 6 to 42 carbon atoms, for example, a triphenyloxysilyl group), a phosphate group (preferably a phosphate group having 0 to 20 carbon atoms, for example, —OP(═O)(R^{P})₂), a phosphonyl group (preferably a phosphonyl group having 0 to 20 carbon atoms, for example, —P(═O)(R^{P})₂), a phosphinyl group (preferably a phosphinyl group having 0 to 20 carbon atoms, for example, —P(R^{P})₂), a phosphonate group (preferably a phosphonate group having 0 to 20 carbon atoms, for example, —PO(OR^{P})₂), a sulfo group (a sulfonate group), a carboxy group, a hydroxy group, a sulfanyl group, a cyano group, and a halogen atom (for example, a fluorine atom, a chlorine atom, a bromine atom, or an iodine atom). R^{P} represents a hydrogen atom or a substituent (preferably a group selected from the substituent Z).

In addition, each group exemplified in the substituent Z may be further substituted with the substituent Z.

The alkyl group, the alkylene group, the alkenyl group, the alkenylene group, the alkynyl group, the alkynylene group, and/or the like may be cyclic or chained, may be linear or branched.

[Fluorine-Containing Polymer]

Examples of the fluorine-containing polymer include polytetrafluoroethylene (PTFE), polyvinylene difluoride (PVdF), a copolymer of polyvinylene difluoride and hexafluoropropylene (PVdF-HFP), and a copolymer (PVdF-HFP-TFE) of polyvinylene difluoride, hexafluoropropylene, and tetrafluoroethylene. In PVdF-HFP, the copolymerization ratio [PVdF:HFP] (mass ratio) of PVdF to HFP is not particularly limited; however, it is preferably 9:1 to 5:5 and more preferably 9:1 to 7:3 from the viewpoint of adhesiveness. In PVdF-HFP-TFE, the copolymerization ratio [PVdF:HFP:TFE] (mass ratio) of PVdF, HFP, and TFE is not particularly limited; however, it is preferably 20 to 60:10 to 40:5 to 30, and more preferably 25 to 50:10 to 35:10 to 25.

[Hydrocarbon-Based Polymer]

Examples of the hydrocarbon-based polymer include polyethylene, polypropylene, natural rubber, polybutadiene, polyisoprene, polystyrene, a polystyrene butadiene copolymer, a styrene-based thermoplastic elastomer, polybutylene, an acrylonitrile butadiene copolymer, and hydrogen-added (hydrogenated) polymers thereof. The styrene-based thermoplastic elastomer or the hydride thereof is not particularly limited. However, examples thereof include a styrene-ethylene-butylene-styrene block copolymer (SEBS), a styrene-isoprene-styrene block copolymer (SIS), a hydrogenated SIS, a styrene-butadiene-styrene block copolymer (SBS), a hydrogenated SBS, a styrene-ethylene-ethylene-propylene-styrene block copolymer (SEEPS), a styrene-ethylene-propylene-styrene block copolymer (SEPS), a styrene-butadiene rubber (SBR), a hydrogenated a styrene-butadiene rubber (HSBR), and furthermore, a random copolymer corresponding to each of the above-described block copolymers such as SEBS. In the present invention, the hydrocarbon-based polymer preferably has no unsaturated group (for example, a 1,2-butadiene constitutional component) that is bonded to the main chain from the viewpoint that the formation of chemical crosslink can be suppressed.

It is also preferable that in addition to the constitutional component (for example, styrene) that constitutes the hydrocarbon-based polymer described above, the hydrocarbon-based polymer contains a constitutional component (a constitutional component having a functional group) derived from a compound having a functional group selected from the above-described group (a) of functional groups, and examples of the constitutional component include a constitutional component derived from a polymerizable cyclic carboxylic acid anhydride such as maleic acid anhydride. Further, the constitutional component having a functional group also includes, for example, a constitutional component obtained by introducing a functional group selected from the above-described group (a) of functional groups described later or the like by various reactions into the copolymerized constitutional component (for example, copolymerization components of an SEBS binder (B-1) synthesized in Example). This makes it possible to adjust the adsorption rate of the polymer binder with respect to the inorganic solid electrolyte so that the relationship represented by Formula (1) is satisfied.

In all the constitutional components that constitute the hydrocarbon-based polymer, the content of the constitutional component (the constitutional component having a functional group) derived from a compound having a functional group selected from the above-described group (a) of functional groups, excluding the constitutional component (for example, styrene) that constitutes the hydrocarbon-based polymer described above, is preferably 0.01% by mole or more, more preferably 0.02% by mole or more, still more preferably 0.05% by mole or more, and particularly preferably 0.1% by mole or more. The upper limit value thereof is preferably 10% by mole or less, more preferably 8% by mole or less, and still more preferably 5% by mole or less of all the constitutional components that constitute the hydrocarbon-based polymer.

In a case where the hydrocarbon-based polymer has a plurality of constitutional components having a functional group, the content of the constitutional components having a functional group shall be adopted as the total amount. In addition, the content of a constitutional component having a functional group generally means the content of the constitutional component in a case where one constitutional component has a plurality of functional groups or a plurality of kinds of functional groups; however, in the present invention, the total amount of contents in terms of the respective functional groups shall be adopted, for convenience, in relation to the adsorption rate or the like of the SEBS binder. However, in a case where a plurality of functional groups or a plurality of kinds of functional groups are present in one molecular chain (in a case of being derived from a common raw material compound), the contents in terms of the respective functional groups are not included for calculation in the above total amount, but contents of the plurality of functional groups or the plurality of kinds of functional groups are included for calculation in the total amount as one content in terms of one functional group.

[Vinyl Polymer]

Examples of the vinyl polymer include a polymer containing a vinyl monomer other than the (meth)acrylic compound (M1), where the content of the vinyl polymer is, for example, 50% by mole or more. Examples of the vinyl monomer include vinyl compounds described later. Specific examples of the vinyl polymer include polyvinyl alcohol, polyvinyl acetal, polyvinyl acetate, and a copolymer containing these.

In addition to the constitutional component derived from the vinyl monomer, this vinyl polymer preferably has a constitutional component derived from the (meth)acrylic compound (M1) that forms a (meth)acrylic polymer described later. The content of the constitutional component derived from the vinyl monomer is preferably the same as the content of the constitutional component derived from the (meth)acrylic compound (M1) in the (meth)acrylic polymer. The content of the constitutional component derived from the (meth)acrylic compound (M1) in the polymer is not particularly limited as long as it is less than 50% by mole; however, it is preferably 0% to 30% by mole. The content of the constitutional component (MM) is preferably the same as the content in the (meth)acrylic polymer.

[(Meth)Acrylic Polymer]

The (meth)acrylic polymer is preferably a polymer obtained by copolymerizing at least one (meth)acrylic compound (M1) selected from a (meth)acrylic acid compound, a (meth)acrylic acid ester compound, a (meth)acrylamide compound, or a (meth)acrylonitrile compound. Further, a (meth)acrylic polymer consisting of a copolymer of the (meth)acrylic compound (M1) and the other polymerizable compound (M2) is also preferable. The other polymerizable compound (M2) is not particularly limited, and examples thereof include vinyl compounds such as a styrene compound, a vinyl naphthalene compound, a vinyl carbazole compound, an allyl compound, a vinyl ether compound, a vinyl ester compound, a dialkyl itaconate compound, and an unsaturated carboxylic acid anhydride, and fluorinated compounds thereof. Examples of the vinyl compound include the “vinyl monomer” disclosed in JP2015-88486A.

The (meth)acrylic compound (M1) and another polymerizable compound (M2) may have a substituent. The substituent is not particularly limited; however, examples thereof preferably include a group selected from the substituent Z described above.

The content of the other polymerizable compound (M2) in the (meth)acrylic polymer is not particularly limited; however, it can be, for example, 50% by mole or less.

(i) Compound Represented by Formula (b-1)

Among the (meth)acrylic compound (M1) and the other polymerizable compound (M2), from which the constitutional component of the (meth)acrylic polymer is derived, preferred examples of the compound different from any one of the constitutional component having a functional group included in the above-described group (a) of functional groups and the compound from which a constitutional component represented by Formula (1-1) described later include a compound represented by Formula (b-1).

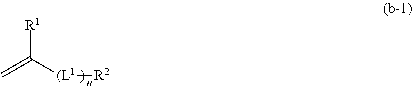

In the formula, R¹ represents a hydrogen atom, a hydroxy group, a cyano group, a halogen atom, an alkyl group (preferably having 1 to 24 carbon atoms, more preferably 1 to 12 carbon atoms, and particularly preferably 1 to 6 carbon atoms), an alkenyl group (preferably having 2 to 24 carbon atoms, more preferably 2 to 12 carbon atoms, and particularly preferably 2 to 6 carbon atoms), an alkynyl group (preferably having 2 to 24 carbon atoms, more preferably 2 to 12 carbon atoms, and particularly preferably 2 to 6 carbon atoms), or an aryl group (preferably having 6 to 22 carbon atoms and more preferably 6 to 14 carbon atoms). Among the above, a hydrogen atom or an alkyl group is preferable, and a hydrogen atom or a methyl group is more preferable.

R² represents a hydrogen atom or a substituent. The substituent that can be adopted as R² is not particularly limited. However, examples thereof include an alkyl group (preferably a linear chain although it may be a branched chain), an alkenyl group (preferably having 2 to 12 carbon atoms, more preferably 2 to 6 carbon atoms, and particularly preferably 2 or 3 carbon atoms), an aryl group (preferably having 6 to 22 carbon atoms and more preferably 6 to 14 carbon atoms), an aralkyl group (preferably having 7 to 23 carbon atoms and more preferably 7 to 15 carbon atoms), and a cyano group.

The alkyl group preferably has 1 to 3 carbon atoms. The alkyl group may have, for example, a group other than the functional group included in the group (a) of functional groups, among the above-described substituent Z.

L¹ is a linking group and is not particularly limited. However, examples thereof include an alkylene group having 1 to 6 carbon atoms (preferably 1 to 3 carbon atoms), an alkenylene group having 2 to 6 carbon atoms (preferably 2 or 3 carbon atoms), an arylene group having 6 to 24 carbon atoms (preferably 6 to 10 carbon atoms), an oxygen atom, a sulfur atom, an imino group (—NR^{N}—: here, R^{N} is as described above), a carbonyl group, and a phosphate linking group (—O—P(OH)(O)—O—), a phosphonate linking group (—P(OH)(O)—O—), and a group involved in the combination thereof, and a —CO—O— group or a —CO—N(R^{N})— group (R^{N} is as described above) is preferable. The above linking group may have any substituent. The number of atoms that constitute the linking group and the number of linking atoms are as described later. Examples of any substituent include a substituent Z described above, and examples thereof include an alkyl group and a halogen atom.

n is 0 or 1 and preferably 1. A case where n is 0 means a form in which R² is directly bonded to the carbon atom to which R¹ is bonded. However, in a case where -(L¹)ₙ-R² represents one kind of substituent (for example, an alkyl group), n is set to 0, and R² is set to a substituent (an alkyl group).

(ii) Compound Represented by Formula (b-2) or (b-3)

Among the above-described (meth)acrylic compounds (M1), preferred examples of the compound different from any one of the constitutional component having a functional group included in the above-described group (a) of functional groups and the compound from which a constitutional component represented by Formula (1-1) described later also include a compound represented by Formula (b-2) or (b-3).

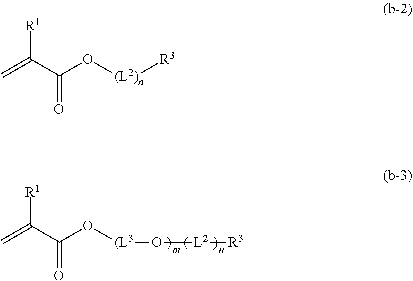

R¹ and n respectively have the same meanings as those in Formula (b-1).

R³ has the same meaning as R² in Formula (b-1).

L² is a linking group, and the description for L¹ described above can be preferably applied thereto.

L³ is a linking group, and the description for L¹ described above can be preferably applied thereto, and it is preferably an alkylene group having 1 to 6 carbon atoms (preferably 1 to 3 carbon atoms).

m is an integer of 1 to 200, and it is preferably an integer of 1 to 100 and more preferably an integer of 1 to 50.

In Formulae (b-1) to (b-3), the carbon atom which forms a polymerizable group and to which R¹ is not bonded is represented as an unsubstituted carbon atom (H₂C═); however, it may have a substituent. The substituent is not particularly limited; however, examples thereof include the above group that can be adopted as R¹.

Further, in Formulae (b-1) to (b-3), the group which may adopt a substituent such as an alkyl group, an aryl group, an alkylene group, or an arylene group may have a substituent within a range where the effect of the present invention is not impaired. It suffices that the substituent is a substituent other than the functional group selected from the group (a) of functional groups. Examples thereof include a group selected from the substituent Z described above, and specific examples thereof include a halogen atom.

(iii) Constitutional Component Represented by Formula (1-1)

The (meth)acrylic polymer preferably has a constitutional component represented by Formula (1-1) and more preferably has a constitutional component having a (meth)acrylic acid ester structure represented by Formula (1-1). In a case where two or more kinds of polymer binders are contained, the polymer that forms at least one kind of polymer binder preferably is preferably a (meth)acrylic polymer having a constitutional component represented by Formula (1-1), and an aspect in which all the (meth)acrylic polymers have this constitutional component is also one of the preferred aspects.

In a case where the (meth)acrylic polymer that forms the polymer binder has a constitutional component represented by Formula (1-1), it is possible to reduce the adsorption rate of the polymer binder with respect to the inorganic solid electrolyte, and thus it is possible to improve the dispersion characteristics and the application suitability of the inorganic solid electrolyte-containing composition. In addition to the (meth)acrylic polymer, in a case where a chain polymerization polymer such as a fluorine-based polymer, a hydrocarbon-based polymer, or a vinyl polymer also has a constitutional component represented by Formula (1-1), the same effect as that of the (meth)acrylic polymer can be obtained, whereby the dispersion characteristics and the application suitability of the inorganic solid electrolyte-containing composition can be improved.

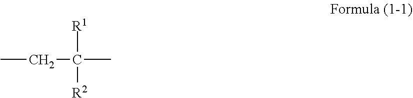

In Formula (1-1), R¹ represents a hydrogen atom or an alkyl group (preferably having 1 to 12 carbon atoms, more preferably 1 to 6 carbon atoms, and still more preferably 1 to 3 carbon atoms). The alkyl group that can be adopted as R¹ may have a substituent. The substituent is not particularly limited; however, examples thereof include the substituent Z described above. A group other than the functional group selected from the group (a) of functional groups is preferable, and suitable examples thereof include a halogen atom.

R² represents a group having a hydrocarbon group having 4 or more carbon atoms. In the present invention, the group having a hydrocarbon group includes a group consisting of the hydrocarbon group itself (where the hydrocarbon group is directly bonded to the carbon atom in the above formula, to which R¹ is bonded) and a group consisting of a hydrocarbon group and a linking group (where a hydrocarbon group is bonded to the carbon atom in the above formula through a linking group, to which R¹ is bonded) that links the carbon atom in the above formula, to which R² is bonded, to a hydrocarbon group.

The hydrocarbon group is a group composed of a carbon atom and a hydrogen atom, and it is generally introduced at the end part of R². The hydrocarbon group is not particularly limited; however, it is preferably an aliphatic hydrocarbon group, more preferably an aliphatic saturated hydrocarbon group (an alkyl group), and still more preferably a linear or branched alkyl group. It suffices that the hydrocarbon group has 4 or more carbon atoms, and the hydrocarbon group preferably has 6 or more carbon atoms and more preferably 10 or more carbon atoms. The upper limit of the carbon atoms thereof is not particularly limited, and it is preferably 20 or less and more preferably 14 or less.

The linking group is not particularly limited; however, examples thereof include an alkylene group (preferably having 1 to 12 carbon atoms, more preferably 1 to 6 carbon atoms, and still more preferably having 1 to 3 carbon atoms), an alkenylene group (preferably having 2 to 6 carbon atoms and more preferably having 2 or 3 carbon atoms), an arylene group (preferably having 6 to 24 carbon atoms and more preferably having 6 to 10 carbon atoms), an oxygen atom, a sulfur atom, an imino group (—NR^{N}—: R^{N} represents a hydrogen atom, an alkyl group having 1 to 6 carbon atoms or an aryl group having 6 to 10 carbon atoms), a carbonyl group, a phosphate linking group (—O—P(OH)(O)—O—), a phosphonate linking group (—P)(OH)(O)—O—), and a group involved in the combination thereof. It is also possible to form a polyalkyleneoxy chain by combining an alkylene group and an oxygen atom. The linking group is preferably a group obtained by combining an alkylene group, an arylene group, a carbonyl group, an oxygen atom, a sulfur atom, and an imino group, more preferably a group obtained by combining an alkylene group, an arylene group, a carbonyl group, an oxygen atom, and an imino group, still more preferably a group containing a —CO—O— group, a —CO—N(R^{N})— group (here, R^{N} is as described above), particularly preferably a —CO—O— group or a —CO—N(R^{N})— group (here, R^{N} is as described above), and most preferably a —CO—O— group. The number of atoms that constitute the linking group and the number of linking atoms are as described later. However, the above does not apply to the polyalkyleneoxy chain that constitutes the linking group.

In the present invention, the number of atoms that constitute the linking group is preferably 1 to 36, more preferably 1 to 24, still more preferably 1 to 12, and particularly preferably 1 to 6. The number of linking atoms of the linking group is preferably 10 or less and more preferably 8 or less. The lower limit thereof is 1 or more. The number of linking atoms refers to the minimum number of atoms linking predetermined structural parts. For example, in a case of —CH₂—C(═O)—O—, the number of atoms that constitute the linking group is 6; however, the number of linking atoms is 3.

Each of the hydrocarbon group and the linking group may have or may not have a substituent. Examples of the substituent which may be contained therein include a substituent Z. A group other than the functional group selected from the group (a) of functional groups is preferable, and suitable examples thereof include a halogen atom.

In Formula (1-1), the carbon atom adjacent to the carbon atom to which R¹ is bonded has two hydrogen atoms; however, in the present invention, it may have one or two substituents. The substituent is not particularly limited; however, examples thereof include the substituent Z described above, and a group other than the functional group selected from the group (a) of functional groups is preferable.

The compound from which a constitutional component represented by Formula (1-1) is derived is not particularly limited; however, examples thereof include a (meth)acrylic acid linear alkyl ester compound (here, linear alkyl means an alkyl group having 4 or more carbon atoms).

The content of the constitutional component represented by Formula (1-1) in the polymer is not particularly limited; however, in terms of improving the dispersion characteristics and application suitability, it is preferably 10% to 100% by mole, more preferably 20% to 99.9% by mole, still more preferably 30% to 99.5% by mole, and particularly preferably 30% to 99% by mole, among which 30 to 98% by mole is preferably and 50% to 96% by mole is more preferable.

In a case where two or more kinds of polymer binders are contained, the content of the constitutional component represented by Formula (1-1) with respect to the total number of moles of the constitutional components of the polymers that form all the polymer binders is not particularly limited, and it is appropriately set according to the content in each of the above polymers.

The (meth)acrylic polymer preferably has the above-described constitutional component having a functional group selected from the group (a) of functional groups or the above-described constitutional component represented by Formula (1-1). In addition, it can have a constitutional component derived from the (meth)acrylic compound (M1) and a constitutional component derived from the vinyl compound (M2), other than these constitutional components, and another constitutional component copolymerizable with a compound from which these constitutional components are derived. A case where the constitutional component represented by Formula (1-1) and a constitutional component having a functional group selected from the group (a) of functional groups among the (meth)acrylic compounds (M1) is contained is preferable in terms of dispersion characteristics and application suitability.

The content of the constitutional component in the (meth)acrylic polymer is not particularly limited, and it is appropriately selected in consideration of the SP value and the like of the constitutional unit or polymer. For example, it can be set in the following range. It is noted that the content of the constitutional component represented by Formula (1-1) is as described above.

The content of the constitutional component derived from the (meth)acrylic compound (M1), in the (meth)acrylic polymer, is not particularly limited and can be 100% by mole. In a case where a constitutional component derived from the vinyl compound (M2) is adopted as a copolymerization component, it is preferable that the remainder of the constitutional component derived from the following vinyl compound (M2) is a (meth)acrylic compound.

The content of the constitutional component derived from the vinyl compound (M2), in the (meth)acrylic polymer, is not particularly limited; however, it is preferably 1% to 50% by mole, more preferably 1% to 30% by mole, still more preferably 1% to 20% by mole, and particularly preferably 2.5% to 20% by mole.

The content of the constitutional component having a functional group selected from the group (a) of functional groups, in the (meth)acrylic polymer, is not particularly limited; it is preferably 0.01% to 50% by mole, more preferably 0.01% to 30% by mole, still more preferably 0.1% to 10% by mole, and particularly preferably 0.5% to 10% by mole.

The chain polymerization polymer preferably has a constitutional component having the above-described functional group selected from the group (a) of functional groups or a constitutional component represented by Formula (1-1), more preferably has a constitutional component having the above-described functional group selected from the group (a) of functional groups, and still more preferably a constitutional component having the above-described functional group selected from the group (a) of functional groups or a constitutional component represented by Formula (1-1). In addition, it may have a constitutional component different from these constitutional components.

The chain polymerization polymer (each constitutional component and raw material compound) may have a substituent. The substituent is not particularly limited as long as it is a group other than the functional group included in the above-described group (a) of functional groups, and preferred examples thereof include a group selected from the substituent Z described above.

The chain polymerization polymer can be synthesized by selecting a raw material compound and polymerizing the raw material compound according to a known method.

The method of incorporating a functional group is not particularly limited, and examples thereof include a method of copolymerizing a compound having a functional group selected from the group (a) of functional groups, a method of using a polymerization initiator having (generating) the above functional group or a chain transfer agent, a method of using a polymeric reaction, an ene reaction or ene-thiol reaction with a double bond (which is formed by a dehydrofluorination reaction of a VDF constitutional component, for example, in a case of a fluoropolymer), and an atom transfer radical polymerization (ATRP) method using a copper catalyst.

(Physical Properties, Characteristics, or Like Polymer)

The polymer preferably has the following physical properties, characteristics, or the like.

The watery moisture concentration of the polymer is preferably 100 ppm (in terms of mass) or lower. Further, as this polymer, a polymer may be crystallized and dried, or a polymer solution may be used as it is.

The polymer is preferably amorphous. In the present invention, the description that a polymer is “amorphous” typically refers to that no endothermic peak due to crystal melting is observed when the measurement is carried out at the glass transition temperature.

The polymer that forms a polymer binder preferably has, for example, an SP value of 10 to 24 MPa^{1/2}, more preferably an SP value of 14 to 22 MPa^{1/2}, and still more preferably an SP value of 16 to 20 MPa^{1/2}, in terms of the dispersion stability of solid particles. The difference (in terms of absolute value) in SP value between the polymer that forms a polymer binder and the dispersion medium will be described later.

The method of calculating the SP value will be described.

(1) The SP Value of the Constitutional Unit is Calculated.

First, in the polymer, a constitutional unit of which the SP value is specified is determined.

That is, in the present invention, in a case where the SP value of the polymer is calculated, a constitutional unit that is the same as that of the constitutional component derived from the raw material compound is adopted in a case where the polymer (the segment) is adopted a chain polymerization polymer. However, in a case where the polymer is a sequential polymerization (polycondensation, polyaddition, or addition condensation) polymer such as polyurethane, polyurea, polyamide, polyimide, or polyester, a unit different from the constitutional component derived from the raw material compound is adopted. For example, in a case where polyurethane is exemplified as a sequential polymerization polymer, a constitutional unit of which the SP value is defined as follows. As a constitutional unit derived from a polyisocyanate compound, a unit (a unit having one urethane bond) obtained by bonding an —O— group in the constitutional component derived from the polyisocyanate compound, to one —NH—CO— group and removing therefrom the remaining —NH—CO— group is adopted. On the other hand, as a constitutional unit derived from a polyol compound, a unit (a unit having one urethane bond) obtained by bonding an —CO—NH— group in the constitutional component derived from the polyol compound, to one —O— group and removing therefrom the remaining —O— group is adopted. It is noted that in a case of other sequential polymerization polymers as well, the constitutional unit is determined in the same manner as in the case of polyurethane.

Next, the SP value for each constitutional unit is determined according to the Hoy method unless otherwise specified (see the following expressions, also shown in Table 5, Table 6, and the following formula in Table 6 in H. L. Hoy JOURNAL OF PAINT TECHNOLOGY, Vol. 42, No. 541, 1970, 76-118, and POLYMER HANDBOOK 4th, Chapter 59, VII, page 686).

$${δ}_{t} = \frac{{F}_{t} + \frac{B}{\overline{n}}}{V} ; \\ B = 277$$

In the expression, δₜ indicates an SP value. Fₜ is a molar attraction function (J×cm³)^{1/2}/mol and represented by the following expression. V is a molar volume (cm³/mol) and represented by the following expression. n̅ is represented by the following expression.

$${F}_{t} = \sum {n}_{i} {F}_{t , i} \\ V = \sum {n}_{i} {V}_{i} \\ \overline{n} = \frac{0.5}{{Δ}_{T}^{( P )}} \\ {Δ}_{T}^{( P )} = \sum {n}_{i} {Δ}_{T , i}^{( P )}$$

In the above formula, F_{t,i} indicates a molar attraction function of each constitutional unit, Vᵢ indicates a molar volume of each constitutional unit. Δ^{(P)}_{T,i} indicates a correction value of each constitutional unit, and nᵢ indicates the number of each constitutional unit.

(2) SP Value of Polymer

It is calculated from the following expression using the constitutional unit determined as described above and the determined SP value. It is noted that the SP value of the constitutional unit obtained according to the above document is converted into an SP value (unit: MPa^{1/2}) (for example, 1 cal^{1/2}cm^{-3/2}≈2.05 J^{1/2} cm^{-3/2}≈2.05 MPa^{1/2}) and used.

SPₚ²=(SP₁²×W₁)+(SP₂²×W₂)+ . . .

In the expression, SP₁, SP₂ . . . indicates the SP values of the constitutional units, and W₁, W₂ . . . indicates the mass fractions of the constitutional units.

In the present invention, the mass fraction of a constitutional unit shall be a mass fraction of the constitutional component (the raw material compound from which this constitutional component is derived) in the polymer, corresponding to the constitutional unit.

The SP value of the polymer can be adjusted depending on the kind or the composition (the kind and the content of the constitutional component) of the polymer.

In the present invention, the SP value of the polymer is calculated according to the above-described expression for all constitutional units. In a case where the polymer contains a constitutional component derived from a macromonomer, an SP value (excluding a macromonomer (MM)) calculated according to the above-described expression can be adopted, where a constitutional unit corresponding to the constitutional component derived from the macromonomer (MM) is excluded for this SP value. According to the SP value (excluding MM) calculated in this way, the dispersion characteristics can be further improved. The SP value (excluding MM) can be set in the same range as the SP value described above; however, it is preferably 13.0 to 22.5 MPa^{1/2}, more preferably 16.0 to 21.0 MPa^{1/2}, and still more preferably 17.5 to 20.5 MPa^{1/2}.

The polymer may be a non-crosslinked polymer or a crosslinked polymer. In addition, in a case where the crosslinking of the polymer progresses due to heating or voltage application, the molecular weight may be higher than the above-described molecular weight. Preferably, the polymer has a mass average molecular weight in the range described later at the start of use of the all-solid state secondary battery.

The mass average molecular weight of the polymer is not particularly limited, and it is, for example, preferably 8,000.

In a case where the dispersion medium contains a compound having a polar functional group, for example, in a case where the dispersion medium contains at least one selected from an ester compound, a ketone compound, an ether compound, an alcohol compound, an amide compound, an amine compound, or a nitrile compound, the mass average molecular weight of the polymer is more preferably 10,000 or more, still more preferably 30,000 or more, and particularly preferably 60,000 or more, from the viewpoint of dispersion characteristics and application suitability. The upper limit thereof is practically 1,000,000 or less, preferably 700,000 or less, more preferably 500,000 or less, still more preferably 300,000 or less, and particularly preferably 100,000 or less.

On the other hand, in a case where the dispersion medium contains at least one selected from an aromatic compound or an aliphatic compound, the mass average molecular weight of the polymer is more preferably 70,000 or more, still more preferably 150,000 or more, and particularly preferably 300,000 or more, from the viewpoint of dispersion characteristics and application suitability. The upper limit thereof is practically 2,000,000 or less, preferably 1,000,000 or less, more preferably 800,000 or less, and particularly preferably 600,000 or less.

In the present invention, the phrase “the dispersion medium contains a compound having a polar functional group” means that a dispersion medium other than the compound having a polar functional group may be contained as long as the effect of the present invention is exhibited. For example, a content of a dispersion medium other than the compound having a polar functional group, in all dispersion media, can be set to 50% or less. It is preferably 20% by mass or less, more preferably 10% by mass or less, and still more preferably 3% by mass, or such a dispersion medium may not be contained at all.

The compound as a dispersion medium having a polar functional group preferably includes at least one selected from an ester compound, a ketone compound, or an ether compound.

In addition, in the present invention, the phrase “contains at least one selected from an aromatic compound or an aliphatic compound” means that a dispersion medium other than the aromatic compound and the aliphatic compound may be contained as long as the effect of the present invention is exhibited. For example, the content of the dispersion medium other than the aromatic compound and the aliphatic compound, in all the dispersion media, can be set to be less than 50%, and it is preferably 20% by mass or less, more preferably 10% by mass or less, and still more preferably 3% by mass, or such a dispersion medium may not be contained at all.

Although the reason why the preferred range of the mass average molecular weight of the polymer differs between a case where the dispersion medium contains at least one selected from an aromatic compound or an aliphatic compound and a case where the dispersion medium contains the above-described compound having a polar functional group, it is presumed as follows.

That is, since the above-described compound having a polar functional group has a polar functional group, the dispersion medium itself enhances the dispersibility of the inorganic solid electrolyte and furthermore, the dispersibility of the active material, whereby it is possible to prepare a concentrated slurry. On the other hand, since the aromatic compound and the aliphatic compound do not have a polar functional group, it is difficult to prepare a concentrated slurry in a case where a dispersion medium containing at least one of these compounds is used.

Therefore, in a case of using a dispersion medium containing at least one selected from an aromatic compound or an aliphatic compound, it is presumed that it is possible to prepare a more concentrated slurry by increasing the mass average molecular weight of the polymer as compared with a case of using a dispersion medium containing the above-described compound having a polar functional group, whereby it is possible to improve dispersion characteristics and application suitability.

In a case where the inorganic solid electrolyte-containing composition contains a plurality of kinds of polymer binders, it suffices that any one of the polymer binders satisfies the above-described mass average molecular weight in addition to the above-described adsorption rate and the above-described relationship defined by Expression (1).

—Measurement of Molecular Weight—

In the present invention, unless specified otherwise, molecular weights of a polymer, a polymer chain, and a macromonomer refer to a mass average molecular weight and number average molecular weight in terms of standard polystyrene conversion, which are determined by gel permeation chromatography (GPC). Regarding a measuring method, basically, a value measured using a method under the following condition 1 or condition 2 (preferred) is used. However, depending on the kind of polymer or macromonomer, an appropriate eluent may be suitably selected and used.

(Condition 1)

Column: A column in which two columns of TOSOH TSKgel Super AWM-H (product name, manufactured by Tosoh Corporation) are connected is used.

Carrier: 10 mM LiBr/N-methylpyrrolidone

Measurement temperature: 40° C.

Carrier flow rate: 1.0 ml/min

Sample concentration: 0.1% by mass

Detector: refractive indicator (RI) detector

(Condition 2)

Column: A column obtained by connecting TOSOH TSKgel Super HZM-H, TOSOH TSKgel Super HZ4000, and TOSOH TSKgel Super HZ2000 (all of which are product names, manufactured by Tosoh Corporation)

Carrier: tetrahydrofuran

Measurement temperature: 40° C.

Carrier flow rate: 1.0 ml/min

Sample concentration: 0.1% by mass

Detector: refractive indicator (RI) detector

Specific examples of the polymer that constitutes a polymer binder include polymers having the constitution shown below in addition to those synthesized in Examples; however, the present invention is not limited thereto. In each specific example, the number attached at the bottom right of the constitutional component indicates the content in the polymer, where the unit thereof is % by mole.

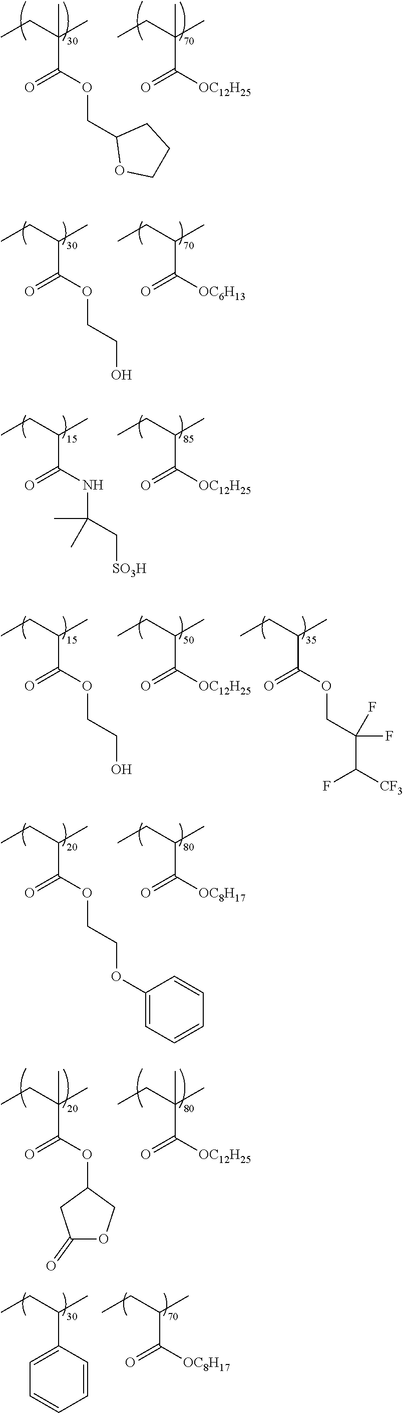

The inorganic solid electrolyte-containing composition according to the embodiment of the present invention may contain one kind of polymer binder or may contain a plurality of kinds of polymer binders.

The (total) content of the polymer binder in the inorganic solid electrolyte-containing composition is not particularly limited. However, it is preferably 0.1% to 10.0% by mass, more preferably 0.2% to 5.0% by mass, and still more preferably 0.3% to 4.0% by mass, in that the dispersion characteristics and the application suitability are improved and furthermore, a firm binding property is exhibited. For the same reason, the (total) content of the polymer binder in the inorganic solid electrolyte-containing composition is preferably 0.1% to 10.0% by mass, more preferably 0.3% to 8% by mass, and still more preferably 0.5% to 7% by mass in 100% by mass of the solid content.

In a case where two or more kinds of polymer binders are contained, the content of each polymer binder is appropriately set within a range that satisfies the above (total) content.

In a case where the inorganic solid electrolyte-containing composition contains a particulate binder described later, the (total) content of the polymer binder may be lower than the content of the particulate binder; however, it is preferable to be equal to or higher than the content of the particulate binder. This makes it possible to further reinforce the binding property without impairing the excellent dispersion characteristics and the excellent application suitability. The difference (in terms of absolute value) between the (total) content of the polymer binder and the content of the particulate binder in 100% by mass of the solid content is not particularly limited, and it can be set to, for example, 0% to 6% by mass, more preferably 0% to 4% by mass, and still more preferably 0% to 2% by mass. In addition, the ratio of the content of the (total) content of the polymer binder to the content of the particulate binder (the (total) content of the polymer binder/the content of the particulate binder) in 100% by mass of the solid content is not particularly limited; however, it is, for example, preferably 1 to 4 and more preferably 1 to 2.

(Insoluble Type Binder)

The inorganic solid electrolyte-containing composition according to the present invention may contain, in addition to the above-described polymer binder, one or more insoluble type binders which are insoluble in a dispersion medium in the composition. This insoluble type binder is preferably a particle-shaped polymer binder (a particulate binder). The shape of this particulate binder is not particularly limited and may be a flat shape, an amorphous shape, or the like; however, a spherical shape or a granular shape is preferable. The average particle diameter of the particulate binder is preferably 1 to 1,000 nm, more preferably 5 to 800 nm, still more preferably 10 to 600 nm, and particularly preferably 50 to 500 nm. The average particle diameter can be measured in the same manner as in the measurement of the average particle diameter of the inorganic solid electrolyte.

The adsorption rate of this particulate binder with respect to the inorganic solid electrolyte is not particularly limited as long as the effect of the present invention is exhibited. It can be set to, for example, 30% or more, and it is preferably set to 40% or more. The upper limit value thereof is not particularly limited; however, it can be set to, for example, 95% or less, and it is preferably set to 90% or less. The adsorption rate with respect to the active material is appropriately determined. The adsorption rate can be measured in the same manner as in the measurement of the above-described polymer binder.

The relationship between the surface energy of the particulate binder and the surface energy of the inorganic solid electrolyte is not particularly limited as long as the effect of the present invention is exhibited, and the sum of the square of the difference between the dispersion elements and the square of the difference between the polarity elements, which are represented by the left side of Expression (1) can be set to, for example, 30.0² or less, and it is preferably 25.0² or less and more preferably 22.0² or less. The lower limit value thereof is not particularly limited; however, it can be also set to, for example, zero, and it is preferably 0.3² or more, more preferably 0.6² or more, and still more preferably 0.9² or more. The relationship between the particulate binder and the surface energy of the active material is not particularly limited either. The dispersion element and the polarity element of the surface energy can be measured in the same manner as in the measurement of the above-described polymer binder.

In a case where the inorganic solid electrolyte-containing composition contains a particulate binder, the effect of improving the dispersion characteristics and the application suitability due to the polymer binder is not impaired, and the binding property of the solid particles can be reinforced while an increase in interface resistance is suppressed. This makes it possible to further increase the cycle characteristics of the all-solid state secondary battery, and preferably it is possible to realize further lower resistance.

As the particulate binder, various particulate binders that are used in the manufacturing of an all-solid state secondary battery can be used without particular limitation. Examples thereof include a particulate binder consisting of the above-described chain polymerization polymer and a particulate binder consisting of the above-described sequential polymerization polymer. A commercially available product may be used as described in Examples described later. In addition, examples thereof also include the binders disclosed in JP2015-088486A, WO2017/145894A, and WO2018/020827A.

The content of the particulate binder in the inorganic solid electrolyte-containing composition is not particularly limited. However, it is preferably 0.01% to 4% by mass, more preferably 0.05% to 2% by mass, and still more preferably 0.1% to 1.5% by mass in 100% by mass of the solid content, in that dispersion characteristics and application suitability are improved and furthermore, the firm binding property is exhibited. It is noted that the content of the particulate binder is appropriately set within the above range; however, it is preferably a content at which the particulate binder is not dissolved in the inorganic solid electrolyte-containing composition in consideration of the solubility of the particulate binder.

<Dispersion Medium>

It suffices that the dispersion medium contained in the inorganic solid electrolyte-containing composition according to the embodiment of the present invention is an organic compound that exhibits a liquid state in the use environment, which is any dispersion medium that disperses the solid content contained in the composition. Examples thereof include various organic solvents, and specific examples thereof include an alcohol compound, an ether compound, an amide compound, an amine compound, a ketone compound, an aromatic compound, an aliphatic compound, a nitrile compound, and an ester compound.

The dispersion medium may be a non-polar dispersion medium (a hydrophobic dispersion medium) or a polar dispersion medium (a hydrophilic dispersion medium); however, a non-polar dispersion medium is preferable from the viewpoint that excellent dispersibility can be exhibited. The non-polar dispersion medium generally means a dispersion medium having a property of a low affinity to water; however, in the present invention, examples thereof include an ester compound, a ketone compound, an ether compound, an aromatic compound, and an aliphatic compound.

Examples of the alcohol compound include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of the ether compound include an alkylene glycol (diethylene glycol, triethylene glycol, polyethylene glycol, dipropylene glycol, or the like), an alkylene glycol monoalkyl ether (ethylene glycol monomethyl ether, ethylene glycol monobutyl ether, propylene glycol monomethyl ether, diethylene glycol monomethyl ether, dipropylene glycol monomethyl ether, tripropylene glycol monomethyl ether, diethylene glycol monobutyl ether, or the like), alkylene glycol dialkyl ether (ethylene glycol dimethyl ether or the like), a dialkyl ether (dimethyl ether, diethyl ether, diisopropyl ether, dibutyl ether, or the like), and a cyclic ether (tetrahydrofuran, dioxane (including 1,2-, 1,3- or 1,4-isomer), or the like).

Examples of the amide compound include N,N-dimethylformamide, N-methyl pyrrolidone, 2-pyrrolidinone, 1,3-dimethyl-2-imidazolidinone, ε-caprolactam, formamide, N-methylformamide, acetamide, N-methylacetamide, N,N-dimethylacetamide, N-methylpropanamide, and hexamethylphosphoric triamide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic compound include benzene, toluene, and xylene.

Examples of the aliphatic compound include hexane, heptane, octane, decane, cyclohexane, methylcyclohexane, ethylcyclohexane, cyclooctane, decalin, paraffin, gasoline, naphtha, kerosene, and light oil.

Examples of the nitrile compound include acetonitrile, propionitrile, and isobutyronitrile.

Examples of the ester compound include ethyl acetate, propyl acetate, propyl butyrate, butyl acetate, ethyl butyrate, isopropyl butyrate, butyl butyrate, isobutyl butyrate, butyl pentanoate, pentyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among them, an ether compound, a ketone compound, an aromatic compound, an aliphatic compound, or an ester compound is preferable, and an ester compound, a ketone compound, or an ether compound is more preferable.

The number of carbon atoms of the compound that constitutes the dispersion medium is not particularly limited, and it is preferably 2 to 30, more preferably 4 to 20, still more preferably 6 to 15, and particularly preferably 7 to 12.

In terms of the dispersion characteristics, the dispersion medium preferably has an SP value (unit: MPa^{1/2}) of 15 to 21, more preferably 16 to 20, and still more preferably 17 to 19. The difference (in terms of absolute value) in the SP value between the polymer binder and the dispersion medium is not particularly limited. However, it is preferably 3.0 or less, more preferably 0 to 2.5, and still more preferably 0 to 2.0 in terms of further improving the dispersion characteristics, and it is particularly preferably 0 to 1.7 from the viewpoint that the application suitability can be also further improved. In a case where a plurality of kinds of polymer binders are contained, it is preferable that the difference (in terms of absolute value) in SP value is such that the smallest value (in terms of absolute value) of the difference is within the above-described range, and it is more preferable that any one of the polymer binders satisfies the above-described range of the difference in SP value, in addition to the above-described adsorption rate and the above-described relationship defined by Expression (1), where all the differences (in terms of absolute value) in SP value may be included in the above-described range.

The SP value of the dispersion medium is defined as a value obtained by converting the SP value calculated according to the Hoy method described above into the unit of MPa^{1/2}. In a case where the inorganic solid electrolyte-containing composition contains two or more kinds of dispersion media, the SP value of the dispersion medium means the SP value of the entire dispersion media, and it is the sum of the products of the SP values and the mass fractions of the respective dispersion media. Specifically, the calculation is carried out in the same manner as the above-described method of calculating the SP value of the polymer, except that the SP value of each of the dispersion media is used instead of the SP value of the constitutional component.

The SP values (unit is omitted) of the dispersion media are shown below. It is noted that in the following compound names, the alkyl group means a normal alkyl group unless otherwise specified. For example, octane means normal octane.

MIBK (18.4), diisopropyl ether (16.8), dibutyl ether (17.9), diisopropyl ketone (17.9), DIBK (17.9), butyl butyrate (18.6), butyl acetate (18.9), toluene (18.5), xylene (a mixture of xylene isomers in which the mixing molar ratio between isomers is, ortho-isomer:para-isomer:meta-isomer=1:5:2) (18.7), octane (16.9), ethylcyclohexane (17.1), cyclooctane (18.8), isobutyl ethyl ether (15.3), N-methylpyrrolidone (NMP, SP value: 25.4)

The boiling point of the dispersion medium at normal pressure (1 atm) is not particularly limited; however, it preferably 90° C. or higher, and it is more preferably 120° C. or higher. The upper limit thereof is preferably 230° C. or lower, more preferably 200° C. or lower, and still more preferably 180° C. or lower.

It suffices that the inorganic solid electrolyte-containing composition according to the embodiment of the present invention contains at least one kind of dispersion medium, and it may contain two or more kinds thereof.

In the present invention, the content of the dispersion medium in the inorganic solid electrolyte-containing composition is not particularly limited, and it is set in a range that satisfies the above-described solid content concentration.

<Active Material>

The inorganic solid electrolyte-containing composition according to the embodiment of the present invention can also contain an active material capable of intercalating and deintercalating an ion of a metal belonging to Group 1 or Group 2 of the periodic table. Examples of such active materials include a positive electrode active material and a negative electrode active material, which will be described later.

In the present invention, the inorganic solid electrolyte-containing composition containing an active material (a positive electrode active material or a negative electrode active material) may be referred to as an electrode composition (a positive electrode composition or a negative electrode composition).

(Positive Electrode Active Material)

The positive electrode active material is preferably a positive electrode active material capable of reversibly intercalating and deintercalating lithium ions. The above-described material is not particularly limited as long as the material has the above-described characteristics and may be a transition metal oxide or an element, which is capable of being complexed with Li, such as sulfur or the like by disassembling the battery.

Among the above, as the positive electrode active material, transition metal oxides are preferably used, and transition metal oxides having a transition metal element M^{a} (one or more elements selected from Co, Ni, Fe, Mn, Cu, or V) are more preferable. In addition, an element M^{b} (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The mixing amount thereof is preferably 0% to 30% by mole of the amount (100% by mole) of the transition metal element M^{a}. It is more preferable that the transition metal oxide is synthesized by mixing the above components such that a molar ratio Li/M^{a} is 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), and lithium-containing transition metal silicate compounds (ME).

Specific examples of the transition metal oxides having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON type vanadium phosphate salt such as Li₃V₂(PO₄)₃ (lithium vanadium phosphate).

Examples of the lithium-containing transition metal halogenated phosphoric acid compound (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

The shape of the positive electrode active material is not particularly limited but is preferably a particle shape. The particle diameter (the volume average particle diameter) of the positive electrode active material is not particularly limited. For example, it can be set to 0.1 to 50 The particle diameter of the positive electrode active material particle can be measured in the same manner as in the measurement of the particle diameter of the inorganic solid electrolyte. In order to allow the positive electrode active material to have a predetermined particle diameter, a general pulverizer or classifier is used. For example, a mortar, a ball mill, a sand mill, a vibration ball mill, a satellite ball mill, a planetary ball mill, a swirling air flow jet mill, or a sieve is preferably used. During pulverization, it is also possible to carry out wet-type pulverization in which water or a dispersion medium such as methanol is made to be present together. In order to provide the desired particle diameter, classification is preferably carried out. The classification is not particularly limited and can be carried out using a sieve, a wind power classifier, or the like. Both the dry-type classification and the wet-type classification can be carried out.

A positive electrode active material obtained using a baking method may be used after being washed with water, an acidic aqueous solution, an alkaline aqueous solution, or an organic solvent.

In a case where the inorganic solid electrolyte-containing composition according to the embodiment of the present invention contains a positive electrode active material, the contained positive electrode active material may be one kind or two or more kinds.

In a case of forming a positive electrode active material layer, the mass (mg) (mass per unit area) of the positive electrode active material per unit area (cm²) of the positive electrode active material layer is not particularly limited. It can be appropriately determined according to the designed battery capacity and can be set to, for example, 1 to 100 mg/cm².

The content of the positive electrode active material in the inorganic solid electrolyte-containing composition is not particularly limited; however, it is preferably 10% to 97% by mass, more preferably 30% to 95% by mass, still more preferably 40% to 93% by mass, and particularly preferably 50% to 90% by mass in 100% by mass of the solid content.

(Negative Electrode Active Material)

The negative electrode active material is preferably capable of reversibly intercalating and deintercalating lithium ions. The material is not particularly limited as long as it has the above-described characteristics, and examples thereof include a carbonaceous material, a metal oxide, a metal composite oxide, a lithium single body, a lithium alloy, and a negative electrode active material that is capable of forming an alloy with lithium. Among the above, a carbonaceous material, a metal composite oxide, or a lithium single body is preferably used from the viewpoint of reliability.

The carbonaceous material that is used as the negative electrode active material is a material substantially consisting of carbon. Examples thereof include petroleum pitch, carbon black such as acetylene black (AB), graphite (natural graphite, artificial graphite such as vapor-grown graphite), and carbonaceous material obtained by baking a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the lattice spacing, density, and crystallite size described in JP1987-22066A (JP-S62-22066A), JP1990-6856A (JP-H2-6856A), and JP1991-45473A (JP-H3-45473A). The carbonaceous material is not necessarily a single material and, for example, may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element that can be used as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element (collectively referred to as “metal composite oxide), and an oxide of a metalloid element (a metalloid oxide). The oxides are more preferably amorphous oxides, and preferred examples thereof include chalcogenides which are reaction products between metal elements and elements in Group 16 of the periodic table). In the present invention, the metalloid element refers to an element having intermediate properties between those of a metal element and a non-metal element. Typically, the metalloid elements include six elements including boron, silicon, germanium, arsenic, antimony, and tellurium, and further include three elements including selenium, polonium, and astatine. In addition, “amorphous” represents an oxide having a broad scattering band with an apex in a range of 20° to 40° in terms of 20 value in case of being measured by an X-ray diffraction method using CuKα rays, and the oxide may have a crystalline diffraction line. The highest intensity in a crystalline diffraction line observed in a range of 40° to 70° in terms of 20 value is preferably 100 times or less and more preferably 5 times or less with respect to the intensity of a diffraction line at the apex in a broad scattering band observed in a range of 20° to 40° in terms of 20 value, and it is still more preferable that the oxide does not have a crystalline diffraction line.

In the compound group consisting of the amorphous oxides and the chalcogenides, amorphous oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Groups 13 (IIIB) to 15 (VB) in the periodic table or chalcogenides are more preferable. Specific examples of the preferred amorphous oxide and chalcogenide preferably include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Preferred examples of the negative electrode active material which can be used in combination with a amorphous oxide containing Sn, Si, or Ge as a major component include a carbonaceous material capable of intercalating and/or deintercalating lithium ions or lithium metal, a lithium single body, a lithium alloy, and a negative electrode active material that is capable of being alloyed with lithium.

It is preferable that an oxide of a metal or a metalloid element, in particular, a metal (composite) oxide and the chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄Ti₅O₁₂ (lithium titanium oxide [LTO]) is preferable since the volume variation during the intercalation and deintercalation of lithium ions is small, and thus the high-speed charging and discharging characteristics are excellent, and the deterioration of electrodes is suppressed, whereby it becomes possible to improve the life of the lithium ion secondary battery.

The lithium alloy as the negative electrode active material is not particularly limited as long as it is an alloy that is typically used as a negative electrode active material for a secondary battery, and examples thereof include a lithium aluminum alloy, using lithium as a base metal, to which 10% by mass of aluminum is added.

The negative electrode active material capable of forming an alloy with lithium is not particularly limited as long as it is typically used as a negative electrode active material for a secondary battery. Such an active material has a large expansion and contraction due to charging and discharging of the all-solid state secondary battery and accelerates the deterioration of cycle characteristics. However, since a layer formed of the inorganic solid electrolyte-containing composition according to the embodiment of the present invention is incorporated in the all-solid state secondary battery according to the embodiment of the present invention, the deterioration of cycle characteristics can be suppressed. Examples of such an active material include a (negative electrode) active material (an alloy or the like) having a silicon element or a tin element and a metal such as Al or In, a negative electrode active material (a silicon element-containing active material) having a silicon element capable of exhibiting high battery capacity is preferable, and a silicon element-containing active material in which the content of the silicon element is 50% by mole or more with respect to all the constitutional elements is more preferable.

In general, a negative electrode including the negative electrode active material (for example, an Si negative electrode including a silicon element-containing active material or an Sn negative electrode containing an active material containing a tin element) can intercalate a larger amount of Li ions than a carbon negative electrode (for example, graphite or acetylene black). That is, the amount of Li ions intercalated per unit mass increases. Therefore, it is possible to increase the battery capacity. As a result, there is an advantage that the battery driving duration can be extended.

Examples of the silicon-containing active material include a silicon-containing alloy (for example, LaSi₂, VSi₂, La—Si, Gd—Si, or Ni—Si) including a silicon material such as Si or SiOx (0<x≤1) and titanium, vanadium, chromium, manganese, nickel, copper, lanthanum, or the like or a structured active material thereof (for example, LaSi₂/Si), and an active material such as SnSiO₃ or SnSiS₃ including silicon element and tin element. In addition, since SiOx itself can be used as a negative electrode active material (a metalloid oxide) and Si is produced along with the operation of an all-solid state secondary battery, SiOx can be used as a negative electrode active material (or a precursor material thereof) capable of being alloyed with lithium.

Examples of the negative electrode active material including tin element include Sn, SnO, SnO₂, SnS, SnS₂, and the above-described active material including silicon element and tin element. In addition, a composite oxide with lithium oxide, for example, Li₂SnO₂ can also be used.

In the present invention, the above-described negative electrode active material can be used without any particular limitation. From the viewpoint of battery capacity, a preferred aspect as the negative electrode active material is a negative electrode active material that is capable of being alloyed with lithium. Among them, the silicon material or the silicon-containing alloy (the alloy containing a silicon element) described above is more preferable, and it is more preferable to include a negative electrode active material containing silicon (Si) or a silicon-containing alloy.

The chemical formulae of the compounds obtained by the above baking method can be calculated using an inductively coupled plasma (ICP) emission spectroscopy as a measuring method from the mass difference of powder before and after baking as a convenient method.

The shape of the negative electrode active material is not particularly limited but is preferably a particle shape. The volume average particle diameter of the negative electrode active material is not particularly limited; however, it is preferably 0.1 to 60 μm. The volume average particle diameter of the negative electrode active material particles can be measured in the same manner as in the measurement of the particle diameter of the inorganic solid electrolyte. In order to obtain the predetermined particle diameter, a typical pulverizer or classifier is used as in the case of the positive electrode active material.

In a case where the inorganic solid electrolyte-containing composition according to the embodiment of the present invention contains a negative electrode active material, the contained negative electrode active material may be one kind or two or more kinds.

In a case of forming a negative electrode active material layer, the mass (mg) (mass per unit area) of the negative electrode active material per unit area (cm²) in the negative electrode active material layer is not particularly limited. It can be appropriately determined according to the designed battery capacity and can be set to, for example, 1 to 100 mg/cm².

The content of the negative electrode active material in the inorganic solid electrolyte-containing composition is not particularly limited, and it is preferably 10% to 90% by mass, more preferably 20% to 85% by mass, still more preferably 30% to 80% by mass, and even still more preferably 40% to 75% by mass in 100% by mass of the solid content.

In the present invention, in a case where a negative electrode active material layer is formed by charging a secondary battery, ions of a metal belonging to Group 1 or Group 2 in the periodic table, generated in the all-solid state secondary battery, can be used instead of the negative electrode active material. By bonding the ions to electrons and precipitating a metal, a negative electrode active material layer can be formed.

(Coating of active material) The surfaces of the positive electrode active material and the negative electrode active material may be subjected to surface coating with another metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiA₁O₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, the surface of the electrode containing the positive electrode active material or negative electrode active material may be subjected to a surface treatment with sulfur or phosphorus.

Further, the particle surface of the positive electrode active material or negative electrode active material may be subjected to a surface treatment with an actinic ray or an active gas (plasma or the like) before and after the surface coating.

<Conductive Auxiliary Agent>

It is preferable that the inorganic solid electrolyte-containing composition according to the embodiment of the present invention contains a conductive auxiliary agent. For example, it is preferable that a silicon atom-containing active material as the negative electrode active material is used in combination with a conductive auxiliary agent.

The conductive auxiliary agent is not particularly limited, and conductive auxiliary agents that are known as ordinary conductive auxiliary agents can be used. It may be, for example, graphite such as natural graphite and artificial graphite, carbon black such as acetylene black (AB), Ketjen black, and furnace black, amorphous carbon such as needle cokes, carbon fibers such as a vapor-grown carbon fiber and a carbon nanotube, or a carbonaceous material such as graphene or fullerene, which are electron-conductive materials, and it may be also a metal powder or metal fiber of copper, nickel, or the like. A conductive polymer such as polyaniline, polypyrrole, polythiophene, polyacetylene, or a polyphenylene derivative may also be used.

In the present invention, in a case where the active material is used in combination with the conductive auxiliary agent, among the above-described conductive auxiliary agents, a conductive auxiliary agent that does not intercalate and deintercalate ions (preferably Li ions) of a metal belonging to Group 1 or Group 2 in the periodic table and does not function as an active material at the time of charging and discharging of the battery is classified as the conductive auxiliary agent. Therefore, among the conductive auxiliary agents, a conductive auxiliary agent that can function as the active material in the active material layer at the time of charging and discharging of the battery is classified as an active material but not as a conductive auxiliary agent. Whether or not the conductive auxiliary agent functions as the active material at the time of charging and discharging of a battery is not unambiguously determined but is determined by the combination with the active material.

The shape of the conductive auxiliary agent is not particularly limited but is preferably a particle shape.

In a case where the inorganic solid electrolyte-containing composition according to the embodiment of the present invention contains a conductive auxiliary agent, the contained conductive auxiliary agent may be one kind or two or more kinds.

In a case where the inorganic solid electrolyte-containing composition contains a conductive auxiliary agent, the content of the conductive auxiliary agent in the inorganic solid electrolyte-containing composition is preferably 0% to 10% by mass in 100% by mass of the solid content.

<Lithium Salt>

The inorganic solid electrolyte-containing composition according to the embodiment of the present invention preferably contains a lithium salt (a supporting electrolyte) as well.

Generally, the lithium salt is preferably a lithium salt that is used for this kind of product and is not particularly limited. For example, lithium salts described in paragraphs 0082 to 0085 of JP2015-088486A are preferable.

In a case where the inorganic solid electrolyte-containing composition according to the embodiment of the present invention contains a lithium salt, the content of the lithium salt is preferably 0.1 part by mass or more and more preferably 5 parts by mass or more with respect to 100 parts by mass of the inorganic solid electrolyte. The upper limit thereof is preferably 50 parts by mass or less and more preferably 20 parts by mass or less.

<Dispersing Agent>

Since the above-described polymer binder also functions as a dispersing agent, the inorganic solid electrolyte-containing composition according to the embodiment of the present invention does not have to contain a dispersing agent other than the polymer binder. In a case where the inorganic solid electrolyte-containing composition contains a dispersing agent other than the polymer binder constitutional component, a dispersing agent that is generally used for an all-solid state secondary battery can be appropriately selected and used as the dispersing agent. Generally, a compound intended for particle adsorption and steric repulsion and/or electrostatic repulsion is suitably used.

<Other Additives>

As components other than the respective components described above, the inorganic solid electrolyte-containing composition according to the embodiment of the present invention may appropriately contain an ionic liquid, a thickener, a crosslinking agent (an agent causing a crosslinking reaction by radical polymerization, condensation polymerization, or ring-opening polymerization), a polymerization initiator (an agent that generates an acid or a radical by heat or light), an antifoaming agent, a leveling agent, a dehydrating agent, or an antioxidant. The ionic liquid is contained in order to further improve the ion conductivity, and the known one in the related art can be used without particular limitation. In addition, a polymer other than the above-described polymer that forms a polymer binder, a typically used binder, or the like may be contained.

(Preparation of Inorganic Solid Electrolyte-Containing Composition)

The inorganic solid electrolyte-containing composition according to the embodiment of the present invention can be prepared by a conventional method. Specifically, it can be prepared, as a mixture and preferably as a slurry, by mixing an inorganic solid electrolyte, a polymer binder, and a dispersion medium, preferably a conductive auxiliary agent, and further appropriately a lithium salt, and any other optionally constitutional components by using, for example, various mixers that are generally used. In a case of an electrode composition, an active material is further mixed.

The mixing method is not particularly limited, and it can be carried out using a known mixer such as a ball mill, a beads mill, a planetary mixer, a blade mixer, a roll mill, a kneader, a disc mill, a self-rotation type mixer, or a narrow gap type disperser.

The mixing conditions are also not particularly limited. For example, the rotation speed of the self-rotation type mixer or the like can be set to 200 to 3,000 rpm. The mixing atmosphere may be any one of the atmosphere, under dry air (the dew point: −20° C. or lower), in an inert gas (for example, in an argon gas, in a helium gas, or in a nitrogen gas), or the like. Since the inorganic solid electrolyte easily reacts with watery moisture, the mixing is preferably carried out under dry air or in an inert gas.

[Sheet for all-Solid State Secondary Battery]

A sheet for an all-solid state secondary battery according to the embodiment of the present invention is a sheet-shaped molded body with which a constitutional layer of an all-solid state secondary battery can be formed, and it includes various aspects depending on use applications thereof. Examples of thereof include a sheet that is preferably used in a solid electrolyte layer (also referred to as a solid electrolyte sheet for an all-solid state secondary battery) and a sheet that is preferably used in an electrode or a laminate of an electrode and a solid electrolyte layer (an electrode sheet for an all-solid state secondary battery). In the present invention, the variety of sheets described above will be collectively referred to as a sheet for an all-solid state secondary battery.

In the present invention, each layer that constitutes a sheet for an all-solid state secondary battery may have a monolayer structure or a multilayer structure.

<Solid Electrolyte Sheet for all-Solid State Secondary Battery>

It suffices that the solid electrolyte sheet for an all-solid state secondary battery according to the embodiment of the present invention is a sheet having a solid electrolyte layer, and it may be a sheet in which a solid electrolyte layer is formed on a base material or may be a sheet that is formed of a solid electrolyte layer without including a base material. The solid electrolyte sheet for an all-solid state secondary battery may include another layer in addition to the solid electrolyte layer. Examples of the other layer include a protective layer (a stripping sheet), a collector, and a coating layer.

Examples of the solid electrolyte sheet for an all-solid state secondary battery according to the embodiment of the present invention include a sheet including a layer formed of the inorganic solid electrolyte-containing composition according to the embodiment of the present invention, a typical solid electrolyte layer, and a protective layer on a base material in this order. The layer thickness of each layer that constitutes the solid electrolyte sheet for an all-solid state secondary battery is the same as the layer thickness of each layer described later in the all-solid state secondary battery.

The content of each component in the constitutional layer is not particularly limited; however, it preferably has the same meaning as the content of the each component in the solid content of the inorganic solid electrolyte-containing composition according to the embodiment of the present invention.

The base material is not particularly limited as long as it can support the solid electrolyte layer, and examples thereof include a sheet body (plate-shaped body) formed of materials described later regarding the collector, an organic material, an inorganic material, or the like. Examples of the organic material include various polymers, and specific examples thereof include polyethylene terephthalate, polypropylene, polyethylene, and cellulose. Examples of the inorganic material include glass and ceramic.

<Electrode Sheet for all-Solid State Secondary Battery>

It suffices that an electrode sheet for an all-solid state secondary battery according to the embodiment of the present invention (simply also referred to as an “electrode sheet”) is an electrode sheet including an active material layer, and it may be a sheet in which an active material layer is formed on a base material (collector) or may be a sheet that is formed of an active material layer without including a base material. The electrode sheet is typically a sheet including the base material (collector) and the active material layer, and examples of an aspect thereof include an aspect including the base material (collector), the active material layer, and the solid electrolyte layer in this order and an aspect including the base material (collector), the active material layer, the solid electrolyte layer, and the active material layer in this order.

At least one of the solid electrolyte layer or the active material layer, which is included in the electrode sheet, is formed of the inorganic solid electrolyte-containing composition according to the embodiment of the present invention. The contents of the respective components in the solid electrolyte layer or the active material layer, which is formed of the inorganic solid electrolyte-containing composition according to the embodiment of the present invention, are not particularly limited; however, the contents are preferably the same as the contents of the respective components with respect to the solid content of the inorganic solid electrolyte-containing composition (the electrode composition) according to the embodiment of the present invention. The thickness of each of the layers forming the electrode sheet according to the embodiment of the present invention is the same as the layer thickness of each of the layers described later regarding the all-solid state secondary battery. The electrode sheet according to the embodiment of the present invention may include the above-described other layers.

It is noted that in a case where the solid electrolyte layer or the active material layer is not formed of the inorganic solid electrolyte-containing composition according to the embodiment of the present invention, it is formed of a general constitutional layer forming material.

In the sheet for an all-solid state secondary battery according to the embodiment of the present invention, at least one layer of the solid electrolyte layer or the active material layer is formed of the inorganic solid electrolyte-containing composition according to the embodiment of the present invention, and a constitutional layer having a flat surface, in which solid particles are firmly bound to each other, is included. As a result, in a case where the sheet for an all-solid state secondary battery according to the embodiment of the present invention is used as a constitutional layer of the all-solid state secondary battery, it is possible to realize excellent cycle characteristics of the all-solid state secondary battery. In particular, in the electrode sheet for an all-solid state secondary battery and the all-solid state secondary battery, in which the active material layer is formed of the inorganic solid electrolyte-containing composition according to the embodiment of the present invention, the active material layer and the collector exhibit strong adhesiveness, and thus it is possible to realize further improvement of the cycle characteristics. As a result, the sheet for an all-solid state secondary battery according to the embodiment of the present invention is suitably used as a sheet with which a constitutional layer of an all-solid state secondary battery can be formed.

[Manufacturing Method for Sheet for all-Solid State Secondary Battery]

The manufacturing method for a sheet for an all-solid state secondary battery according to the embodiment of the present invention is not particularly limited, and the sheet can be manufactured by forming each of the above layers using the inorganic solid electrolyte-containing composition according to the embodiment of the present invention. Examples thereof include a method in which the film formation (the coating and drying) is carried out preferably on a base material or a collector (another layer may be interposed) to form a layer (a coated and dried layer) consisting of an inorganic solid electrolyte-containing composition. As a result, the sheet for an all-solid state secondary battery including the base material or the collector, and the coated and dried layer can be produced. In particular, in a case where a film of the inorganic solid electrolyte-containing composition according to the embodiment of the present invention is formed on a collector to produce a sheet for an all-solid state secondary battery, it is possible to strengthen the adhesion between the collector and the active material layer. Here, the coated and dried layer refers to a layer formed by carrying out coating with the inorganic solid electrolyte-containing composition according to the embodiment of the present invention and drying the dispersion medium (that is, a layer formed using the inorganic solid electrolyte-containing composition according to the embodiment of the present invention and consisting of a composition obtained by removing the dispersion medium from the inorganic solid electrolyte-containing composition according to the embodiment of the present invention). In the active material layer and the coated and dried layer, the dispersion medium may remain within a range where the effect of the present invention is not impaired, and the residual amount thereof, for example, in each of the layers may be 3% by mass or lower.

In the manufacturing method for a sheet for an all-solid state secondary battery according to the embodiment of the present invention, each of the steps such as coating and drying will be described in the following manufacturing method for an all-solid state secondary battery.

In the manufacturing method for a sheet for an all-solid state secondary battery according to the embodiment of the present invention, the coated and dried layer obtained as described above can be pressurized. The pressurizing condition and the like will be described later in the section of the manufacturing method for an all-solid state secondary battery.

In addition, in the manufacturing method for a sheet for an all-solid state secondary battery according to the embodiment of the present invention, the base material, the protective layer (particularly stripping sheet), or the like can also be stripped.

[All-Solid State Secondary Battery]

The all-solid state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The all-solid state secondary battery according to the embodiment of the present invention is not particularly limited in the configuration as long as it has a solid electrolyte layer between the positive electrode active material layer and the negative electrode active material layer, and for example, a known configuration for an all-solid state secondary battery can be employed. In a preferred all-solid state secondary battery, a positive electrode collector is laminated on a surface of the positive electrode active material layer opposite to the solid electrolyte layer to constitute a positive electrode, and a negative electrode collector is laminated on a surface of the negative electrode active material layer opposite to the solid electrolyte layer to constitute a negative electrode. In the present invention, each constitutional layer (including a collector and the like) that constitutes an all-solid state secondary battery may have a monolayer structure or a multilayer structure.

In the all-solid state secondary battery according to the embodiment of the present invention, at least one layer of the negative electrode active material layer, the positive electrode active material layer, or the solid electrolyte layer is a layer formed of the inorganic solid electrolyte-containing composition according to the embodiment of the present invention, which has excellent cycle characteristics. In the all-solid state secondary battery according to the embodiment of the present invention, from the viewpoint of further improving the cycle characteristics, it is preferable that at least two layer of the negative electrode active material layer, the positive electrode active material layer, and the solid electrolyte layer is a layer formed of the inorganic solid electrolyte-containing composition according to the embodiment of the present invention, and it is more preferable that all layers of the negative electrode active material layer, the positive electrode active material layer, and the solid electrolyte layer is a layer formed of the inorganic solid electrolyte-containing composition according to the embodiment of the present invention. In the present invention, forming the constitutional layer of the all-solid state secondary battery by using the inorganic solid electrolyte-containing composition according to the embodiment of the present invention includes an aspect in which the constitutional layer is formed by using the sheet for an all-solid state secondary battery according to the embodiment of the present invention (however, in a case where a layer other than the layer formed of the inorganic solid electrolyte-containing composition according to the embodiment of the present invention is provided, a sheet from which this layer is removed). In the active material layer or the solid electrolyte layer formed of the inorganic solid electrolyte-containing composition according to the embodiment of the present invention, the kinds of components to be contained and the contents thereof are preferably the same as the solid content of the inorganic solid electrolyte-containing composition according to the embodiment of the present invention.

<Active Material Layer and Solid Electrolyte Layer>

The thickness of each of the negative electrode active material layer, the solid electrolyte layer, and the positive electrode active material layer is not particularly limited. In case of taking a dimension of a general all-solid state secondary battery into account, the thickness of each of the layers is preferably 10 to 1,000 μm and more preferably 20 μm or more and less than 500 μm. In the all-solid state secondary battery according to the embodiment of the present invention, the thickness of at least one layer of the positive electrode active material layer or the negative electrode active material layer is still more preferably 50 μm or more and less than 500 μm.

In a case where the active material layer or the solid electrolyte layer is not formed of the inorganic solid electrolyte-containing composition according to the embodiment of the present invention, a known material in the related art can be used.

<Collector>

The positive electrode collector and the negative electrode collector are preferably an electron conductor.

In the present invention, either or both of the positive electrode collector and the negative electrode collector will also be simply referred to as the collector.

As a material that forms the positive electrode collector, not only aluminum, an aluminum alloy, stainless steel, nickel, or titanium but also a material (a material on which a thin film has been formed) obtained by treating the surface of aluminum or stainless steel with carbon, nickel, titanium, or silver is preferable. Among these, aluminum or an aluminum alloy is more preferable.

As a material that forms the negative electrode collector, aluminum, copper, a copper alloy, stainless steel, nickel, titanium, or the like, and further, a material obtained by treating the surface of aluminum, copper, a copper alloy, or stainless steel with carbon, nickel, titanium, or silver is preferable, and aluminum, copper, a copper alloy, or stainless steel is more preferable.

Regarding the shape of the collector, a film sheet shape is typically used; however, it is also possible to use shapes such as a net shape, a punched shape, a lath body, a porous body, a foaming body, and a molded body of a fiber group.

The thickness of the collector is not particularly limited; however, it is preferably 1 to 500 μm. In addition, protrusions and recesses are preferably provided on the surface of the collector by carrying out a surface treatment.

<Other Configurations>

In the present invention, a functional layer, a functional member, or the like may be appropriately interposed or disposed between or on the outside of the respective layers of the negative electrode collector, the negative electrode active material layer, the solid electrolyte layer, the positive electrode active material layer, and the positive electrode collector.

<Housing>

Depending on the use application, the all-solid state secondary battery according to the embodiment of the present invention may be used as the all-solid state secondary battery having the above-described structure as it is but is preferably sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

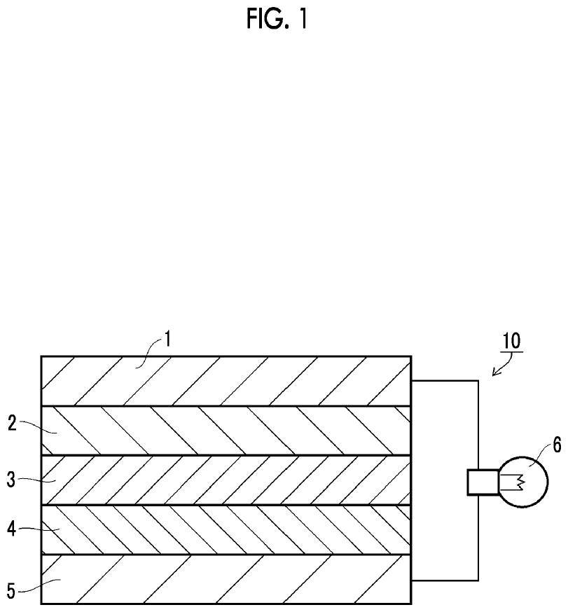

Hereinafter, the all-solid state secondary battery according to the preferred embodiment of the present invention will be described with reference to FIG. 1; however, the present invention is not limited thereto.

FIG. 1 is a cross-sectional view schematically illustrating an all-solid state secondary battery (a lithium ion secondary battery) according to a preferred embodiment of the present invention. In a case of being seen from the negative electrode side, an all-solid state secondary battery 10 of the present embodiment includes a negative electrode collector 1, a negative electrode active material layer 2, a solid electrolyte layer 3, a positive electrode active material layer 4, and a positive electrode collector 5 in this order. The respective layers are in contact with each other, and thus structures thereof are adjacent. In a case in which the above-described structure is employed, during charging, electrons (e) are supplied to the negative electrode side, and lithium ions (Lit) are accumulated on the negative electrode side. On the other hand, during discharging, the lithium ions (Lit) accumulated in the negative electrode return to the positive electrode side, and electrons are supplied to an operation portion 6. In an example illustrated in the drawing, an electric bulb is employed as a model at the operation portion 6 and is lit by discharging.

In a case where the all-solid state secondary battery having a layer configuration illustrated in FIG. 1 is placed in a 2032-type coin case, the all-solid state secondary battery will be referred to as a laminate for an all-solid state secondary battery, and a battery produced by placing this laminate for an all-solid state secondary battery in a 2032-type coin case will be referred to as a (coin type) all-solid state secondary battery, whereby both batteries may be distinctively referred to in some cases.

(Positive Electrode Active Material Layer, Solid Electrolyte Layer, and Negative Electrode Active Material Layer)

In the all-solid state secondary battery 10, all of the positive electrode active material layer, the solid electrolyte layer, and the negative electrode active material layer are formed of the inorganic solid electrolyte-containing composition of the embodiment of the present invention. This all-solid state secondary battery 10 exhibits excellent battery performance. The kinds of the inorganic solid electrolyte and the polymer binder which are contained in the positive electrode active material layer 4, the solid electrolyte layer 3, and the negative electrode active material layer 2 may be identical to or different from each other.

In the present invention, any one of the positive electrode active material layer and the negative electrode active material layer, or collectively both of them may be simply referred to as an active material layer or an electrode active material layer. In addition, in the present invention, any one of the positive electrode active material and the negative electrode active material, or collectively both of them may be simply referred to as an active material or an electrode active material.

In the present invention, in a case where the constitutional layer is formed of the inorganic solid electrolyte-containing composition according to the embodiment of the present invention, it is possible to realize an all-solid state secondary battery having excellent cycle characteristics.

In the all-solid state secondary battery 10, the negative electrode active material layer can be a lithium metal layer. Examples of the lithium metal layer include a layer formed by depositing or molding a lithium metal powder, a lithium foil, and a lithium vapor deposition film. The thickness of the lithium metal layer can be, for example, 1 to 500 μm regardless of the above thickness of the above negative electrode active material layer.

(Collector)

The positive electrode collector 5 and the negative electrode collector 1 are as described above.

In a case where the all-solid state secondary battery 10 has a constitutional layer other than the constitutional layer formed of the inorganic solid electrolyte-containing composition according to the embodiment of the present invention, a layer formed of a known constitutional layer forming material can also be applied.

In addition, each layer may be constituted of a single layer or multiple layers.

[Manufacture of all-Solid State Secondary Battery]

The all-solid state secondary battery can be manufactured by a conventional method. Specifically, the all-solid state secondary battery can be manufactured by forming each of the layers described above using the inorganic solid electrolyte-containing composition of the embodiment of the present invention or the like. Hereinafter, the manufacturing method therefor will be described in detail.

The all-solid state secondary battery according to the embodiment of the present invention can be manufactured by carrying out a method (a manufacturing method for a sheet for an all-solid state secondary battery according to the embodiment of the present invention) which includes (is carried out through) a step of coating an appropriate base material (for example, a metal foil which serves as a collector) with the inorganic solid electrolyte-containing composition according to the embodiment of the present invention and forming a coating film (forming a film).

For example, an inorganic solid electrolyte-containing composition containing a positive electrode active material is applied as a material for a positive electrode (a positive electrode composition) onto a metal foil which is a positive electrode collector, to form a positive electrode active material layer, thereby producing a positive electrode sheet for an all-solid state secondary battery. Next, the inorganic solid electrolyte-containing composition for forming a solid electrolyte layer is applied onto the positive electrode active material layer to form the solid electrolyte layer. Furthermore, an inorganic solid electrolyte-containing composition containing a negative electrode active material is applied as a material for a negative electrode (a negative electrode composition) onto the solid electrolyte layer, to form a negative electrode active material layer. A negative electrode collector (a metal foil) is overlaid on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can also be manufactured by enclosing the all-solid state secondary battery in a housing.

In addition, it is also possible to manufacture an all-solid state secondary battery by carrying out the forming method for each layer in reverse order to form a negative electrode active material layer, a solid electrolyte layer, and a positive electrode active material layer on a negative electrode collector and overlaying a positive electrode collector thereon.

Examples of the other method include the following method. That is, the positive electrode sheet for an all-solid state secondary battery is produced as described above. In addition, an inorganic solid electrolyte-containing composition containing a negative electrode active material is applied as a material for a negative electrode (a negative electrode composition) onto a metal foil which is a negative electrode collector, to form a negative electrode active material layer, thereby producing a negative electrode sheet for an all-solid state secondary battery. Next, a solid electrolyte layer is formed on the active material layer in any one of these sheets as described above. Furthermore, the other one of the positive electrode sheet for an all-solid state secondary battery and the negative electrode sheet for an all-solid state secondary battery is laminated on the solid electrolyte layer such that the solid electrolyte layer and the active material layer come into contact with each other. In this manner, an all-solid state secondary battery can be manufactured.

As still another method, for example, the following method can be used. That is, a positive electrode sheet for an all-solid state secondary battery and a negative electrode sheet for an all-solid state secondary battery are produced as described above. In addition, separately from the positive electrode sheet for an all-solid state secondary battery and the negative electrode sheet for an all-solid state secondary battery, an inorganic solid electrolyte-containing composition is applied onto a base material, thereby producing a solid electrolyte sheet for an all-solid state secondary battery consisting of a solid electrolyte layer. Furthermore, the positive electrode sheet for an all-solid state secondary battery and the negative electrode sheet for an all-solid state secondary battery are laminated with each other to sandwich the solid electrolyte layer that has been peeled off from the base material. In this manner, an all-solid state secondary battery can be manufactured.

The solid electrolyte layer or the like can also be formed by, for example, forming an inorganic solid electrolyte-containing composition or the like on a substrate or an active material layer by pressurization molding under pressurizing conditions described later.

In the above manufacturing method, it suffices that the inorganic solid electrolyte-containing composition according to the embodiment of the present invention is used in any one of the positive electrode composition, the inorganic solid electrolyte-containing composition, and the negative electrode composition, and the inorganic solid electrolyte-containing composition according to the embodiment of the present invention can be used in any one of the compositions.

<Formation (Film Formation) of Each Layer>

The method of applying the inorganic solid electrolyte-containing composition is not particularly limited and can be appropriately selected. Examples thereof include wet-type coating methods such as spray coating, spin coating, dip coating, slit coating, stripe coating, and bar coating.

In this case, the inorganic solid electrolyte-containing composition may be subjected to drying treatment (heating treatment) each time or may be subjected to drying treatment after being applied multiple times. The drying temperature is not particularly limited as long as the dispersion medium can be removed, and it is appropriately set according to the boiling point of the dispersion medium. The lower limit of the drying temperature is, for example, preferably 30° C. or higher, more preferably 60° C. or higher, and still more preferably 80° C. or higher. The upper limit thereof is preferably 300° C. or lower, more preferably 250° C. or lower, and still more preferably 200° C. or lower. In a case where the solid electrolyte composition is heated in the above-described temperature range, the dispersion medium can be removed to make the composition enter a solid state (coated and dried layer). This temperature range is preferable since the temperature is not excessively increased and each member of the all-solid state secondary battery is not impaired. As a result, excellent overall performance is exhibited in the all-solid state secondary battery, and it is possible to obtain a good application suitability (adhesiveness) and a good ion conductivity even without pressurization.

In a case where the inorganic solid electrolyte-containing composition according to the embodiment of the present invention is applied and dried as described above, it is possible to suppress the variation in the contact state and bind solid particles, and furthermore, it is possible to form a coated and dried layer having a flat surface.

After applying the inorganic solid electrolyte-containing composition, it is preferable to pressurize each layer or the all-solid state secondary battery after superimposing the constitutional layers or producing the all-solid state secondary battery. In addition, each of the layers is also preferably pressurized together in a state of being laminated. Examples of the pressurizing methods include a method using a hydraulic cylinder press machine. The pressurizing force is not particularly limited; however, it is generally preferably in a range of 5 to 1,500 MPa.

In addition, the applied inorganic solid electrolyte-containing composition may be heated at the same time with the pressurization. The heating temperature is not particularly limited but is generally in a range of 30° C. to 300° C. The press can also be applied at a temperature higher than the glass transition temperature of the inorganic solid electrolyte. It is also possible to carry out pressing at a temperature higher than the glass transition temperature of the polymer that constitutes a polymer binder. However, in general, the temperature does not exceed the melting point of this polymer.

The pressurization may be carried out in a state where the coating solvent or dispersion medium has been dried in advance or in a state where the solvent or the dispersion medium remains.

The respective compositions may be applied at the same time, and the application, the drying, and the pressing may be carried out simultaneously and/or sequentially. Each of the compositions may be applied onto each of the separate base materials and then laminated by carrying out transfer.

The atmosphere during the coating or during the pressurization is not particularly limited and may be any one of the atmospheres such as an atmosphere of dried air (the dew point: −20° C. or lower) and an atmosphere of inert gas (for example, an argon gas, a helium gas, or a nitrogen gas).

The pressurization time may be a short time (for example, within several hours) under the application of a high pressure or a long time (one day or longer) under the application of an intermediate pressure. In case of members other than the sheet for an all-solid state secondary battery, for example, the all-solid state secondary battery, it is also possible to use a restraining device (screw fastening pressure or the like) of the all-solid state secondary battery in order to continuously apply an intermediate pressure.

The pressing pressure may be a pressure that is constant or varies with respect to a portion under pressure such as a sheet surface.

The pressing pressure may be variable depending on the area or the film thickness of the portion under pressure. In addition, the pressure may also be variable stepwise for the same portion.

A pressing surface may be flat or roughened.

<Initialization>

The all-solid state secondary battery manufactured as described above is preferably initialized after the manufacturing or before use. The initialization is not particularly limited, and it is possible to initialize the all-solid state secondary battery by, for example, carrying out initial charging and discharging in a state where the pressing pressure is increased and then releasing the pressure up to a pressure at which the all-solid state secondary battery is ordinarily used.

[Use Application of all-Solid State Secondary Battery]

The all-solid state secondary battery according to the embodiment of the present invention can be applied to a variety of usages. The application aspect thereof is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. Additionally, examples of consumer usages include automobiles (electric vehicles and the like), electric vehicles, motors, lighting equipment, toys, game devices, road conditioners, watches, strobes, cameras, medical devices (pacemakers, hearing aids, and shoulder massage devices, and the like). Furthermore, the all-solid state secondary battery can be used for a variety of military usages and universe usages. In addition, the all-solid state secondary battery can also be combined with a solar battery.

### EXAMPLES

Hereinafter, the present invention will be described in more detail based on Examples; however, the present invention is not limited thereto be interpreted. “Parts” and “%” that represent compositions in the following Examples are based on the mass unless particularly otherwise described. In the present invention, “room temperature” means 25° C.

### 1. Synthesis of Polymer

Polymers shown in the following chemical formulae were synthesized as follows.

### Synthesis Example 1: Synthesis of Polymer B-1

Specifically, 300 g of cyclohexane as a solvent and 1.0 mL of sec-butyl lithium (1.3 M, manufactured by FUJIFILM Wako Pure Chemical Corporation) as a polymerization initiator were charged into a pressure-resistant container that had been subjected to nitrogen substitution and drying, and after raising the temperature to 50° C., 27.4 g of styrene was added thereto carry out polymerization for 2 hours, 22.0 g of 1,3-butadiene and 20.7 g of ethylene were subsequently added thereto carry out polymerization for 3 hours, and then 27.4 g of styrene was added thereto carry out polymerization for 2 hours. The obtained solution was reprecipitated in methanol and dried to obtain a solid, and 3 parts by mass of 2,6-di-t-butyl-p-cresol and 2.5 g of maleic acid anhydride were added with respect to 100 parts by mass of the obtained solid, and then the reaction was carried out at 180° C. for 5 hours. The obtained solution was reprecipitated in acetonitrile, and the obtained solid was dried at 80° C. to obtain a polymer (a dry solid product). Then, in a pressure-resistant container, the entire amount of the polymer obtained above was dissolved in 400 parts by mass of cyclohexane, and then 5% by mass of palladium carbon (palladium carrying amount: 5% by mass) with respect to the above-described polymer was added as a hydrogenation catalyst, and the mixture was subjected to a reaction under the conditions of a hydrogen pressure of 2 MPa and 150° C. for 10 hours. After allowing cooling and pressure release, palladium carbon was removed by filtration, the filtrate was concentrated, and further vacuum dried to obtain a binder precursor A.

450 parts by mass of xylene (manufactured by FUJIFILM Wako Pure Chemical Corporation) and 50 parts by mass of the binder precursor A were added to a 1 L three-necked flask equipped with a reflux condenser and a gas introduction cock and dissolved. Then, 2 parts by mass of 1H,1H,2H,2H-perfluoro-1-octanol (manufactured by FUJIFILM Wako Pure Chemical Corporation) was added thereto, the temperature was raised to 130° C., and stirring was continued for 20 hours. Then, the reaction solution was added dropwise to methanol to obtain an SEBS polymer (B-1) as a precipitate. After drying under reduced pressure at 60° C. for 5 hours, the precipitate was redissolved in butyl butyrate. In this way, a polymer B-1 having a mass average molecular weight of 99,000 was synthesized to obtain a binder solution B-1 (concentration: 10% by mass) consisting of the polymer B-1.

In the polymer (B-1), the content of the above-described constitutional component having a functional group selected from the group (a) of functional groups, excluding styrene, ethylene, and butylene, is 1.5% by mole for the fluoroalkyl group and 1.5% by mole for the carboxy group, and the total thereof is 3.0% by mole.

### Synthesis Example 2: Synthesis of binder B-2

200 parts by mass of ion exchange water, 96 parts by mass of vinylidene fluoride, 60 parts by mass of hexafluoropropylene, and 44 parts by mass of tetrafluoroethylene were added to the autoclave, 1 part by mass of diisopropyl peroxydicarbonate was added, and the mixture was stirred at 30° C. for 24 hours. After completion of the polymerization, the precipitate was filtered and dried at 100° C. for 10 hours to obtain a polymer (binder) B-2. The obtained polymer B-2 was a random copolymer, and the mass average molecular weight thereof was 68,000.

The obtained polymer B-2 was dissolved in butyl butyrate to obtain a binder solution B-2 (concentration: 10% by mass) consisting of the polymer B-2.

### Synthesis Example 3: Synthesis of Binder B-3

To a 100 mL volumetric flask, 1.6 g of acrylic acid (manufactured by Tokyo Chemical Industry Co., Ltd.), 98.4 g of dodecyl acrylate (manufactured by Tokyo Chemical Industry Co., Ltd.), and 0.36 g of a polymerization initiator V-601 (product name, manufactured by FUJIFILM Wako Pure Chemical Corporation) were added and dissolved in 36 g of butyl butyrate to prepare a monomer solution. To a 300 mL three-necked flask, 18 g of butyl butyrate was added and stirred at 80° C., and then the above monomer solution was added dropwise thereto over 2 hours. After completion of the dropwise addition, the temperature was raised to 90° C., and stirring was carried out for 2 hours to synthesize a polymer B-3 (a methacrylic polymer). The obtained solution was reprecipitated in methanol and redissolved in butyl butyrate to obtain a binder solution B-3 (concentration: 10% by mass) consisting of a polymer B-3.

### Synthesis Example 4: Synthesis of Binder B-15

A polymer B-15 was synthesized in the same manner as in Synthesis Example 3 to obtain a binder solution B-15 (concentration: 10% by mass) consisting of the polymer B-15, except that in Synthesis Example 3, a compound from which each constitutional component was derived was used so that the polymer B-15 had the composition (the content of the constitutional component) shown in the following structural formula.

### Synthesis Examples 5 to 14: Synthesis of Binders B-4 to B-13

Polymers (binders) B-4 to B-13 were synthesized in the same manner to obtain butyl butyrate solutions (concentration: 10% by mass) of the binders B-4 to B-13, except that in Synthesis Example 3, AS-6 (product name, a styrene macromonomer, number average molecular weight: 6,000, manufactured by TOAGOSEI Co., Ltd.), maleic acid anhydride, and dodecyl acrylate were respectively used according to the amounts shown in Table A below instead of acrylic acid and dodecyl acrylate and that a polymerization initiator V-601 (product name, manufactured by FUJIFILM Wako Pure Chemical Corporation) was used according to the amount shown in Table A below.

In Table A below, the units of the blending amount of each monomer component and V-601 are “g”, and the unit of the blending amount ratio of each monomer component is “% by mole”.

TABLE A

| | AS-6 | | Dodecyl acrylate | | Maleic acid anhydride | | V-601 |
|---|---|---|---|---|---|---|---|
| | Blending | Molar | Blending | Molar | Blending | Molar | Blending |
| Binder | amount | ratio | amount | ratio | amount | ratio | amount |
| B-4 | 30 | 1.4 | 60 | 70.05 | 10 | 28.55 | 0.36 |
| B-5 | 30 | 1.5 | 62 | 74.9 | 8 | 23.6 | 0.36 |
| B-6 | 30 | 1.5 | 65 | 82.9 | 5 | 15.6 | 0.36 |
| B-7 | 30 | 1.6 | 68 | 91.8 | 2 | 6.6 | 0.36 |
| B-8 | 30 | 1.7 | 69.2 | 95.6 | 0.8 | 2.7 | 0.36 |
| B-9 | 30 | 1.7 | 69.2 | 95.6 | 0.8 | 2.7 | 0.11 |
| B-10 | 30 | 1.7 | 69.2 | 95.6 | 0.8 | 2.7 | 0.05 |
| B-11 | 30 | 1.7 | 69.2 | 95.6 | 0.8 | 2.7 | 1.00 |
| B-12 | 30 | 1.7 | 69.4 | 96.3 | 0.6 | 2.0 | 0.36 |
| B-13 | 30 | 1.7 | 69.7 | 97.3 | 0.3 | 1.0 | 0.36 |

### Synthesis Example 15: Preparation of Binder B-14

An epoxidized product of a styrene-butadiene block copolymer (product name: EPOFRIEND AT501, manufactured by Daicel Corporation) was dissolved in butyl butyrate to obtain a butyl butyrate solution (concentration: 10% by mass) of the binder B-14.

### Synthesis Example 16: Preparation of Binder B-16

An ethylene-acrylic acid ester-glycidyl acrylate copolymer (product name: BONDFAST BF-7M, manufactured by Sumitomo Chemical Corporation) was dissolved in butyl butyrate to obtain a butyl butyrate solution (concentration: 10% by mass) of the binder B-16.

### Synthesis Example 17: Synthesis of Binder B-17

A polymer (a binder) B-17 was synthesized in the same manner to obtain a butyl butyrate solution (concentration: 10% by mass) of the binder B-17, except that in Synthesis Example 3, 37.7 g of butyl acrylate and 62.3 g of styrene were used instead of the acrylic acid and the dodecyl acrylate.

### [Synthesis Example 18: Synthesis of Binder T-1] (Acrylic Latex (Insoluble Type Binder))

The binder B-3 described in Table 1 of JP2015-088486A was synthesized in the same manner as in the synthesis of the binder B-1 described in paragraphs [0123] and [0124] of JP2015-088486A. That is, using 20 parts by mass of methyl acrylate, 80 parts by mass of polyethylene glycol monomethyl ether acrylate (average repetition number of ethylene glycols: 9), and 11 parts by mass of the following macromonomer M-1, as monomer components, a polymer (a binder) T-1 (corresponding to the binder B-3 in JP2015-088486A) was synthesized to obtain a butyl butyrate solution (concentration: 10% by mass) of a binder T-1.

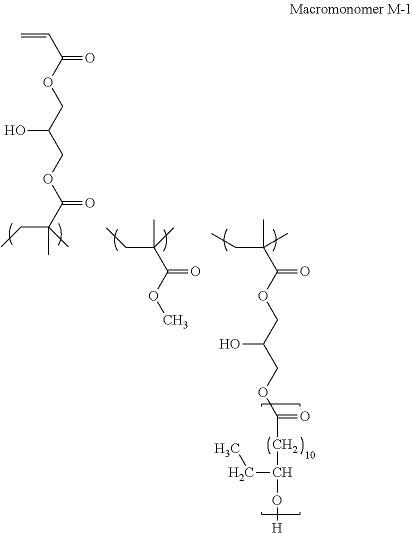

### [Synthesis Example 19: Preparation of Binder T-2] (Urethane Latex (Insoluble Type Binder))

ART PEARL MM-101SMA (product name, manufactured by Negami Chemical Industrial Co., Ltd.) was dispersed in butyl butyrate to obtain a butyl butyrate dispersion liquid (concentration: 10% by mass) of a binder T-2.

### [Synthesis Example 20: Preparation of Binder T-3] (Hydrocarbon-Based Latex (Insoluble Type Binder))

FLO-BEADS (product name, a polyethylene-acrylic copolymer powder, manufactured by Sumitomo Seika Co., Ltd.) was dispersed in butyl butyrate to obtain a butyl butyrate dispersion liquid (concentration: 10% by mass) of a binder T-3.

### [Synthesis Example 21: Preparation of Binder T-4] (Fluorine-Based Latex (Insoluble Type Binder))

Microdispers-200 (product name, manufactured by Techno Chemical Corporation) was dispersed in butyl butyrate to obtain a butyl butyrate dispersion liquid (concentration: 10% by mass) of a binder T-4.

### Synthesis Example 22: Synthesis of Binders B-18 to B-24

Polymers B-18 to B-24 were synthesized in the same manner as in Synthesis Example 3 to obtain binder solutions B-18 to B-24 consisting of the polymers B-18 to B-24 (concentration: 10% by mass) by using the dispersion medium shown in the table below, except that in Synthesis Example 3, a compound from which each constitutional component was derived was used instead of acrylic acid and dodecyl acrylate so that the structure and the composition (the content of the constitutional component) were as shown in the following structural formula and that the amount of the polymerization initiator V-601 (product name, manufactured by FUJIFILM Wako Pure Chemical Corporation) was appropriately changed in order to adjust the molecular weight.

### Synthesis Example 23: Synthesis of Binder B-25

To a 200 mL volumetric flask, 1.0 g of maleic acid anhydride (manufactured by Tokyo Chemical Industry Co., Ltd.), 99.0 g of dodecyl acrylate (manufactured by FUJIFILM Wako Pure Chemical Corporation), and 0.06 g of a polymerization initiator V-601 (product name, manufactured by FUJIFILM Wako Pure Chemical Corporation) were added and dissolved in 36 g of butyl butyrate to prepare a monomer solution. To a 500 mL three-necked flask, 30 g of butyl butyrate was added and stirred at 80° C., and then the above monomer solution was added dropwise thereto over 2 hours. After the completion of the dropwise addition, the solution was heated to 90° C. and stirred for 2 hours. Then, the temperature was decreased to 60° C., butyl butyrate was added thereto so that the solid content was 30%, 80 g of methanol was added thereto, and mixing was at 60° C. for 1 hour. The obtained solution was reprecipitated in acetonitrile and redissolved in butyl butyrate to obtain a binder solution B-25 (concentration: 10% by mass) consisting of a polymer B-25.

Each of the polymers synthesized is shown below. The number at the bottom right of each constitutional component indicates the content (% by mole). In the following structural formulae, Me represents a methyl group.

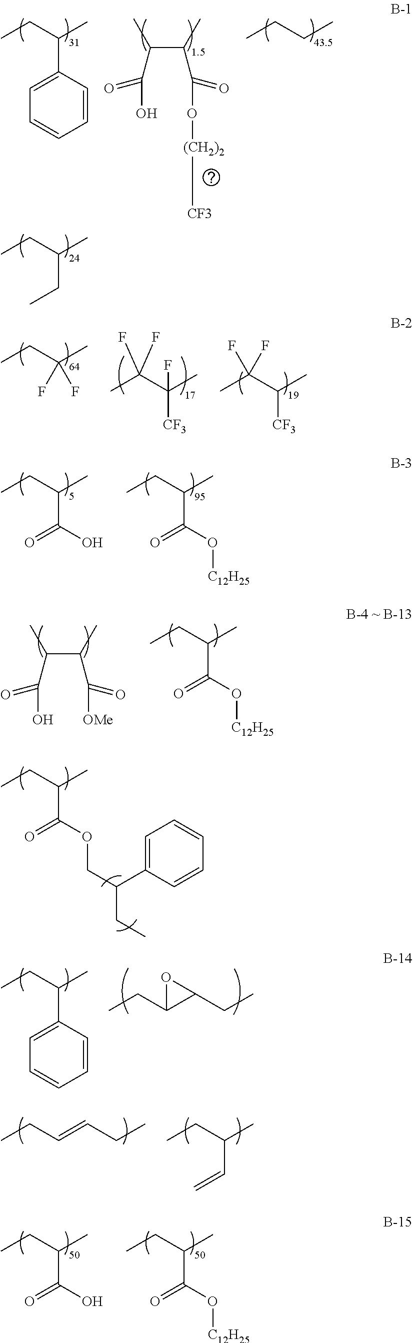

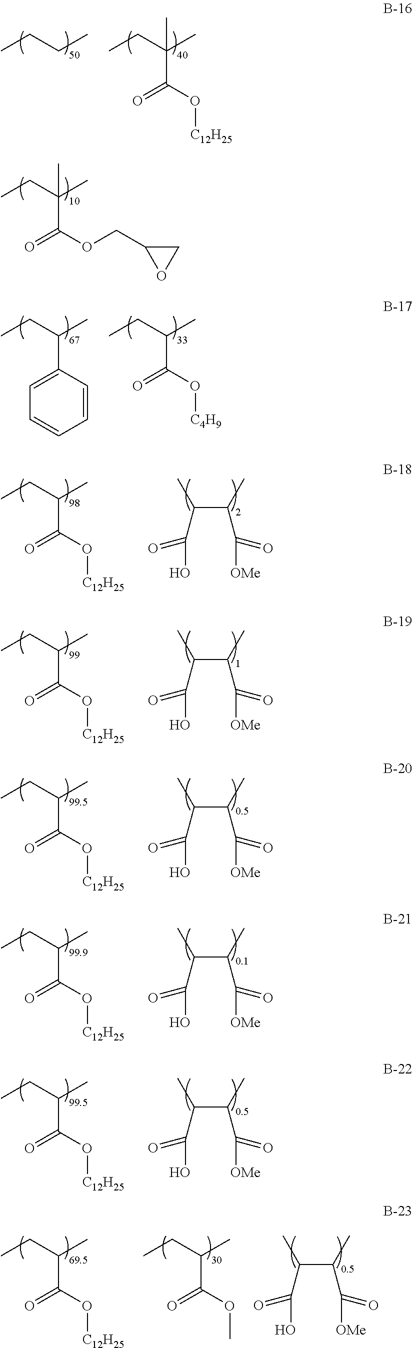

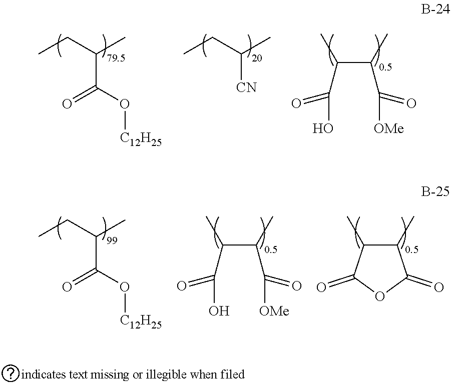

The mass average molecular weight (Mw) and SP value of each synthesized polymer (binder) were calculated based on the above-described methods, and the dispersion element and the polarity element of the surface energy of each polymer (binder) and the adsorption rate with respect to the inorganic solid electrolyte were calculated based on the methods described later. These results are shown in Table 1.

It is noted that regarding the combination of the binder and the dispersion medium used in the preparation of each of the inorganic solid electrolyte-containing compositions shown in Tables 1-1 to 1-4 below, as a result of determining the solubility of each polymer synthesized as above, in the dispersion medium, according to the transmittance measurement described above, the solubility was 10% by mass or more in any case.

### 2. Synthesis of Sulfide-Based Inorganic Solid Electrolyte

### Synthesis Example A

A sulfide-based inorganic solid electrolyte was synthesized with reference to a non-patent document of T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box in an argon atmosphere (dew point: −70° C.), lithium sulfide (Li₂S, manufactured by Sigma-Aldrich Co., LLC Co., LLC Co., LLC, purity: >99.98%) (2.42 g) and diphosphorus pentasulfide (P₂S₅, manufactured by Sigma-Aldrich Co., LLC Co., LLC Co., LLC, purity: >99%) (3.90 g) each were weighed, put into an agate mortar, and mixed using an agate pestle for five minutes. The mixing ratio between Li₂S and P₂S₅ (Li₂S:P₂S₅) was set to 75:25 in terms of molar ratio.

Next, 66 g of zirconia beads having a diameter of 5 mm were put into a 45 mL container made of zirconia (manufactured by FRITSCH), the entire amount of the mixture of the above lithium sulfide and the diphosphorus pentasulfide was put thereinto, and the container was completely sealed in an argon atmosphere. The container was set in a planetary ball mill P-7 (product name, manufactured by FRITSCH), mechanical milling was carried out at a temperature of 25° C. and a rotation speed of 510 rpm for 36 hours, thereby obtaining yellow powder (6.20 g) of a sulfide-based inorganic solid electrolyte (Li—P—S-based glass, hereinafter, may be referred to as LPS). The particle diameter of the Li—P—S-based glass was 4 μm.

### Example 1

<Preparation of Inorganic Solid Electrolyte-Containing Composition (Slurry)>

2.8 g of the LPS synthesized in Synthesis Example A, 0.08 g (in terms of solid content mass) of the binder solution prepared as above, and the dispersion medium shown in the table below were put into a container for a self-rotation type mixer (ARE-310, manufactured by THINKY CORPORATION) so that the content of the dispersion medium in the composition was 50% by mass. Then, this container was set in a self-rotation type mixer ARE-310 (product name) manufactured by THINKY CORPORATION. The inorganic solid electrolyte-containing compositions (slurries) S-1 to S-34 were prepared by mixing for 5 minutes under the conditions of 25° C. and a rotation speed of 2,000 rpm.

The contents of the respective components in the composition were 97.2% by mass for LPS and 2.8% by mass for the binder in 100% by mass of the solid content. It is noted that compositions S-17 and S-21 to S-24 contain two kinds of binders in a mass ratio of 50:50.

<Preparation of Positive Electrode Composition (Slurry)>

2.8 g of the LPS synthesized in Synthesis Example A and the dispersion medium shown in the table below were put into a container for a self-rotation type mixer (ARE-310, manufactured by THINKY CORPORATION) so that the content of the dispersion medium in the positive electrode composition was 50% by mass. Then, this container was set in the self-rotation type mixer ARE-310 (product name) manufactured by THINKY CORPORATION and, mixing was carried out for 2 minutes at 25° C. and a rotation speed of 2,000 rpm. Then, 13.2 g of LiNi_{1/3}Co_{1/3}Mn_{1/3}O₂ (NMC, manufactured by Sigma-Aldrich Co., LLC) as a positive electrode active material, 0.32 g of acetylene black (AB) as a conductive auxiliary agent, and 0.16 g (in terms of solid content mass) of the binder solution prepared as above were put into this container, and the container was set in the self-rotation type mixer ARE-310, and mixing was carried out for 2 minutes under the conditions of 25° C. and the rotation speed of 2,000 rpm to prepare each of positive electrode compositions (slurries) P-1 to P-20.

The contents of the respective components in the composition were 17.0% by mass for LPS, 80.1% by mass for NMC, 1.0% by mass for the binder, and 1.9% by mass for AB in 100% by mass of the solid content.

<Preparation of Negative Electrode Composition (Slurry)>

2.8 g of the LPS synthesized in Synthesis Example A, 0.08 g (in terms of solid content mass) of the binder solution prepared as above, and the dispersion medium shown in the table below were put into a container for a self-rotation type mixer (ARE-310, manufactured by THINKY CORPORATION) so that the content of the dispersion medium in the negative electrode composition was 50% by mass. Then, this container was set in the self-rotation type mixer ARE-310 (product name) manufactured by THINKY CORPORATION, and mixing was carried out for 2 minutes under the conditions of 25° C. and the rotation speed of 2,000 rpm. Then, 3.53 g of silicon (Si, manufactured by Sigma-Aldrich Co., LLC) as a negative electrode active material and 0.27 g of carbon nanotube VGCF (product name, manufactured by Showa Denko K.K.) as a conductive auxiliary agent were put into the container, the container was set in the same manner in the self-rotation type mixer ARE-310 (product name), and mixing was carried out for 2 minutes under the conditions of 25° C. and the rotation speed of 2,000 rpm to prepare each of negative electrode compositions (slurries) N-1 to N-22.

The contents of the respective components in the composition were 42.0% by mass for LPS, 52.8% by mass for Si, 1.2% by mass for the binder 1, and 4.0% by mass for VGCF in 100% by mass of the solid content. It is noted that compositions N-7 to N-9 and N-19 to N-21 were prepared by using 3.53 g of graphite (Gr, manufactured by Hohsen Corp.) instead of silicon.

Table 1 shows the kind of binder used for each of the prepared compositions. In addition, Table 1 collectively shows the dispersion element and the polarity element of the surface energy of each of the active material, the inorganic solid electrolyte, and the binder, as well as R_{SE}, R_{AM}, and R_{AM}+R_{SE}, which are calculated using the dispersion element and the polarity element thereof.

It is noted that Nos. S-1 to S-3, S-5 to S-15, S-17, S-19, S-21 to S-34, P-1, P-2, P-4 to P-9, P-11 to P-20, N-1, N-3 to N-5, N-7, N-8, and N-10 to N-22 are the inorganic solid electrolyte-containing compositions according to the present invention, and Nos. S-4, S-16, S-18, S-20, P-3, P-10, N-2, N-6, and N-9 are inorganic solid electrolyte-containing compositions for comparison.

<Measuring Method for Surface Energy (Surface Energies of Inorganic Solid Electrolyte and Active Material)>

The measurement was carried out using a powder contact angle measurement kit and optionally a high-precision surface tension meter DY-700 (product name, manufactured by Kyowa Interface Science Co., Ltd.).

Specifically, 2.0 g of a powder (an inorganic solid electrolyte or an active material) was packed in a cylinder having a diameter of 1 cm so that the cylinder was filled with the powder which subsequently compressed with a cylindrical rod having the same diameter as the inner diameter of the cylinder. The above-described cylinder was set on the above-described powder contact angle measurement kit, and three kinds of solvents (hexadecane, ethylene glycol, or bromonaphthalene) were allowed to permeate for 5 minutes, and W₂/t was measured. W indicates the permeation weight, and t indicates the time. The contact angle cos θ was calculated based on the following Washburn expression. ε represents the void ratio, and r represents the capillary radius.

$$\frac{{W}_{L}^{2}}{t} = {( S \cdot ε \cdot {ρ}_{L} )}^{2} \frac{r \cdot {Y}_{L} \cdot cos θ}{2 {η}_{L}}$$

W_{L}: Permeation weight
t: Time
S: Cell (powder layer filling part) cross sectional area
ε: Void ratio
ρ_{L}: Liquid density
r: Capillary radius formed by particle inside powder
Y_{L}: Liquid surface tension
η_{L}: Liquid viscosity
θ: Contact angle formed by liquid and solid surface

The contact angle of a liquid that wets most (hexadecane in a case of the inorganic solid electrolyte; ethylene glycol in a case of the active material) was assumed to be 0°, and W²/t actually measured was substituted in the above expression to determine ε2r. Here, ε²r is a constant that is determined depending on the powder kind.

W²/t and ε²r of each liquid were substituted in the expression for two kinds of other solvents (ethylene glycol and bromonaphthalene in a case of the inorganic solid electrolyte, and hexadecane and bromonaphthalene in a case of the active material), and cos θ was derived for each liquid.

The binary simultaneous equations in terms of the dispersion component Y=γSV^{d} and the polarity component X=γSV^{h} with respect to the following Fowkes expression associated with the contact angle component were solved to obtain the dispersion component and the polarity component.

The above measurement was carried out four times, and an average value from the measurements were taken to obtain the dispersion element Xse (dispersion component) and the polarity element Yse (polarity component) of the surface energy of the inorganic solid electrolyte and the dispersion element Xam (dispersion component) and the polarity element Yam (polarity component) of the surface energy of the active material. The unit is mN/m in any case.

$$\sqrt{γ {SV}^{d} γ {LV}^{d}} + \sqrt{γ {SV}^{h} γ {LV}^{h}} = \frac{γ L ( 1 + cos Θ )}{2}$$

It is noted that γLV^{h} and γLV^{d} are known constants determined from the surface tension γL of each liquid. For example, in a case of hexadecane, they are as follows: γLV^{d}=44.4 mN/m, and γLV^{h}=0.2 mN/m.

<Measuring Method for Surface Energy (Surface Energy of Binder)>

(1) Production of Polymer Film

100 μL of a 10% by mass solution of the above-described binder (polymer) was applied onto a silicon wafer (3×N type, manufactured by AS ONE Corporation) with a spin coater under the following conditions, and then vacuum drying was carried out at 100° C. for 2 hours to produce a binder film (polymer film).

It is noted that the 10% by mass solution of the binder was prepared according to the combination of the binder and the dispersion medium used in the preparation of each of the inorganic solid electrolyte-containing compositions shown in Tables 1-1 to 1-4 below.

—Measurement Conditions—

Rotation speed of spin coater: 2,000 rpm

Rotation time of spin coater: 5 seconds

(2) Measurement of Contact Angle θ

The contact angle θ of each liquid with respect to the polymer film produced on the silicon wafer as described above was measured according to the θ/2 method in the liquid droplet method. Here, an angle (an angle inside the liquid droplet), which is formed by the sample surface (the surface of a polymer film) and a liquid droplet after 200 milliseconds after the liquid droplet has been brought into contact with the surface of the polymer film and attached thereto, is defined as the contact angle θ.

(3) Derivation of Dispersion Element and Polarity Element of Surface Energy

In the same manner as in the derivation of the surface energies of the inorganic solid electrolyte and the active material, the binary simultaneous equations in terms of the dispersion component Y=γSV^{d} and the polarity component X=γSV^{h} with respect to the following Fowkes expression were solved to obtain the dispersion component and the polarity component.

The above measurement of the contact angle θ was carried out four times, and an average value from the measurements was taken to obtain the dispersion element Xba (dispersion component) and the polarity element Yba (polarity component) of the surface energy of the binder. The unit is mN/m in any case.

[Measurement of Adsorption Rate of Binder with Respect to Inorganic Solid Electrolyte]

The adsorption rate was measured using the inorganic solid electrolyte, the binder (the polymer), and the dispersion medium, which had been used in the preparation of each of the inorganic solid electrolyte-containing compositions shown in Table 1.

That is, a binder solution having a concentration of 1% by mass, which was obtained by dissolving the binder prepared as above in a dispersion medium, was prepared. The binder solution and the inorganic solid electrolyte were placed in a 15 ml of vial at a proportion such that the mass ratio of the binder in this binder solution to the inorganic solid electrolyte was 42:1, and stirred for 1 hour with a mix rotor at room temperature (25° C.) and a rotation speed of 80 rpm, and then allowed to stand. The supernatant obtained by solid-liquid separation was filtered through a filter having a pore diameter of 1 μm, and the entire amount of the obtained filtrate was dried to be solid, and then the mass of the binder remaining in the filtrate (the mass of the binder that had not adsorbed to the inorganic solid electrolyte) W_{A} was measured. From this mass W_{A} and the mass W_{B} of the binder contained in the binder solution used for the measurement, the adsorption rate of the binder with respect to the inorganic solid electrolyte was calculated according to the following expression.

The adsorption rate of the binder is the average value of the adsorption rates obtained by carrying out the above measurement twice.

Adsorption rate (%)=[(W_{B}−W_{A})/W_{B}]×100

It is noted that as a result of measuring the adsorption rate using the inorganic solid electrolyte and the binder, which had been extracted from the inorganic solid electrolyte layer formed into a film, and the dispersion medium which had been used for the preparation of the inorganic solid electrolyte-containing composition, the same value was obtained.

TABLE 1
Inorganic solid electrolyte-containing composition

| | Inorganic solid | | | | | | | | | | |
|---|---|---|---|---|---|---|---|---|---|---|---|
| | electrolyte | | | Binder | | | | | | | |
| | | Surface | | | Surface | | | | | | |
| | | energy | | | energy | | | | | | |
| | | Disper- | Polar- | | Disper- | Polar- | | | | Disper- | |
| | | sion | ity | | sion | ity | | Adsorp- | | sion | |
| | | element | element | | element | element | | tion | SP | medium | |
| No. | Kind | Xse | Yse | Kind | Xba | Yba | Mw | rate | value | Kind | R_{SE} |
| S-1 | LPS | 24 | 0 | B-1 | 12 | 1 | 70000 | 0 | 16.2 | Butyl | 12.0 |
| | | | | | | | | | | butyrate | |
| S-2 | LPS | 24 | 0 | B-2 | 18 | 2 | 68000 | 10 | 12.0 | Butyl | 6.3 |
| | | | | | | | | | | butyrate | |
| S-3 | LPS | 24 | 0 | B-3 | 23 | 1 | 73000 | 0 | 18.2 | Butyl | 1.4 |
| | | | | | | | | | | butyrate | |
| S-4 | LPS | 24 | 0 | B-4 | 23 | 1 | 70000 | 56 | 17.4 | Butyl | 1.4 |
| | | | | | | | | | | butyrate | |
| S-5 | LPS | 24 | 0 | B-5 | 23 | 1 | 70000 | 56 | 17.4 | Butyl | 1.4 |
| | | | | | | | | | | butyrate | |
| S-6 | LPS | 24 | 0 | B-6 | 23 | 1 | 74000 | 40 | 17.4 | Butyl | 1.4 |
| | | | | | | | | | | butyrate | |
| S-7 | LPS | 24 | 0 | B-7 | 23 | 1 | 72000 | 20 | 17.3 | Butyl | 1.4 |
| | | | | | | | | | | butyrate | |
| S-8 | LPS | 24 | 0 | B-8 | 23 | 1 | 69000 | 10 | 17.3 | Butyl | 1.4 |
| | | | | | | | | | | butyrate | |
| S-9 | LPS | 24 | 0 | B-9 | 23 | 1 | 530000 | 10 | 17.3 | Butyl | 1.4 |
| | | | | | | | | | | butyrate | |
| S-10 | LPS | 24 | 0 | B-10 | 23 | 1 | 760000 | 10 | 17.3 | Butyl | 1.4 |
| | | | | | | | | | | butyrate | |
| S-11 | LPS | 24 | 0 | B-11 | 23 | 1 | 8000 | 10 | 17.3 | Butyl | 1.4 |
| | | | | | | | | | | butyrate | |
| S-12 | LPS | 24 | 0 | B-12 | 23 | 1 | 80000 | 6 | 17.3 | Butyl | 1.4 |
| | | | | | | | | | | butyrate | |
| S-13 | LPS | 24 | 0 | B-13 | 23 | 1 | 81000 | 3 | 17.2 | Butyl | 1.4 |
| | | | | | | | | | | butyrate | |
| S-14 | LPS | 24 | 0 | B-14 | 36 | 0.7 | 60000 | 8 | 17.4 | Butyl | 12.0 |
| | | | | | | | | | | butyrate | |
| S-15 | LPS | 24 | 0 | B-15 | 23 | 18 | 71000 | 8 | 19.7 | Butyl | 18.0 |
| | | | | | | | | | | butyrate | |
| S-16 | LPS | 24 | 0 | B-16 | 44.5 | 0.5 | 70000 | 8 | 18.8 | Butyl | 20.5 |
| | | | | | | | | | | butyrate | |
| S-17 | LPS | 24 | 0 | B-8/B-16 | 23/44.5 | 1/0.5 | 69000/70000 | 8/8 | 17.3/18.8 | Butyl | 1.4/20.5 |
| | | | | | | | | | | butyrate | |
| S-18 | LPS | 24 | 0 | B-17 | 42 | 10 | 78000 | 0 | 19.2 | Butyl | 20.6 |
| | | | | | | | | | | butyrate | |
| S-19 | LLZ | 24 | 0 | B-8 | 23 | 1 | 69000 | 10 | 17.3 | Butyl | 1.4 |
| | | | | | | | | | | butyrate | |
| S-20 | LPS | 24 | 0 | T-1 | 33.6 | 0.3 | 320000 | 60 | 19.4 | Butyl | 9.6 |
| | | | | | | | | | | butyrate | |
| S-21 | LPS | 24 | 0 | B-8/T-1 | 23/33.6 | 1/0.3 | 69000/320000 | 8/60 | 17.3/19.4 | Butyl | 1.4/9.6 |
| | | | | | | | | | | butyrate | |
| S-22 | LPS | 24 | 0 | B-8/T-2 | 23/21 | 1/19.9 | 69000/45000 | 8/80 | 17.3/19.5 | Butyl | 1.4/20.2 |
| | | | | | | | | | | butyrate | |
| S-23 | LPS | 24 | 0 | B-8/T-3 | 23/20.2 | 1/20 | 69000/110000 | 8/45 | 17.3/18.2 | Butyl | 1.4/20.1 |
| | | | | | | | | | | butyrate | |
| S-24 | LPS | 24 | 0 | B-8/T-4 | 23/18 | 1/3.2 | 69000/80000 | 8/52 | 17.3/12.0 | Butyl | 1.4/6.8 |
| | | | | | | | | | | butyrate | |
| S-25 | LPS | 24 | 0 | B-18 | 25 | 0.5 | 70000 | 15 | 18.8 | Butyl | 1.1 |
| | | | | | | | | | | acetate | |
| S-26 | LPS | 24 | 0 | B-18 | 25 | 0.5 | 70000 | 20 | 18.8 | Xylene | 1.1 |
| S-27 | LPS | 24 | 0 | B-19 | 25 | 0.5 | 150000 | 6 | 18.8 | Xylene | 1.1 |
| S-28 | LPS | 24 | 0 | B-20 | 23 | 0.5 | 400000 | 10 | 18.8 | Xylene | 1.1 |
| S-29 | LPS | 24 | 0 | B-21 | 22 | 0.5 | 600000 | 10 | 18.8 | Xylene | 2.1 |
| S-30 | LPS | 24 | 0 | B-22 | 22 | 0.5 | 800000 | 12 | 18.8 | Xylene | 2.1 |
| S-31 | LPS | 24 | 0 | B-20 | 23 | 0.5 | 400000 | 13 | 18.8 | Octane | 1.1 |
| S-32 | LPS | 24 | 0 | B-23 | 28 | 0.5 | 300000 | 15 | 18.9 | Toluene | 4.0 |
| S-33 | LPS | 24 | 0 | B-24 | 32 | 0.5 | 500000 | 20 | 20.1 | Xylene | 8.0 |
| S-34 | LPS | 24 | 0 | B-25 | 23 | 0.5 | 400000 | 8 | 18.8 | Xylene | 1.1 |

Positive electrode composition

| | Active | | | Inorganic solid | | | | | | | | | | | | |
|---|---|---|---|---|---|---|---|---|---|---|---|---|---|---|---|---|
| | material | | | electrolyte | | | Binder | | | | | | | | | |
| | | Surface | | | Surface | | | Surface | | | | | | | | |
| | | energy | | | energy | | | energy | | | | | | | | |
| | | Disper- | Polar- | | Disper- | Polar- | | Disper- | Polar- | | | | Disper- | | | |
| | | sion | ity | | sion | ity | | sion | ity | | Adsorp- | | sion | | | |
| | | element | element | | element | element | | element | element | | tion | SP | medium | | | R_{AM} + |
| No. | Kind | χam | Yam | Kind | Xse | Yse | Kind | Xba | Yba | Mw | rate | value | Kind | R_{SE} | R_{AM} | R_{SE} |
| P-1 | NMC | 18 | 25 | LPS | 24 | 0 | B-1 | 12 | 1 | 70000 | 0 | 16.2 | Butyl | 12.0 | 24.7 | 36.8 |
| | | | | | | | | | | | | | butyrate | | | |
| P-2 | NMC | 18 | 25 | LPS | 24 | 0 | B-3 | 23 | 1 | 73000 | 0 | 18.2 | Butyl | 1.4 | 24.5 | 25.9 |
| | | | | | | | | | | | | | butyrate | | | |
| P-3 | NMC | 18 | 25 | LPS | 24 | 0 | B-4 | 23 | 1 | 70000 | 56 | 17.4 | Butyl | 1.4 | 24.5 | 25.9 |
| | | | | | | | | | | | | | butyrate | | | |
| P-4 | NMC | 18 | 25 | LPS | 24 | 0 | B-5 | 23 | 1 | 70000 | 50 | 17.4 | Butyl | 1.4 | 24.5 | 25.9 |
| | | | | | | | | | | | | | butyrate | | | |
| P-5 | NMC | 18 | 25 | LPS | 24 | 0 | B-6 | 23 | 1 | 74000 | 40 | 17.4 | Butyl | 1.4 | 24.5 | 25.9 |
| | | | | | | | | | | | | | butyrate | | | |
| P-6 | NMC | 18 | 25 | LPS | 24 | 0 | B-7 | 23 | 1 | 72000 | 20 | 17.3 | Butyl | 1.4 | 24.5 | 25.9 |
| | | | | | | | | | | | | | butyrate | | | |
| P-7 | NMC | 18 | 25 | LPS | 24 | 0 | B-8 | 23 | 1 | 69000 | 10 | 17.3 | Butyl | 1.4 | 24.5 | 25.9 |
| | | | | | | | | | | | | | butyrate | | | |
| P-8 | NMC | 18 | 25 | LPS | 24 | 0 | B-14 | 36 | 0.7 | 60000 | 8 | 17 4 | Butyl | 12.0 | 30.2 | 42.3 |
| | | | | | | | | | | | | | butyrate | | | |
| P-9 | NMC | 18 | 25 | LPS | 24 | 0 | B-15 | 23 | 18 | 71000 | 8 | 19.7 | Butyl | 18.0 | 8.6 | 26.6 |
| | | | | | | | | | | | | | butyrate | | | |
| P-10 | NMC | 18 | 25 | LPS | 24 | 0 | B-16 | 44.5 | 0.5 | 70000 | 8 | 18.8 | Butyl | 20.5 | 36.1 | 56.6 |
| | | | | | | | | | | | | | butyrate | | | |
| P-11 | NMC | 18 | 25 | LPS | 24 | 0 | B-18 | 25 | 0.5 | 70000 | 15 | 18.8 | Butyl | 1.1 | 25.5 | 26.6 |
| | | | | | | | | | | | | | butyrate | | | |
| P-12 | NMC | 18 | 25 | LPS | 24 | 0 | B-18 | 25 | 0.5 | 7000 | 20 | 18.8 | Xylene | 1.1 | 25.5 | 26.6 |
| P-13 | NMC | 18 | 25 | LPS | 24 | 0 | B-19 | 25 | 0.5 | 150000 | 6 | 18.8 | Xylene | 1.1 | 25.5 | 26.6 |
| P-14 | NMC | 18 | 25 | LPS | 24 | 0 | B-20 | 23 | 0.5 | 400000 | 10 | 18.8 | Xylene | 1.1 | 25.0 | 26.1 |
| P-15 | NMC | 18 | 25 | LPS | 24 | 0 | B-21 | 22 | 0.5 | 600000 | 10 | 18.8 | Xylene | 2.1 | 24.8 | 26.9 |
| P-16 | NMC | 18 | 25 | LPS | 24 | 0 | B-22 | 22 | 0.5 | 800000 | 12 | 18.8 | Xylene | 2.1 | 24.8 | 26.9 |
| P-17 | NMC | 18 | 25 | LPS | 24 | 0 | B-20 | 23 | 0.5 | 400000 | 13 | 18.8 | Octane | 1.1 | 25.0 | 26.1 |
| P-18 | NMC | 18 | 25 | LPS | 24 | 0 | B-23 | 25 | 0.5 | 300000 | 15 | 18.9 | Toluene | 4.0 | 26.5 | 30.5 |
| P-19 | NMC | 18 | 25 | LPS | 24 | 0 | B-24 | 32 | 0.5 | 500000 | 20 | 20.1 | Xylene | 8.0 | 28.2 | 36.2 |
| P-20 | NMC | 18 | 25 | LPS | 24 | 0 | B 25 | 23 | 0.5 | 400000 | 8 | 18.8 | Xylene | 1.1 | 25.0 | 26.1 |

Negative electrode-composition

| | Active | | | Inorganic solid | | | | | | | | | | | | |
|---|---|---|---|---|---|---|---|---|---|---|---|---|---|---|---|---|
| | material | | | electrolyte | | | Binder | | | | | | | | | |
| | | surface | | | surface | | | surface | | | | | | | | |
| | | energy | | | energy | | | energy | | | | | | | | |
| | | Disper- | Polar- | | Disper- | Polar- | | Disper- | Polar- | | | | Disper- | | | |
| | | sion | ity | | sion | ity | | sion | ity | | Adsorp- | | sion | | | |
| | | element | element | | element | element | | element | element | | tion | SP | medium | | | R_{AM} + |
| No. | Kind | Xam | Yam | Kind | Xse | Yse | Kind | Xba | Yba | Mw | rate | value | Kind | R_{SE} | R_{AM} | R_{SE} |
| N-1 | Si | 21 | 23 | LPS | 24 | 0 | B-1 | 12 | 1 | 70000 | 0 | 16.2 | Butyl | 12.0 | 23.8 | 35.8 |
| | | | | | | | | | | | | | butyrate | | | |
| N-2 | Si | 21 | 23 | LPS | 24 | 0 | B-4 | 23 | 1 | 70000 | 56 | 17.4 | Butyl | 1.4 | 22.1 | 23.5 |
| | | | | | | | | | | | | | butyrate | | | |
| N-3 | Si | 21 | 23 | LPS | 24 | 0 | B-8 | 23 | 1 | 69000 | 10 | 17.3 | Butyl | 1.4 | 22.1 | 23.5 |
| | | | | | | | | | | | | | butyrate | | | |
| N-4 | Si | 21 | 23 | LPS | 24 | 0 | B-14 | 36 | 0.7 | 70000 | 8 | 17.4 | Butyl | 12.0 | 26.9 | 38.9 |
| | | | | | | | | | | | | | butyrate | | | |
| N-5 | Si | 21 | 23 | LPS | 24 | 0 | B-15 | 23 | 18 | 70000 | 8 | 19.7 | Butyl | 18.0 | 5.4 | 23.4 |
| | | | | | | | | | | | | | butyrate | | | |
| N-6 | Si | 21 | 23 | LPS | 24 | 0 | B-16 | 44.5 | 0.5 | 70000 | 8 | 18.8 | Butyl | 20.5 | 32.5 | 53.0 |
| | | | | | | | | | | | | | butyrate | | | |
| N-7 | Gr | 21 | 1 | LPS | 24 | 0 | B-1 | 12 | 1 | 70000 | 0 | 16.2 | Butyl | 12.0 | 9.0 | 21.0 |
| | | | | | | | | | | | | | butyrate | | | |
| N-8 | Gr | 21 | 1 | LPS | 24 | 0 | B-8 | 23 | 1 | 69000 | 10 | 17.3 | Butyl | 1.4 | 2.0 | 3.4 |
| | | | | | | | | | | | | | butyrate | | | |
| N-9 | Gr | 21 | 1 | LPS | 24 | 0 | B-16 | 44.5 | 0.5 | 70000 | 8 | 18.8 | Butyl | 20.5 | 23.5 | 44.0 |
| | | | | | | | | | | | | | butyrate | | | |
| N-10 | Si | 21 | 23 | LPS | 24 | 0 | B-3 | 23 | 1 | 73000 | 0 | 18.2 | Butyl | 1.4 | 22.1 | 23.5 |
| | | | | | | | | | | | | | butyrate | | | |
| N-11 | Si | 21 | 23 | LPS | 24 | 0 | B-7 | 23 | 1 | 72000 | 20 | 17.3 | Butyl | 1.4 | 22.1 | 23.5 |
| | | | | | | | | | | | | | butyrate | | | |
| N-12 | Si | 21 | 23 | LPS | 24 | 0 | B-6 | 23 | 1 | 74000 | 40 | 17.4 | Butyl | 1.4 | 22.1 | 23.5 |
| | | | | | | | | | | | | | butyrate | | | |
| N-13 | Si | 21 | 23 | LPS | 24 | 0 | B-5 | 23 | 1 | 70000 | 50 | 17.4 | Butyl | 1.4 | 22.1 | 23.5 |
| | | | | | | | | | | | | | butyrate | | | |
| N-14 | Si | 21 | 23 | LPS | 24 | 0 | B-19 | 25 | 0.5 | 150000 | 6 | 18.8 | Xylene | 1.1 | 22.9 | 24.0 |
| N-15 | Si | 21 | 23 | LPS | 24 | 0 | B-20 | 23 | 0.5 | 400000 | 10 | 18.8 | Xylene | 1.1 | 22.6 | 23.7 |
| N-16 | Si | 21 | 23 | LPS | 24 | 0 | B-20 | 23 | 0.5 | 400000 | 13 | 18.8 | Octane | 1.1 | 22.6 | 23.7 |
| N-17 | Si | 21 | 23 | LPS | 24 | 0 | B-23 | 28 | 0.5 | 300000 | 15 | 18.9 | Toluene | 4.0 | 23.6 | 27.6 |
| N-18 | Si | 21 | 23 | LPS | 24 | 0 | B-24 | 32 | 0.5 | 500000 | 20 | 20.1 | Xylene | 8.0 | 25.0 | 33.1 |
| N-19 | Gr | 21 | 1 | LPS | 24 | 0 | B-20 | 23 | 0.5 | 400000 | 10 | 18.8 | Xylene | 1.1 | 2.1 | 3.2 |
| N-20 | Gr | 21 | 1 | LPS | 24 | 0 | B-23 | 28 | 0.5 | 300000 | 15 | 18.9 | Toluene | 4.0 | 7.0 | 11.0 |
| N-21 | Gr | 21 | 1 | LPS | 24 | 0 | B-24 | 32 | 0.5 | 500000 | 20 | 20.1 | Xylene | 8.0 | 11.0 | 19.0 |
| N-22 | Si | 21 | 23 | LPS | 24 | 0 | B-25 | 23 | 0.5 | 400000 | 8 | 18.8 | Xylene | 1.1 | 22.6 | 23.7 |

<Abbreviations in Table>

LPS: LPS synthesized in Synthesis Example A

LLZ: Li₇La₃Zr₂O₁₂

NMC: LiNi_{1/3}Co_{1/3}Mn_{1/3}O₂

Si: Silicon

Gr: Graphite

The unit of the “SP value” in the table is MPa^{1/2}. The “adsorption rate” means the adsorption rate of the binder with respect to the inorganic solid electrolyte, and the unit thereof is %. The unit of the dispersion element and the polarity element of the surface energy of each of the inorganic solid electrolyte, the binder, and the active material is mN/m.

R_{SE} means {(Xse−Xba)²+(Yse−Yba)²}^{0.5}, and the unit thereof is mN/m.

R_{AM} means {(Xse−Xam)²+(Yse−Yam)²}^{0.5}, and the unit thereof is mN/m.

In the compositions S-17 and S-21 to S-24 in which the composition contains two kinds of binders, the values of each binder regarding the surface energy of the binder, the adsorption rate with respect to the inorganic solid electrolyte, the molecular weight, the SP value, and R_{SE}, are described together using “/”.

The SP values of the dispersion media are 18.9 for butyl acetate (normal butyl butyrate), 18.5 for toluene, 18.7 for xylene (a mixture of xylene isomers in which the mixing molar ratio between isomers is, ortho-isomer:para-isomer:meta-isomer=1:5:2), and 16.9 for octane (normal octane), respectively.

<Production of Solid Electrolyte Sheet for all-Solid State Secondary Battery>

Each of the above-described inorganic solid electrolyte-containing compositions S-1 to S-34 was prepared and after 1 hour, applied onto an aluminum foil having a thickness of 20 μm using a baker type applicator (product name: SA-201, manufactured by Tester Sangyo Co., Ltd.), followed by heating at 110° C. for 2 hours to dry (remove the dispersion medium) the inorganic solid electrolyte-containing composition. Then, using a heat press machine, the inorganic solid electrolyte-containing composition dried at 25° C. and a pressure of 10 MPa for 10 seconds was pressurized to produce each of solid electrolyte sheets S-1 to S-34 for an all-solid state secondary battery. The film thickness of the solid electrolyte layer was 50

<Production of Positive Electrode Sheet for all-Solid State Secondary Battery>

Each of the obtained positive electrode compositions P-1 to P-20 was prepared and after 1 hour, applied onto an aluminum foil having a thickness of 20 μm by using a baker type applicator (product name: SA-201), followed by heating at 110° C. for 1 hour to dry (to remove the dispersion medium) the positive electrode composition. Then, using a heat press machine, the dried positive electrode composition was pressurized (10 MPa, 1 minute) at 25° C. to produce each of positive electrode sheets P-1 to P-20 for an all-solid state secondary battery, having a positive electrode active material layer having a film thickness of 100

<Production of Negative Electrode Sheet for all-Solid State Secondary Battery>

Each of the negative electrode compositions N-1 to N-22 obtained as above was prepared, and after 1 hour, applied onto a copper foil having a thickness of 20 μm using a baker type applicator (product name: SA-201), followed by heating at 110° C. and subsequently drying and heating at 110° C. for 2 hours with a vacuum dryer AVO-200NS (product name, manufactured by AS ONE Corporation) to dry (to remove the dispersion medium) the negative electrode composition. Then, using a heat press machine, the dried negative electrode composition was pressurized (10 MPa, 1 minute) at 25° C. to produce each of negative electrode sheets N-1 to N-22 for an all-solid state secondary battery, having a negative electrode active material layer having a film thickness of 70 μm.

The following evaluations were carried out for each of the manufactured compositions and each of the sheet, and the results are shown in Table 2.

<Evaluation 1: Dispersion Characteristics (Dispersibility)>

A composition at the time of applying onto a base material in the above-described manufacturing method for each sheet was sampled, and the following dispersibility test was carried out.

Each sampled composition (slurry) was dropped in a groove of a particle size measuring device (a grind meter) 232/111 type (product name, manufactured by AS ONE Corporation), and a value obtained by reading, according to the gradation, the position of the line that appeared after scraping with a scraper was defined as the aggregation size X. On the other hand, the aggregation size X₀ of the composition in which the viscosity was adjusted to 300 cP was measured in the same manner as the aggregation size X. The aggregation size ratio [X/X₀] was calculated using the obtained aggregation sizes X and X₀.

It is noted that the composition having a viscosity of 300 cP was prepared by adjusting the amount of butyl butyrate as a solvent while keeping the blending ratio of the solid content unchanged with respect to each sampled composition (slurry). As described above, the viscosity is a value measured using an E-type viscometer.

The ease of aggregation of solid particles was evaluated as the dispersibility of the composition by determining where this aggregation size ratio [X/X₀] is included in any one of the following evaluation standards.

In this test, the smaller the aggregation size ratio [X/X₀] is, the less the solid particles are aggregated or sedimented, which indicates that the dispersibility is excellent, and an evaluation standard “F” or higher is the pass level.

—Evaluation Standards—

A: X/X₀<1.1

B: 1.1≤X/X₀<1.2

C: 1.2≤X/X₀<1.3

D: 1.3≤X/X₀<1.4

E: 1.4≤X/X₀<1.5

F: 1.5≤X/X₀<1.6

G: 1.6≤X/X₀

<Evaluation 2: Dispersion Characteristics (Stability)>

A composition at the time of applying onto a base material in the above-described manufacturing method for each sheet was sampled, and the following dispersion stability test was carried out.

Each of the sampled compositions (slurries) was put into a glass test tube having a diameter of 10 mm and a height of 4 cm up to a height of 4 cm and allowed to stand at 25° C. for 24 hours. The solid content reduction rate for the upper 30% (in terms of height) of the composition before and after standing was calculated from the following expression. The ease of sedimentation (sedimentary property) of the solid particles due to a lapse of time was evaluated as the dispersion stability (the storage stability) of the composition by determining where the solid content reduction rate is included in any one of the following evaluation standards. In this test, the smaller the solid content reduction rate, the better the dispersion stability, and an evaluation standard “F” or higher is the pass level.

Solid content reduction rate (%)=[(solid content concentration of upper 30% before standing-solid content concentration of upper 30% after standing)/solid content concentration of upper 30% before standing]×100

—Evaluation Standards—

A: Solid content reduction rate<1%

B: 1%≤solid content reduction rate<3%

C: 3%≤solid content reduction rate<5%

D: 5%≤solid content reduction rate<7%

E: 7%≤solid content reduction rate<9%

F: 9%≤solid content reduction rate<11%

G: 11%≤solid content reduction rate

<Evaluation 3: Application Suitability (Surface Properties)>

As the application suitability of each composition, the maximum height roughness Rz of the surface of the solid electrolyte layer or the surface of the active material layer of each obtained sheet was measured and evaluated.

Specifically, the maximum height roughness Rz of the surface of the solid electrolyte layer or the surface of the active material layer of each sheet was measured with the following measuring device and under the following conditions according to Japanese Industrial Standards (JIS) B 0601: 2013.

The ease of forming a constitutional layer having a flat surface and good surface properties (surface properties) was evaluated as the application suitability of the composition, by determining where the maximum height roughness Rz is included in any of the following evaluation standards. In this test, the smaller the maximum height roughness Rz is, the more excellent the application suitability (the surface properties) is, and an evaluation standard “F” or higher is the pass level.

—Measuring Device and Conditions—

Measuring device: Three-dimensional fine shape measuring instrument (model: ET-4000A, manufactured by Kosaka Laboratory Ltd.)

Analytical instrument: 3D surface roughness analysis system (model TDA-31)

Touch needle: Tip radius of 0.5 μm, made of diamond

Needle pressure: 1 μN

Measurement length: 5.0 mm

Measurement speed: 0.02 mm/s

Measurement interval: 0.62 μm

Cutoff: Absent

Filter method: Gaussian spatial type

Leveling: Present (quadratic curve)

—Evaluation Standards—

A: Rz<1.0 μm

B: 1.0 μm≤Rz<2.0 μm

C: 2.0 μm≤Rz<4.0 μm

D: 4.0 μm≤Rz<6.0 μm

E: 6.0 μm≤Rz<8.0 μm

F: 8.0 μm≤Rz<10 μm

G: 10 μm≤Rz

<Evaluation 4: Application Suitability (Adhesiveness)>

As the application suitability of each composition, the adhesiveness of the solid particles in the solid electrolyte layer or active material layer of each obtained sheet and the adhesiveness between the active material layer and the collector were evaluated.

The produced sheet was cut out into a rectangle having a width of 3 cm and a length of 14 cm. Using a cylindrical mandrel tester (product code: 056, mandrel diameter: 10 mm, manufactured by Allgood Co., Ltd.), one end part of the cut-out sheet test piece in the length direction was fixed to the tester and disposed so that the cylindrical mandrel touched to the central portion of the sheet test piece, and then the sheet test piece was bent by 180° along the peripheral surface of the mandrel (with the mandrel as an axis) while pulling the other end part of the sheet test piece in the length direction with a force of 5N along the length direction. It is noted that the sheet test piece was set so that the solid electrolyte layer or active material layer thereof was placed on a side opposite to the mandrel (the base material or the collector was placed on the side of the mandrel) and the width direction was parallel to the axis line of the mandrel. The test was carried out by gradually reducing the diameter of the mandrel from 32 mm.

In a state of being wound around the mandrel and a state of being restored to a sheet shape by releasing the winding, the occurrence of defects (cracking, breakage, chipping, and the like) due to the disintegration of binding of solid particles in the solid electrolyte layer or the active material layer and for the active material layer, the minimum diameter at which the peeling between the active material layer and the collector could not be confirmed were measured, and the evaluation was carried out by determining which evaluation standard below is satisfied by the minimum diameter.

In this test, it is indicated that the smaller the minimum diameter is, the more firm the binding force of the solid particles that constitute the solid electrolyte layer or active material layer is, and the more firm the adhesion between the active material layer and the collector is, and an evaluation standard “F” or higher is the pass level.

—Evaluation Standards—

A: Minimum diameter<5 mm

B: 5 mm≤minimum diameter<6 mm

C: 6 mm≤minimum diameter<8 mm

D: 8 mm≤minimum diameter<10 mm

E: 10 mm≤minimum diameter<14 mm

F: 14 mm≤minimum diameter<25 mm

G: 25 mm≤minimum diameter

<Evaluation 5: Upper Limit Concentration for Slurrying>

In the preparation of each of the above-described compositions (slurries), the blending amount of butyl butyrate was adjusted to prepare a composition having a solid content concentration of 76% by mass in the composition. The prepared composition having a solid content concentration of 76% by mass was placed in a container (a columnar container for a self-rotation type mixer (ARE-310: product name, manufactured by THINKY CORPORATION), having a diameter of 5.0 cm and a height of 7.0 cm) placed on a desk, to a height of about 1.0 cm, and then tilted by 60 degrees from this state, and it was checked whether or not the fluidity was such a degree that the prepared composition dripped under the weight thereof. In a case where the composition did not drip under the weight thereof and had no fluidity, butyl butyrate as a dispersion medium was added so that the solid content concentration of the composition was reduced by 1% by mass, the composition was dispersed at 2,000 rpm for 1 minute with the above-described self-rotation type mixer, and then it was checked whether or not the composition had fluidity in the same manner as in the case of the above-described composition having a solid content concentration of 76% by mass. This operation was repeated so that the solid content concentration was reduced by 1% by mass per operation, and the maximum concentration of the concentrated slurry capable of being prepared was evaluated regarding the maximum solid content concentration having fluidity as the upper limit concentration for slurrying. In a case where the solid content concentration is increased to a concentration exceeding the upper limit concentration for slurrying, it is difficult to be used in the coating step in the first place. Therefore, the upper limit concentration for slurrying is an indicator of the upper limit concentration of solid contents of the composition that can be used in the coating step, and it is preferable to be high.

In the table below, the unit of the upper limit concentration for slurrying is % by mass.

TABLE 2

| | | | | Application | |
|---|---|---|---|---|---|
| | Upper limit | Dispersion | | suitability | |
| | concentration | characteristics | | Surface | Adhe- |
| No. | for slurrying | Dispersibility | Stability | properties | siveness |
| S-1 | 65 | D | D | D | D |
| S-2 | 70 | B | B | B | B |
| S-3 | 73 | E | F | E | F |
| S-4 | 63 | G | G | G | G |
| S-5 | 68 | E | F | E | F |
| S-6 | 68 | E | E | E | E |
| S-7 | 74 | C | B | C | B |
| S-8 | 74 | B | A | A | A |
| S-9 | 74 | B | A | B | A |
| S-10 | 72 | C | C | C | C |
| S-11 | 72 | D | D | C | C |
| S-12 | 74 | D | D | D | D |
| S-13 | 74 | E | F | E | F |
| S-14 | 65 | D | D | D | D |
| S-15 | 62 | D | E | E | E |
| S-16 | 60 | G | G | G | G |
| S-17 | 74 | B | A | A | A |
| S-18 | 60 | G | G | G | G |
| S-19 | 74 | B | A | A | A |
| S-20 | 58 | G | G | G | G |
| S-21 | 70 | D | C | C | C |
| S-22 | 68 | E | D | D | E |
| S-23 | 69 | D | C | D | C |
| S-24 | 70 | D | D | C | D |
| S-25 | 74 | B | A | A | A |
| S-26 | 70 | D | E | D | E |
| S-27 | 69 | C | D | C | C |
| S-28 | 68 | B | A | A | A |
| S-29 | 67 | B | A | B | A |
| S-30 | 65 | C | A | A | A |
| S-31 | 64 | C | B | B | B |
| S-32 | 65 | B | A | B | A |
| S-33 | 65 | C | A | B | B |
| S-34 | 68 | B | A | A | A |
| P-1 | 65 | E | F | E | F |
| P-2 | 73 | D | D | D | D |
| P-3 | 63 | G | G | G | G |
| P-4 | 68 | D | D | D | D |
| P-5 | 68 | D | C | C | B |
| P-6 | 74 | C | B | B | B |
| P-7 | 74 | B | A | A | A |
| P-8 | 65 | D | D | D | D |
| P-9 | 62 | C | C | B | B |
| P-10 | 60 | G | G | G | G |
| P-11 | 74 | B | A | A | A |
| P-12 | 70 | E | E | E | E |
| P-13 | 69 | C | C | C | C |
| P-14 | 68 | B | A | A | A |
| P-15 | 67 | B | A | B | B |
| P-16 | 65 | B | B | B | B |
| P-17 | 64 | C | C | C | C |
| P-18 | 65 | C | B | C | C |
| P-19 | 65 | D | C | C | B |
| P-20 | 68 | B | A | A | A |
| N-1 | 65 | C | C | C | C |
| N-2 | 60 | G | G | G | G |
| N-3 | 73 | A | B | B | B |
| N-4 | 65 | C | C | C | C |
| N-5 | 62 | B | B | B | B |
| N-6 | 60 | G | G | G | G |
| N-7 | 65 | A | B | A | B |
| N-8 | 73 | A | A | A | A |
| N-9 | 60 | G | G | G | G |
| N-10 | 70 | B | C | C | B |
| N-11 | 73 | B | B | B | B |
| N-12 | 67 | D | E | D | D |
| N-13 | 63 | E | F | E | E |
| N-14 | 69 | D | C | C | C |
| N-15 | 67 | C | B | B | B |
| N-16 | 67 | D | C | C | C |
| N-17 | 66 | C | B | C | C |
| N-18 | 64 | C | C | C | C |
| N-19 | 70 | B | A | A | A |
| N-20 | 68 | B | B | B | B |
| N-21 | 67 | C | B | C | C |
| N-22 | 67 | C | B | B | B |

<Manufacturing of all-Solid State Secondary Battery>

A positive electrode sheet for an all-solid state secondary battery, a solid electrolyte sheet for an all-solid state secondary battery, and a negative electrode sheet for an all-solid state secondary battery were used in combinations of the constitutional layers shown in Table 3 to manufacture all-solid state secondary battery.

The positive electrode sheet P-3, P-7, P-10, P-12, P-14, P-19, or P-20 for an all-solid state secondary battery was punched out into a disk shape having a diameter of 10 mm and was placed in a cylinder made of PET having an inner diameter of 10 mm. Each of the solid electrolyte sheet S-4, S-8, S-16, S-26, S-28, S-33, or S-34 for an all-solid state secondary battery were punched on the side of the positive electrode active material layer in the cylinder into a disk shape having a diameter of 10 mm and placed in the cylinder, and a 10 mm SUS rod was inserted from the openings at both ends of the cylinder. The collector side of the positive electrode sheet for an all-solid state secondary battery and the aluminum foil side of the solid electrolyte sheet for an all-solid state secondary battery were pressurized by applying a pressure of 350 MPa with a SUS rod. The SUS rod on the side of the solid electrolyte sheet for an all-solid state secondary battery was once removed to gently peel off the aluminum foil of the solid electrolyte sheet for an all-solid state secondary battery, and then the negative electrode sheet N-2, N-8, N-9, N-15, N-19, N-21, or N-22 was punched into a disk shape having a diameter of 10 mm and inserted onto the solid electrolyte layer of the solid electrolyte sheet for an all-solid state secondary battery in the cylinder. The removed SUS rod was inserted again into the cylinder and the sheets were fixed while applying a pressure of 50 MPa. In this way, all-solid state secondary battery Nos. C-1 to C-17 having a structure of an aluminum foil (thickness: 20 μm)-a positive electrode active material layer (thickness: 90 μm)-a solid electrolyte layer (thickness: 45 μm)-a negative electrode active material layer (thickness: 65 μm) were obtained.

It is noted that Nos. C-1 to C-4, C-6 to C-8, and C-10 to C-17 are the all-solid state secondary batteries according to the embodiment of the present invention, and Nos. C-5 and C-9 are all-solid state secondary batteries for comparison.

<Evaluation 5: Cycle Characteristics>

The discharge capacity retention rate of each of the all-solid state secondary batteries manufactured as described above was measured using a charging and discharging evaluation device TOSCAT-3000 (product name, manufactured by Toyo System Corporation).

Specifically, each of the all-solid state secondary batteries was charged in an environment of 25° C. at a current density of 0.1 mA/cm² until the battery voltage reached 3.6 V. Then, the battery was discharged at a current density of 0.1 mA/cm² until the battery voltage reached 2.5 V. One charging operation and one discharging operation were set as one cycle of initialization charging and discharging, and 3 cycles of initialization charging and discharging were repeated under the same conditions to carry out initialization. Then, under the same conditions as the cycle of initialization charging and discharging, charging and discharging were repeatedly carried out for 1,000 cycles, and the discharge capacity at the first cycle of charging and discharging and the discharge capacity at the 1,000th cycle thereof were determined with a charging and discharging evaluation device: TOSCAT-3000 (product name). The discharge capacity retention rate was calculated according to the following expression, and this discharge capacity retention rate was applied to the following evaluation standards to evaluate the cycle characteristics of the all-solid state secondary battery. In this test, the higher the evaluation standard is, the better the battery performance (the cycle characteristics) is, and the initial battery performance can be maintained even in a case where a plurality of times of charging and discharging are repeated (even in a case of the long-term use).

In this test, an evaluation standard of “F” or higher is the pass level.

All of the all-solid state secondary batteries according to the embodiment of the present invention exhibited initial discharge capacity values sufficient for functioning as an all-solid state secondary battery.

Discharge capacity retention rate (%)=(discharge capacity at 1,000th cycle/discharge capacity at first cycle)×100

—Evaluation Standards—

A: 90%≤discharge capacity retention rate

B: 85%≤discharge capacity retention rate<90%

C: 80%≤discharge capacity retention rate<85%

D: 75%≤discharge capacity retention rate<80%

E: 70%≤discharge capacity retention rate<75%

F: 60%≤discharge capacity retention rate<70%

G: Discharge capacity retention rate<60%

TABLE 3

| | Negative | Solid | Positive | |
|---|---|---|---|---|
| Battery | electrode active | electrolyte | electrode active | Cycle |
| No. | material layer | layer | material layer | characteristics |
| C-1 | N-8 | S-8 | P-7 | A |
| C-2 | N-8 | S-16 | P-10 | D |
| C-3 | N-9 | S-8 | P-10 | E |
| C-4 | N-9 | S-16 | P-7 | C |
| C-5 | N-9 | S-16 | P-10 | G |
| C-6 | N-8 | S-4 | P-3 | E |
| C-7 | N-2 | S-8 | P-3 | E |
| C-8 | N-2 | S-4 | P-7 | C |
| C-9 | N-2 | S-4 | P-3 | G |
| C-10 | N-19 | S-28 | P-14 | A |
| C-11 | N-19 | S-26 | P-12 | E |
| C-12 | N-19 | S-33 | P-19 | C |
| C-13 | N-21 | S-33 | P-19 | E |
| C-14 | N-15 | S-28 | P-14 | C |
| C-15 | N-15 | S-26 | P-19 | E |
| C-16 | N-15 | S-33 | P-12 | F |
| C-17 | N-22 | S-34 | P-20 | C |

The following findings can be seen from the results of Table 2 and Table 3.

Comparative inorganic solid electrolyte-containing composition Nos. S-4, S-20, P-3, and N-2 do not contain a polymer binder that satisfies the adsorption rate defined in the present invention. All of these compositions were inferior in dispersion characteristics and application suitability. In addition, the comparative all-solid state secondary battery No. C-9 in which layers were constituted using each of these comparative inorganic solid electrolyte-containing compositions did not exhibit sufficient cycle characteristics.

The comparative inorganic solid electrolyte-containing composition Nos. S-16, S-18, P-10, N-6, and N-9 do not contain a polymer binder that satisfies the relationship of Expression (1) defined in the present invention. All of these compositions were inferior in dispersion characteristics and application suitability. In addition, the comparative all-solid state secondary battery No. C-5 in which layers were constituted using each of these comparative inorganic solid electrolyte-containing compositions did not exhibit sufficient cycle characteristics.

On the other hand, in the inorganic solid electrolyte-containing compositions according to the embodiment of the present invention, S-1 to S-3, S-5 to S-15, S-17, S-19, S-21 to S-34, P-1, P-2, P-4 to P-9, P-11 to P-20, N-1, N-3 to N-5, N-7, N-8, and N-10 to N-22, the adsorption rate defined in the present invention is 50% or less, and a polymer binder that satisfies the relationship defined by Expression (1) between the polymer binder and the inorganic solid electrolyte in terms of surface energy is contained. These compositions have both dispersion characteristics (dispersibility and stability) and application suitability (surface properties and adhesiveness) at a high level. It has been found that in a case of using this inorganic solid electrolyte-containing composition for the formation of any one of constitutional layers of an all-solid state secondary battery, an all-solid state secondary battery exhibiting excellent cycle characteristics can be manufactured as shown in Nos. C-1 to C-4, C-6 to C-8, and C-10 to C-17.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery

What is claimed is:

1. An inorganic solid electrolyte-containing composition for an all-solid state secondary battery, comprising:
an inorganic solid electrolyte having an ion conductivity of a metal belonging to Group 1 or Group 2 in the periodic table;
a polymer binder; and
a dispersion medium,
wherein an adsorption rate of the polymer binder with respect to the inorganic solid electrolyte in the dispersion medium is 50% or less, and
the inorganic solid electrolyte and the polymer binder satisfy a relationship defined by Expression (1) in terms of surface energy,
(Xse−Xba)²+(Yse−Yba)²≤R² Expression (1)
in the expression, Xse represents a dispersion element of surface energy of the inorganic solid electrolyte, and Yse represents a polarity element of the surface energy of the inorganic solid electrolyte, Xba represents a dispersion element of surface energy of the polymer binder, and Yba represents a polarity element of the surface energy of the polymer binder, and R is 20.

2. The inorganic solid electrolyte-containing composition according to claim 1,
wherein the adsorption rate is 5% or more and less than 30%.

3. The inorganic solid electrolyte-containing composition according to claim 1, further comprising:
an active material,
wherein the active material and the polymer binder satisfy a relationship defined by Expression (2) in terms of surface energy,
(Xam−Xba)²+(Yam−Yba)²≤r² Expression (2)
in the expression, Xam represents a dispersion element of surface energy of the active material, and Yam represents a polarity element of the surface energy of the active material,
Xba represents the dispersion element of the surface energy of the polymer binder, and Yba represents the polarity element of the surface energy of the polymer binder, and
r is 30.

4. The inorganic solid electrolyte-containing composition according to claim 3,
wherein the inorganic solid electrolyte, the polymer binder, and the active material satisfy a relationship defined by Expression (3) in terms of surface energy,
R_{SE}+R_{AM}≤30 Expression (3)
in the expression, R_{SE}² represents a left side of Expression (1), and R_{AM}² represents a left side of Expression (2).

5. The inorganic solid electrolyte-containing composition according to claim 1,
wherein the dispersion medium contains at least one selected from an ester compound, a ketone compound, an ether compound, an alcohol compound, an amide compound, an amine compound, or a nitrile compound, and the polymer binder has a molecular weight of 10,000 to 700,000, or
the dispersion medium contains at least one selected from an aromatic compound or an aliphatic compound, and the polymer binder has a molecular weight of 70,000 to 1,000,000.

6. The inorganic solid electrolyte-containing composition according to claim 1,
wherein a difference between an SP value of the dispersion medium and an SP value of the polymer binder is 3 or less.

7. The inorganic solid electrolyte-containing composition according to claim 1,
wherein a polymer that forms the polymer binder contains a constitutional component having a functional group selected from the following group (a) of functional groups,
<Group (a) of functional groups>
a hydroxy group, an amino group, a carboxy group, a sulfo group, a phosphate group, a phosphonate group, a sulfanyl group, an ether bond, an imino group, an ester bond, an amide bond, a urethane bond, a urea bond, a heterocyclic group, an aryl group, a carboxylic acid anhydride group, and a fluoroalkyl group.

8. A sheet for an all-solid state secondary battery, comprising a layer formed of the inorganic solid electrolyte-containing composition according to claim 1.

9. An all-solid state secondary battery comprising, in the following order:
a positive electrode active material layer;
a solid electrolyte layer; and
a negative electrode active material layer,
wherein at least one of the positive electrode active material layer, the negative electrode active material layer, or the solid electrolyte layer has a layer formed of the inorganic solid electrolyte-containing composition according to claim 1.

10. A manufacturing method for a sheet for an all-solid state secondary battery, the manufacturing method comprising forming a film of the inorganic solid electrolyte-containing composition according to claim 1.

11. A manufacturing method for an all-solid state secondary battery, the manufacturing method comprising incorporating a sheet for an all-solid state secondary battery, which is obtained by the manufacturing method according to claim 10, into an all-solid state secondary battery.
